(19) United States
(12) Patent Application Publication
(10) Pub. No.: US 2023/0151257 A1
(43) Pub. Date: May 18, 2023

(54) REFRIGERANT-CONTAINING COMPOSITION, USE THEREOF, REFRIGERATOR HAVING SAME, AND METHOD FOR OPERATING SAID REFRIGERATOR

(71) Applicant: DAIKIN INDUSTRIES, LTD., Osaka (JP)

(72) Inventors: Mitsushi ITANO, Osaka (JP); Shun OHKUBO, Osaka (JP); Daisuke KARUBE, Osaka (JP); Satoshi TOKUNO, Osaka (JP)

(73) Assignee: DAIKIN INDUSTRIES, LTD., Osaka (JP)

(21) Appl. No.: 18/098,962

(22) Filed: Jan. 19, 2023

Related U.S. Application Data
(63) Continuation of application No. PCT/JP2021/028482, filed on Jul. 30, 2021.

(30) Foreign Application Priority Data
Jul. 30, 2020 (JP) 2020-129434

(51) Int. Cl. C09K 5/04

(52) U.S. Cl. CPC C09K 5/045; C09K 2205/42; C09K 2205/122; C09K 2205/126; C09K 2205/22

(57) ABSTRACT

An object is to provide a novel low-GWP mixed refrigerant. Provided is a composition comprising a refrigerant, the refrigerant comprising difluoromethane (R32), trans-1,2-difluoroethylene (HFO-1132(E)), 1,3,3,3-tetrafluoropropene (R1234ze), and 1,1-difluoroethylene (HFO-1132a).

### TECHNICAL FIELD

The present disclosure relates to a composition comprising a refrigerant, use of the composition, a refrigerating machine having the composition, and a method for operating the refrigerating machine.

### BACKGROUND ART

R410A is currently used as an air conditioning refrigerant for home air conditioners etc. R410A is a two-component mixed refrigerant of difluoromethane (CH2F₂: HFC-32 or R32) and pentafluoroethane (C₂HF₅: HFC-125 or R125), and is a pseudo-azeotropic composition.

However, the global warming potential (GWP) of R410A is 2088. Due to growing concerns about global warming, R32, which has a GWP of 675, has been increasingly used.

For this reason, various low-GWP mixed refrigerants that can replace R410A have been proposed (PTL 1).

### CITATION LIST

### Patent Literature

PTL 1: WO2015/141678

### SUMMARY OF INVENTION

### Technical Problem

An object of the present disclosure is to provide a novel low-GWP mixed refrigerant.

### Solution to Problem

Item 1.

A composition comprising a refrigerant, the refrigerant comprising difluoromethane (R32), trans-1,2-difluoroethylene (HFO-1132 (E)), 1,3,3,3-tetrafluoropropene (R1234ze), and 1,1-difluoroethylene (HFO-1132a).

Item 2.

The composition according to Item 1, wherein

when the mass % of R32, HFO-1132(E), R1234ze, and HFO-1132a based on their sum in the refrigerant is respectively represented by x, y, z, and a, provided that 1.5≤a≤10.0, coordinates (x,y,z) in a ternary composition diagram in which the sum of R32, HFO-1132(E), and R1234ze is (100−a) mass % are within the range of a figure surrounded by straight lines AB, BC, CD, DO, and OA that connect the following 5 points:

point A (74.0, −a+26.0, 0.0),
point B (73.9, 0.0, −a+26.1),
point C (0.0087a²−2.2743a+59.574, 0.0, −0.0087a+1.2743a+40.426),
point D (0.0, 0.0299a²−3.4018a+76.233, −0.0299a²+2.4018a+23.767), and
point O (0.0, 100.0−a, 0.0),
or on the straight lines AB and CD (excluding the points A, B, C, and D).

Item 3.

The composition according to Item 1, wherein

when the mass % of R32, HFO-1132(E), R1234ze, and HFO-1132a based on their sum in the refrigerant is respectively represented by x, y, z, and a, provided that 1.5≤a≤10.0, coordinates (x,y,z) in a ternary composition diagram in which the sum of R32, HFO-1132(E), and R1234ze is (100−a) mass % are within the range of a figure surrounded by straight lines A′B′, B′C, CD, DO, and OA′ that connect the following 5 points:

point A′ (59.2, −a+40.8, 0.0),
point B′ (0.0132a+58.891, 0.0, −1.0132a+41.109),
point C (0.0087a²−2.2743a+59.574, 0.0, −0.0087a²+1.2743a+40.426),
point D (0.0, 0.0299a²−3.4018a+76.233, −0.0299a²+2.4018a+23.767), and
point O (0.0, 100.0−a, 0.0),
or on the straight lines A′B′ and CD (excluding the points A′, B′, C, and D).

Item 4.

The composition according to any one of Items 1 to 3, wherein the refrigerant further comprises 2,3,3,3-tetrafluoro-1-propene (R1234yf).

Item 5.

The composition according to Item 4, wherein

when the mass % of R32 is represented by x, the mass % of HFO-1132(E) is represented by y, the total mass % of R1234ze and R1234yf is represented by z, and the mass % of HEO-1132a is represented by a, provided that 1.5≤a≤10.0, based on the sum of R32, HFO-1132(E), R1234ze, R1234yf, and HFO-1132a in the refrigerant, and r=R1234yf/(R1234ze+R1234yf),

if 1.5≤a≤4.6, coordinates (x,y,z) in a ternary composition diagram having R32 as a first vertex, HFO-1132(E) as a second vertex, and the sum of R1234ze and R1234yf as a third vertex are within the range of a figure surrounded by straight lines ABᵣ, BᵣCᵣ, CᵣDᵣ, DᵣO, and OA that connect the following 5 points:

point A (74.0, −a+26.0, 0.0),
point Bᵣ (73.9, 0.0, −a+26.1),
point Cᵣ ((0.0349a²+0.1094a−1.2427)r²+(−0.0202a²+0.0907a−10.591)r+(0.0255a²−2.3816a+59.715), 0.0, −a−x+100.0), point Dₕ(0.0, (−0.2097a²+1.3435a−2.7435)r²+(0.2312a²−1.507a−5.0597)r+(0.0255a²−3.3816a+76.215), −a−y+100.0), and
point O (0.0, 100.0−a, 0.0),
or on the straight lines ABᵣ and CᵣDᵣ(excluding the points A, Bᵣ, Cᵣ, and Dᵣ); or

if 4.6≤a≤10.0, coordinates (x,y,z) in the ternary composition diagram are within the range of a figure surrounded by straight lines ABᵣ, BᵣCᵣ, CᵣDᵣ, DᵣO, and OA that connect the following 5 points:

point A (74.0, −a+26.0, 0.0),
point Bᵣ(73.9, 0.0, −a+26.1),
point Cᵣ ((0.0494a²−0.5728a+1.5901)r₂+(−0.037a²+0.763a−13.326)r+(0.0062a²−2.2383a+59.465), 0.0, −a−x+100.0), point Dᵣ (0.0, (−0.0648a²+1.1685a−5.0037)r²+(0.0849a²−1.2762a−3.0253)r+(0.0262a²−3.346a+76.036), −a−y+100.0), and point O (0.0, 100.0−a, 0.0),
or on the straight lines ABᵣ and CᵣDᵣ(excluding the points A, Bᵣ, Cᵣ, and Dᵣ).

Item 6.

The composition according to Item 4,

wherein

when the mass % of R32 is represented by x, the mass % of HFO-1132(E) is represented by y, the total mass % of R1234ze and R1234yf is represented by z, and the mass % of HFO-1132a is represented by a, provided that 1.5≤a≤10.0, based on the sum of R32, HFO-1132(E), R1234ze, R1234yf, and HFO-1132a in the refrigerant, and r=R1234yf/(R1234ze+R1234yf),

if 1.5≤a≤4.6, coordinates (x,y,z) in a ternary composition diagram having R32 as a first vertex, HFO-1132(E) as a second vertex, and the sum of R1234ze and R1234yf as a third vertex are within the range of a figure surrounded by straight lines ABᵣ′, Bᵣ′Cᵣ, CᵣDᵣ, DᵣO, and OA that connect the following 5 points:

point A′ (74.0, −a+26.0, 0.0),
point Bᵣ′ ((−0.043a=+0.3269a−0.5935)r²+(−0.0188a²+0.018a+0.3153)r+(0.0202a²=−0.0907a+58.991), 0.0, −a−x+100.0),
point Cᵣ ((0.0349a²+0.1094a−1.2427)r²+(−0.0202a=+0.0907a−10.591)r+(0.0255a²−2.3816a+59.715), 0.0, −a−x+100.0),
point Dᵣ (0.0, (−0.2097a²+1.3435a−2.7435)r²+(0.2312a²−1.507a−5.0597)r+(0.0255a²−3.3816a+76.215), −a−y+100.0), and
point O (0.0, 100.0−a, 0.0),
or on the straight lines ABᵣ′ and CᵣDᵣ (excluding the points A, Bᵣ′, Cᵣ, and Dᵣ); or

if 4.6≤a≤10.0, coordinates (x,y,z) in the ternary composition diagram are within the range of a figure surrounded by straight lines AB′, Bᵣ′Cᵣ, CᵣDᵣ, DᵣO, and OA that connect the following 5 points:

point A (74.0, −a+26.0, 0.0), point B₁′ ((−0.0077a²+0.1312a−0.4401)r+(0.0013a²−0.0223a+59.075), 0.0, −a−x+100.0),
point Cᵣ((0.0494a²−0.5728a+1.5901) r₂+(−0.037a²+0.763a−13.326)r+(0.0062a²−2.2383a+59.465), 0.0, −a−x+100.0),
point Dᵣ (0.0, (−0.0648a²+1.1685a−5.0037)r²+(0.0849a²−1.2762a−3.0253)r+(0.0262a²−3.346a+76.036), −a−y+100.0), and
point O (0.0, 100.0−a, 0.0),
or on the straight lines ABᵣ′ and CᵣDᵣ (excluding the points A, Bᵣ′, Cᵣ, and Dᵣ)).

Item 7.

The composition according to any one of Items 1 to 6, for use as a working fluid for a refrigerating machine, wherein the composition further comprises a refrigeration oil.

Item 8.

The composition according to any one of Items 1 to 6, for use as an alternative refrigerant for R410A.

Item 9.

Use of the composition according to any one of Items 1 to 6 as an alternative refrigerant for R410A.

Item 10.

A refrigerating machine comprising the composition according to any one of Items 1 to 6 as a working fluid.

Item 11.

A method for operating a refrigerating machine, comprising circulating the composition according to any one of Items 1 to 6 as a working fluid in a refrigerating machine.

### Advantageous Effects of Invention

The refrigerant of the present disclosure has a low GWP.

### BRIEF DESCRIPTION OF DRAWINGS

FIG. 1 shows points A to D, points A′ to C′, and point O, as well as line segments connecting these points in a ternary composition diagram in which the sum of R32, HFO-1132(E), and R1234ze is 98.5 mass % (the HFO-1132a content is 1.5 mass %).

FIG. 2 shows points A to D, points A′ and B′, and point O, as well as line segments connecting these points in a ternary composition diagram in which the sum of R32, HFO-1132(E), and R1234ze is 98.5 mass % (the HFO-1132a content is 1.5 mass %).

FIG. 3 shows points A to D, points A′ and B′, and point O, as well as line segments connecting these points in a ternary composition diagram in which the sum of R32, HFO-1132(E), and R1234ze is 97 mass % (the HFO-1132a content is 3 mass %).

FIG. 4 shows points A to D, points A′ and B′, and point O, as well as line segments connecting these points in a ternary composition diagram in which the sum of R32, HFO-1132(E), and R1234ze is 95.4 mass % (the HFO-1132a content is 4.6 mass %).

FIG. 5 shows points A to D, points A′ and B′, and point O, as well as line segments connecting these points in a ternary composition diagram in which the sum of R32, HFO-1132(E), and R1234ze is 93 mass % (the HFO-1132a content is 7 mass %).

FIG. 6 shows points A to D, points A′ and B′, and point O, as well as line segments connecting these points in a ternary composition diagram in which the sum of R32, HFO-1132(E), and R1234ze is 90 mass % (the HFO-1132a content is 10 mass %).

FIG. 7 shows point A, point A′, points Bᵣ to Dᵣ, point Bᵣ′ and point 0, as well as line segments connecting these points in a ternary composition diagram in which the sum of R32, HFO-1132(E), and R1234ze is 98.5 mass % (the HFO-1132a content is 1.5 mass %).

FIG. 8 shows point A, point A′, points Bᵣ to Dᵣ, point Bᵣ′ and point 0, as well as line segments connecting these points in a ternary composition diagram in which the sum of R32, HFO-1132(E), and R1234ze is 97 mass % (the HFO-1132a content is 3 mass %).

FIG. 9 shows point A, point A′, points Bᵣ to Dᵣ, point Bᵣ′ and point O, as well as line segments connecting these points in a ternary composition diagram in which the sum of R32, HFO-1132(E), and R1234ze is 95.4 mass % (the HFO-1132a content is 4.6 mass %).

FIG. 10 shows point A, point A′, points Bᵣ to Dᵣ, point Br′ and point 0, as well as line segments connecting these points in a ternary composition diagram in which the sum of R32, HFO-1132(E), and R1234ze is 93 mass % (the HFO-1132a content is 7 mass %).

FIG. 11 shows point A, point A′, points Bᵣ to Dᵣ, point Br′ and point 0, as well as line segments connecting these points in a ternary composition diagram in which the sum of R32, HFO-1132(E), and R1234ze is 90 mass % (the HFO-1132a content is 10 mass %).

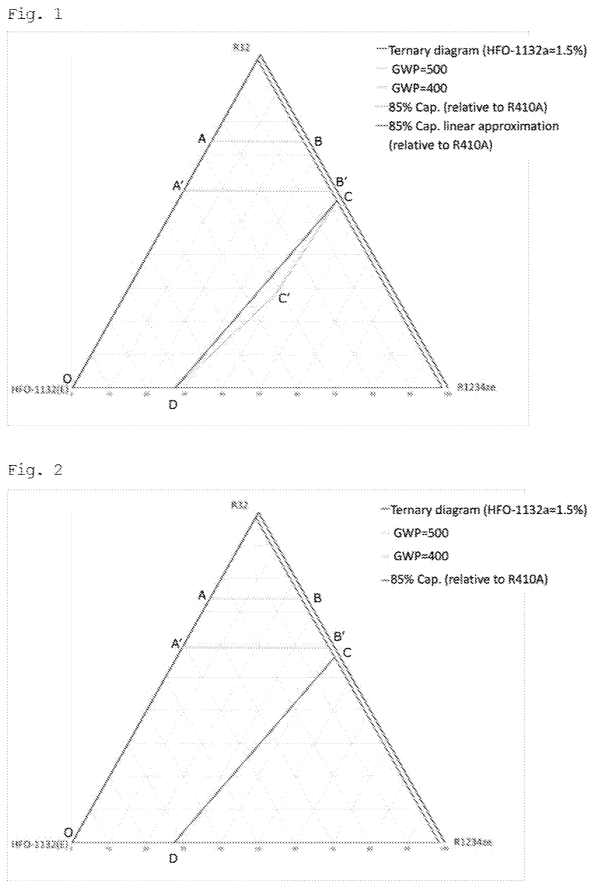

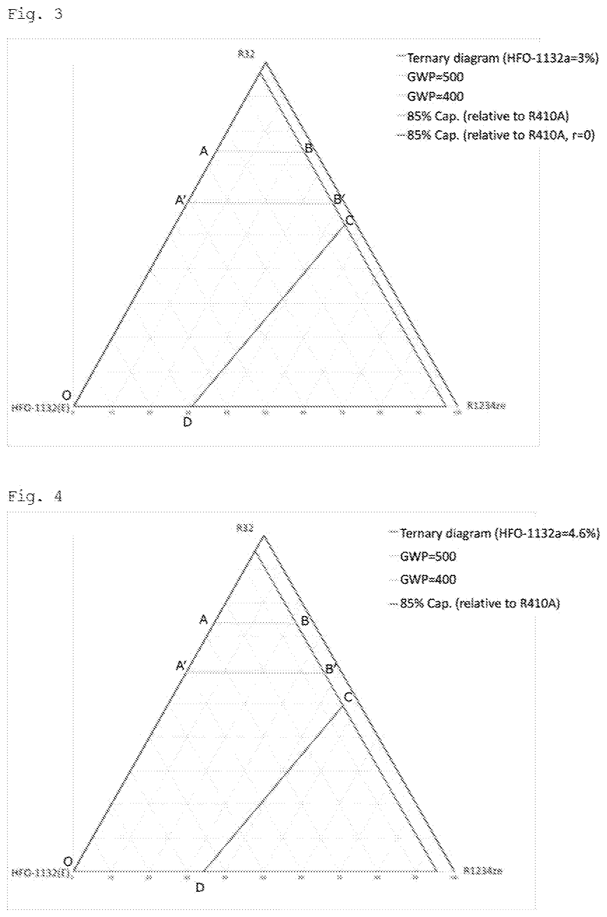

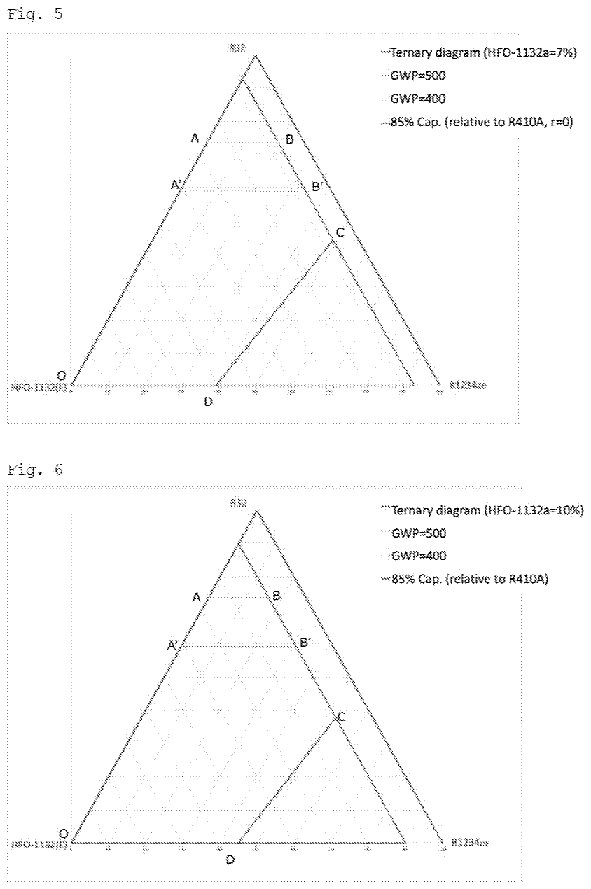

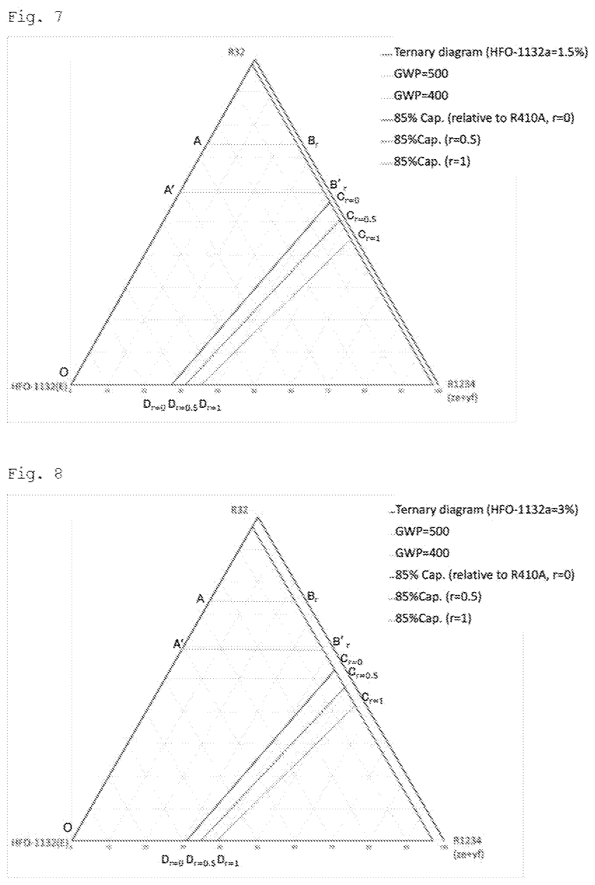

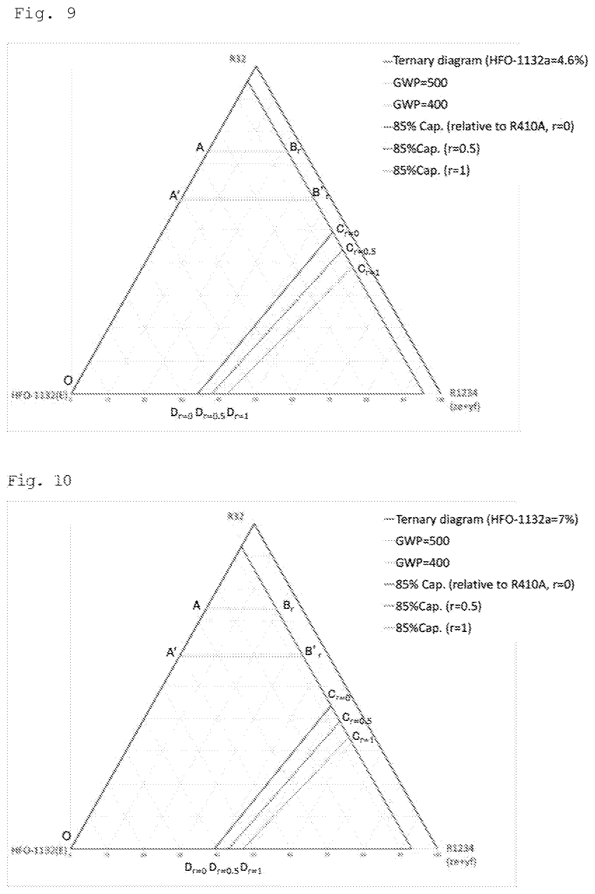

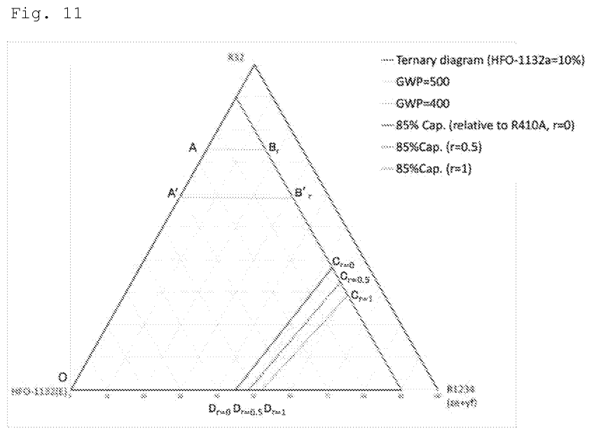

### DESCRIPTION OF EMBODIMENTS

The present inventors conducted intensive studies to solve the above problem, and consequently found that a mixed refrigerant comprising R32, HFO-1132(E), and R1234ze, as well as HFO-1132a has the above properties.

The present disclosure has been completed as a result of further research based on this finding. The present disclosure includes the following embodiments.

### DEFINITION OF TERMS

In the present specification, the term “refrigerant” includes at least compounds that are specified in ISO 817 (International Organization for Standardization), and that are given a refrigerant number (ASHRAE number) representing the type of refrigerant with “R” at the beginning; and further includes refrigerants that have properties equivalent to those of such refrigerants, even though a refrigerant number is not yet given. Refrigerants are broadly divided into fluorocarbon compounds and non-fluorocarbon compounds in terms of the structure of the compounds. Fluorocarbon compounds include chlorofluorocarbons (CFC), hydrochlorofluorocarbons (HCFC), and hydrofluorocarbons (HFC). Non-fluorocarbon compounds include propane (R290), propylene (R1270), butane (R600), isobutane (R600a), carbon dioxide (R744), ammonia (R717), and the like.

In the present specification, the phrase “composition comprising a refrigerant” at least includes (1) a refrigerant itself (including a mixture of refrigerants), (2) a composition that further comprises other components and that can be mixed with at least a refrigeration oil to obtain a working fluid for a refrigerating machine, and (3) a working fluid for a refrigerating machine containing a refrigeration oil. In the present specification, of these three embodiments, the composition (2) is referred to as a “refrigerant composition” so as to distinguish it from a refrigerant itself (including a mixture of refrigerants). Further, the working fluid for a refrigerating machine (3) is referred to as a “refrigeration oil-containing working fluid” so as to distinguish it from the “refrigerant composition.”

In the present specification, when the term “alternative” is used in a context in which the first refrigerant is replaced with the second refrigerant, the first type of “alternative” means that equipment designed for operation using the first refrigerant can be operated using the second refrigerant under optimum conditions, optionally with changes of only a few parts (at least one of the following: refrigeration oil, gasket, packing, expansion valve, dryer, and other parts) and equipment adjustment. In other words, this type of alternative means that the same equipment is operated with an alternative refrigerant. Embodiments of this type of “alternative” include “drop-in alternative,” “nearly drop-in alternative,” and “retrofit,” in the order in which the extent of changes and adjustment necessary for replacing the first refrigerant with the second refrigerant is smaller.

The term “alternative” also includes a second type of “alternative,” which means that equipment designed for operation using the second refrigerant is operated for the same use as the existing use with the first refrigerant by using the second refrigerant. This type of alternative means that the same use is achieved with an alternative refrigerant.

In the present specification, the term “refrigerating machine” refers to machines in general that draw heat from an object or space to make its temperature lower than the temperature of ambient air, and maintain a low temperature. In other words, refrigerating machines refer to conversion machines that gain energy from the outside to do work, and that perform energy conversion, in order to transfer heat from where the temperature is lower to where the temperature is higher.

### 1. Refrigerant

### 1.1 Refrigerant Component

The refrigerant of the present disclosure comprises R32, HFO-1132(E), R1234ze, and HFO-1132a.

The refrigerant of the present disclosure is a low-GWP mixed refrigerant.

The refrigerant of the present disclosure preferably satisfies the following requirements. In this case, the refrigerant of the present disclosure has a GWP of 500 or less and a refrigerating capacity ratio of 85% or more relative to that of R410A.

### Requirements

When the mass % of R32, HFO-1132(E), R1234ze, and HFO-1132a based on their sum is respectively represented by x, y, z, and a, provided that 1.5≤a≤10.0, coordinates (x,y,z) in a ternary composition diagram in which the sum of R32, HFO-1132(E), and R1234ze is (100−a) mass % are within the range of a figure surrounded by straight lines AB, BC, CD, DO, and OA that connect the following 5 points:

point A (74.0, −a+26.0, 0.0),
point B (73.9, 0.0, −a+26.1),
point C (0.0087a²−2.2743a+59.574, 0.0, −0.0087a²+1.2743a+40.426),
point D (0.0, 0.0299a²−3.4018a+76.233, −0.0299a²+2.4018a+23.767), and
point O (0.0, 100.0−a, 0.0),
or on the straight lines AB and CD (excluding the points A, B, C, and D).

The refrigerant of the present disclosure preferably satisfies the following requirements. In this case, the refrigerant of the present disclosure has a GWP of 400 or less and a refrigerating capacity ratio of 85% or more relative to that of R410A.

### Requirements

When the mass % of R32, HFO-1132(E), R1234ze, and HFO-1132a based on their sum is respectively represented by x, y, z, and a, provided that 1.5≤a≤10.0, coordinates (x,y,z) in a ternary composition diagram in which the sum of R32, HFO-1132(E), and R1234ze is (100−a) mass % are within the range of a figure surrounded by straight lines A′B′, B′C, CD, DO, and QA′ that connect the following 5 points:

point A′ (59.2, −a+40.8, 0.0),
point B′ (0.0132a+58.891, 0.0, −1.0132a+41.109),
point C (0.0087a²−2.2743a+59.574, 0.0, −0.0087a²+1.2743a+40.426),
point D (0.0, 0.0299a²−3.4018a+76.233, −0.0299a²+2.4018a+23.767), and
point O (0.0, 100.0−a, 0.0),
or on the straight lines A′B′ and CD (excluding the points A′, B′, C, and D).

The refrigerant of the present disclosure may further comprise R1234yf.

When the refrigerant of the present disclosure further comprises R1234yf, it preferably satisfies the following requirements. In this case, the refrigerant of the present disclosure has a GWP of 500 or less and a refrigerating capacity ratio of 85% or more relative to that of R410A.

### Requirements

When the mass % of R32 is represented by x, the mass % of HFO-1132(E) is represented by y, the total mass % of R1234ze and R1234yf is represented by z, and the mass % of HFO-1132a is represented by a, provided that 1.5≤a≤10.0, based on the sum of R32, HFO-1132(E), R1234ze, R1234yf, and HFO-1132a, and r=R1234yf/(R1234ze+R1234yf),

if 1.5≤a≤4.6, coordinates (x,y,z) in a ternary composition diagram having R32 as a first vertex, HFO-1132 (E) as a second vertex, and the sum of R1234ze and R1234yf as a third vertex are within the range of a figure surrounded by straight lines ABᵣ, BᵣCᵣ, CᵣDᵣ, DᵣO, and OA that connect the following 5 points:

point A (74.0, −a+26.0, 0.0),
point Bᵣ (73.9, 0.0, −a+26.1),
point Cᵣ ((0.0349a²+0.1094a−1.2427)r²+(−0.0202a²+0.0907a−10.591)r+(0.0255a²−2.3816a+59.715), 0.0, −a−x+100.0),
point Dᵣ (0.0, (−0.2097a²+1.3435a−2.7435)r²+(0.2312a²−1.507a−5.0597)r+(0.0255a²−3.3816a+76.215), −a−y+100.0), and
point O (0.0, 100.0−a, 0.0),
or on the straight lines ABᵣ and CᵣDᵣ (excluding the points A, Bᵣ, Cᵣ, and Dᵣ); or

if 4.6≤a≤10.0, coordinates (x,y,z) in the ternary composition diagram are within the range of a figure surrounded by straight lines ABᵣ, BᵣCᵣ, CᵣDᵣ, DᵣO, and OA that connect the following 5 points:

point A (74.0, −a+26.0, 0.0),
point Bᵣ (73.9, 0.0, −a+26.1),
point Cᵣ ((0.0494a²−0.5728a+1.5901)r²+(−0.037a²+0.763a−13.326)r+(0.0062a=−2.2383a+59.465), 0.0, −a−x+100.0),
point Dᵣ(0.0, (−0.0648a²+1.1685a−5.0037)r²+(0.0849a²−1.2762a−3.0253)r+(0.0262a²−3.346a+76.036), −a−y+100.0), and
point O (0.0, 100.0−a, 0.0),
or on the straight lines ABᵣ and CᵣDᵣ (excluding the points A, Bᵣ, Cᵣ, and Dᵣ).

When the refrigerant of the present disclosure further comprises R1234yf, it preferably satisfies the following requirements. In this case, the refrigerant of the present disclosure has a GWP of 400 or less and a refrigerating capacity ratio of 85% or more relative to that of R410A.

### Requirements

When the mass % of R32 is represented by x, the mass % of HFO-1132(E) is represented by y, the total mass % of R1234ze and R1234yf is represented by z, and the mass % of HFO-1132a is represented by a, provided that 1.5≤a≤10.0, based on the sum of R32, HFO-1132(E), R1234ze, R1234yf, and HFO-1132a, and r=R1234yf/(R1234ze+R1234yf),

if 1.5≤a≤4.6, coordinates (x,y,z) in a ternary composition diagram having R32 as a first vertex, HFO-1132(E) as a second vertex, and the sum of R1234ze and R1234yf as a third vertex are within the range of a figure surrounded by straight lines ABᵣ′, Bᵣ′Cᵣ, CᵣDᵣ, DᵣO, and OA that connect the following 5 points:

point A′ (74.0, −a+26.0, 0.0),
point Bᵣ′ ((−0.043a²+0.3269a−0.5935)r²+(−0.0188a²+0.018a+0.3153)r+(0.0202a²−0.0907a+58.991), 0.0, −a−x+100.0),
point Cᵣ ((0.0349a²+0.1094a−1.2427)r²+(−0.0202a²+0.0907a−10.591)r+(0.0255a²−2.3816a+59.715), 0.0, −a−x+100.0),
point Dᵣ (0.0, (−0.2097a=+1.3435a−2.7435)r²+(0.2312a²−1.507a−5.0597)r+(0.0255a²−3.3816a+76.215), −a−y+100.0), and
point O (0.0, 100.0−a, 0.0),
or on the straight lines ABᵣ′ and CᵣDᵣ (excluding the points A, Bᵣ′, Cᵣ, and Dᵣ); or

if 4.6≤a≤10.0, coordinates (x,y,z) in the ternary composition diagram are within the range of a figure surrounded by straight lines ABM′, Bᵣ′Cᵣ, CᵣDᵣ, DᵣO, and OA that connect the following 5 points:

point A (74.0, −a+26.0, 0.0),
point Bᵣ′ ((−0.0077a²+0.1312a−0.4401)r+(0.0013a²−0.0223a+59.075), 0.0, −a−x+100.0),
point Cᵣ ((0.0494a²−0.5728a+1.5901)r²+(−0.037a²+0.763a−13.326)r+(0.0062a²−2.2383a+59.465), 0.0, −a−x+100.0),
point Dᵣ (0.0, (−0.0648a²+1.1685a−5.0037)r+(0.0849a²−1.2762a−3.0253)r+(0.0262a²−3.346a+76.036), −a−y+100.0), and
point O (0.0, 100.0−a, 0.0),
or on the straight lines ABᵣ′ and CᵣDᵣ(excluding the points A, Bᵣ′, Cᵣ, and Dᵣ).

The refrigerant of the present disclosure may further comprise other additional refrigerants in addition to R32, HFO-1132(E), R1234ze, R1234yf, and HFO-1132a, as long as the above properties and effects are not impaired. In this respect, in an embodiment, the refrigerant of the present disclosure preferably comprises R32, HFO-1132(E), R1234ze, and HFO-1132a in a total amount of 99.5 mass % or more, more preferably 99.75 mass % or more, and even more preferably 99.9 mass % or more, based on the entire refrigerant. Further, the refrigerant of the present disclosure may consist of R32, HFO-1132(E), R1234ze, and HFO-1132a. In this case, the refrigerant of the present disclosure may contain impurities inevitably mixed in the production process. In another embodiment, the refrigerant of the present disclosure preferably comprises R32, HFO-1132(E), R1234ze, R1234yf, and HFO-1132a in a total amount of 99.5 mass % or more, more preferably 99.75 mass % or more, and even more preferably 99.9 mass % or more, based on the entire refrigerant. Further, the refrigerant of the present disclosure may essentially consist of R32, HFO-1132(E), R1234ze, R1234yf, and HFO-1132a. In this case, the refrigerant of the present disclosure may contain impurities inevitably mixed in the production process.

Such additional refrigerants are not limited, and can be selected from a wide range of refrigerants. The mixed refrigerant may comprise a single additional refrigerant, or two or more additional refrigerants.

### 1.2. Use

The refrigerant according to the present disclosure can be preferably used as a working fluid in a refrigerating machine.

The composition according to the present disclosure is suitable for use as an alternative refrigerant for R410A.

### 2. Refrigerant Composition

The refrigerant composition according to the present disclosure comprises at least the refrigerant according to the present disclosure, and can be used for the same use as the refrigerant according to the present disclosure. Moreover, the refrigerant composition according to the present disclosure can be further mixed with at least a refrigeration oil to thereby obtain a working fluid for a refrigerating machine.

The refrigerant composition according to the present disclosure further comprises at least one other component in addition to the refrigerant according to the present disclosure. The refrigerant composition according to the present disclosure may comprise at least one of the following other components, if necessary. As described above, when the refrigerant composition according to the present disclosure is used as a working fluid in a refrigerating machine, it is generally used as a mixture with at least a refrigeration oil. Therefore, it is preferable that the refrigerant composition according to the present disclosure does not substantially comprise a refrigeration oil. Specifically, in the refrigerant composition according to the present disclosure, the content of the refrigeration oil based on the entire refrigerant composition is preferably 0 to 1 mass %, and more preferably 0 to 0.1 mass %.

### 2.1. Water

The refrigerant composition according to the present disclosure may contain a small amount of water. The water content of the refrigerant composition is preferably 0.1 mass % or less based on the entire refrigerant. A small amount of water contained in the refrigerant composition stabilizes double bonds in the molecules of unsaturated fluorocarbon compounds that can be present in the refrigerant, and makes it less likely that the unsaturated fluorocarbon compounds will be oxidized, thus increasing the stability of the refrigerant composition.

### 2.2. Tracer

A tracer is added to the refrigerant composition according to the present disclosure at a detectable concentration such that when the refrigerant composition has been diluted, contaminated, or undergone other changes, the tracer can trace the changes.

The refrigerant composition according to the present disclosure may comprise a single tracer, or two or more tracers.

The tracer is not limited, and can be suitably selected from commonly used tracers.

Examples of tracers include hydrofluorocarbons, hydrochlorofluorocarbons, chlorofluorocarbons, hydrochlorocarbons, fluorocarbons, deuterated hydrocarbons, deuterated hydrofluorocarbons, perfluorocarbons, fluoroethers, brominated compounds, iodinated compounds, alcohols, aldehydes, ketones, and nitrous oxide (N₂O). The tracer is particularly preferably a hydrofluorocarbon, a hydrochlorofluorocarbon, a chlorofluorocarbon, a hydrochlorocarbon, a fluorocarbon, or a fluoroether.

The following compounds are preferable as the tracer.
FC-14 (tetrafluoromethane, CF₄)
HCC-40 (chloromethane, CH₃Cl)
HFC-23 (trifluoromethane, CHF₃)
HFC-41 (fluoromethane, CH₃Cl)
HFC-125 (pentafluoroethane, CF₃CHF₂)
HFC-134a (1,1,1,2-tetrafluoroethane, CF₃CH₂F)
HFC-134 (1, 1, 2, 2-tetrafluoroethane, CHF₂CHF₂)
HFC-143a (1,1, 1-trifluoroethane, CF₃CH₃)
HFC-143 (1,1, 2-trifluoroethane, CHF₂CH₂F)
HFC-152a (1,1-difluoroethane, CHF₂CH₃)
HFC-152 (1,2-difluoroethane, CH₂FCH₂F)
HFC-161 (fluoroethane, CH₃CH₂F)
HFC-245fa (1,1,1, 3, 3-pentafluoropropane, CF₃CH₂CHF₂)
HFC-236fa (1, 1,1, 3, 3, 3-hexafluoropropane, CF₃CH₂CF₃)
HFC-236ea (1,1,1, 2, 3, 3-hexafluoropropane, CF₃CHFCHF₂)
HFC-227ea (1, 1,1,2,3,3, 3-heptafluoropropane, CF₃CHFCF₃)
HCFC-22 (chlorodifluoromethane, CHClF₂)
HCFC-31 (chlorofluoromethane, CH₂ClF)
CFC-1113 (chlorotrifluoroethylene, CF₂═CClF)
HFE-125 (trifluoromethyl-difluoromethyl ether, CF₃OCHF₂)
HFE-134a (trifluoromethyl-fluoromethyl ether, CF₃OCH₂F)
HFE-143a (trifluoromethyl-methyl ether, CF₃OCH₃)
HFE-227ea (trifluoromethyl-tetrafluoroethyl ether, CF₃OCHFCF₃)
HFE-236fa (trifluoromethyl-trifluoroethyl ether, CF₃OCHCF₃)

The refrigerant composition of the present disclosure may contain the tracer in a total amount of about 10 parts per million by weight (ppm) to about 1000 ppm based on the entire refrigerant composition. The refrigerant composition of the present disclosure may contain the tracer in a total amount of preferably about 30 ppm to about 500 ppm, and more preferably about 50 ppm to about 300 ppm, based on the entire refrigerant composition.

### 2.3. Ultraviolet Fluorescent Dye

The refrigerant composition according to the present disclosure may comprise a single ultraviolet fluorescent dye, or two or more ultraviolet fluorescent dyes.

The ultraviolet fluorescent dye is not limited, and can be suitably selected from commonly used ultraviolet fluorescent dyes.

Examples of ultraviolet fluorescent dyes include naphthalimide, coumarin, anthracene, phenanthrene, xanthene, thioxanthene, naphthoxanthene, fluorescein, and derivatives thereof. The ultraviolet fluorescent dye is particularly preferably either naphthalimide or coumarin, or both.

### 2.4. Stabilizer

The refrigerant composition according to the present disclosure may comprise a single stabilizer, or two or more stabilizers.

The stabilizer is not limited, and can be suitably selected from commonly used stabilizers.

Examples of stabilizers include nitro compounds, ethers, and amines.

Examples of nitro compounds include aliphatic nitro compounds, such as nitromethane and nitroethane; and aromatic nitro compounds, such as nitro benzene and nitro styrene.

Examples of ethers include 1,4-dioxane.

Examples of amines include 2,2,3,3,3-pentafluoropropylamine and diphenylamine.

Examples of stabilizers also include butylhydroxyxylene and benzotriazole.

The content of the stabilizer is not limited. Generally, the content of the stabilizer is preferably 0.01 to 5 mass %, and more preferably 0.05 to 2 mass %, based on the entire refrigerant.

### 2.5. Polymerization Inhibitor

The refrigerant composition according to the present disclosure may comprise a single polymerization inhibitor, or two or more polymerization inhibitors.

The polymerization inhibitor is not limited, and can be suitably selected from commonly used polymerization inhibitors.

Examples of polymerization inhibitors include 4-methoxy-1-naphthol, hydroquinone, hydroquinone methyl ether, dimethyl-t-butylphenol, 2, 6-di-tert-butyl-p-cresol, and benzotriazole.

The content of the polymerization inhibitor is not limited. Generally, the content of the polymerization inhibitor is preferably 0.01 to 5 mass %, and more preferably 0.05 to 2 mass %, based on the entire refrigerant.

### 3. Refrigeration Oil-Containing Working Fluid

The refrigeration oil-containing working fluid according to the present disclosure comprises at least the refrigerant or refrigerant composition according to the present disclosure and a refrigeration oil, for use as a working fluid in a refrigerating machine. Specifically, the refrigeration oil-containing working fluid according to the present disclosure is obtained by mixing a refrigeration oil used in a compressor of a refrigerating machine with the refrigerant or the refrigerant composition. The refrigeration oil-containing working fluid generally comprises 10 to 50 mass % of refrigeration oil.

### 3.1. Refrigeration Oil

The composition according to the present disclosure may comprise a single refrigeration oil, or two or more refrigeration oils.

The refrigeration oil is not limited, and can be suitably selected from commonly used refrigeration oils. In this case, refrigeration oils that are superior in the action of increasing the miscibility with the mixture and the stability of the mixture, for example, are suitably selected as necessary.

The base oil of the refrigeration oil is preferably, for example, at least one member selected from the group consisting of polyalkylene glycols (PAG), polyol esters (POE), and polyvinyl ethers (PVE).

The refrigeration oil may further contain additives in addition to the base oil. The additive may be at least one member selected from the group consisting of antioxidants, extreme-pressure agents, acid scavengers, oxygen scavengers, copper deactivators, rust inhibitors, oil agents, and antifoaming agents.

A refrigeration oil with a kinematic viscosity of 5 to 400 cSt at 40° C. is preferable from the standpoint of lubrication.

The refrigeration oil-containing working fluid according to the present disclosure may further optionally contain at least one additive. Examples of additives include compatibilizing agents described below.

### 3.2. Compatibilizing Agent

The refrigeration oil-containing working fluid according to the present disclosure may comprise a single compatibilizing agent, or two or more compatibilizing agents.

The compatibilizing agent is not limited, and can be suitably selected from commonly used compatibilizing agents.

Examples of compatibilizing agents include polyoxyalkylene glycol ethers, amides, nitriles, ketones, chlorocarbons, esters, lactones, aryl ethers, fluoroethers, and 1,1,1-trifluoroalkanes. The compatibilizing agent is particularly preferably a polyoxyalkylene glycol ether.

### 4. Method for Operating Refrigerating Machine

The method for operating a refrigerating machine according to the present disclosure is a method for operating a refrigerating machine using the refrigerant according to the present disclosure.

Specifically, the method for operating a refrigerating machine according to the present disclosure comprises the step of circulating the refrigerant according to the present disclosure in a refrigerating machine.

The embodiments are described above; however, it will be understood that various changes in forms and details can be made without departing from the spirit and scope of the claims.

### EXAMPLES

The present disclosure is described in more detail below with reference to Examples. However, the present disclosure is not limited to the Examples.

Mixed refrigerants were prepared by mixing R32, HFO-1132(E), R1234ze, and HFO-1132a at mass % shown in Table 1 based on their sum.

The GWP of R410A (R32=50%/R125=50%) and the above mixed refrigerants was evaluated based on the values stated in the Intergovernmental Panel on Climate Change (IPCC), fourth report. The GWP of HFO-1132(E), which was not stated therein, was assumed to be 1 from HFO-1132a (GWP=1 or less) and HFO-1123 (GWP=0.3, described in PTL 1). The refrigerating capacity of R410A and the above mixed refrigerants was determined by performing theoretical refrigeration cycle calculations for the mixed refrigerants using the National Institute of Science and Technology (NIST) and Reference Fluid Thermodynamic and Transport Properties Database (Refprop 9.0) under the following conditions.

For each of these mixed refrigerants, the COP ratio and refrigerating capacity ratio relative to those of R410A were determined. The calculation conditions were as follows:

Evaporating temperature: 5° C.
Condensation temperature: 45° C.
Superheating temperature: 5 K
Subcooling temperature: 5 K
Compressor efficiency: 70%

Table1 shows these values together with the GWP of each mixed refrigerant. The COP and refrigerating capacity are ratios relative to R410A.

The coefficient of performance (COP) was determined by the following formula.

COP=(refrigerating capacity or heating capacity)/power consumption

TABLE 1

| | | Com | Com | Com | | | | | | Com | Com |
|---|---|---|---|---|---|---|---|---|---|---|---|
| Item | Unit | Ex. 1 | Ex. 2 | Ex. 3 | Ex. 1 | Ex. 2 | Ex. 3 | Ex. 4 | Ex. 5 | Ex. 4 | Ex. 5 |
| HFO-1132a | mass % | R410A | 0.0 | 0.79 | 1.5 | [symbol] | 5.0 | 7.5 | [symbol] | 12.5 | 15.0 |
| R32 | mass % | | 25.0 | 25.0 | 25.0 | 25.0 | 25.0 | 25.0 | 25.0 | 25.0 | 25.0 |
| HFO-1132 (E) | mass % | | 35.0 | 35.0 | 35.0 | 35.0 | 35.0 | 35.0 | 35.0 | 35.0 | 35.0 |
| R1234ze | mass % | | [symbol] | 39.25 | 38.5 | 37.0 | 35.0 | 32.5 | 30.0 | 27.5 | 25.0 |
| GWP | — | [symbol] | 172 | 171 | 171 | 171 | 171 | 171 | 171 | 171 | 171 |
| COP ratio | % (relative | 100.0 | [symbol] | [symbol] | [symbol] | 100.4 | [symbol] | [symbol] | [symbol] | [symbol] | [symbol] |
| | to R410A) | | | | | | | | | | |
| Refrigerating | % (relative | 100.0 | [symbol] | [symbol] | [symbol] | [symbol] | [symbol] | [symbol] | [symbol] | 103.3 | 107.0 |
| capacity ratio | to R410A) | | | | | | | | | | |
| Condensation | ° C. | 0 | 7.1 | [symbol] | 8.0 | 8.7 | [symbol] | [symbol] | [symbol] | [symbol] | [symbol] |
| glide | | | | | | | | | | | |

| | | Com | Com | Com | Com | Com | Com | Com | Com | Com | Com | [symbol] om | [symbol] om | Com |
|---|---|---|---|---|---|---|---|---|---|---|---|---|---|---|
| | | Ex. 6 | Ex. 7 | Ex. 8 | Ex. 9 | Ex. 10 | Ex. 11 | Ex. 12 | Ex. 13 | Ex. 14 | Ex. 15 | Ex. 1 [symbol] | Ex. 1 [symbol] | Ex. 18 |
| Item | Unit | A | B | A′ | B′ | C | C′ | D | A | B | A′ | B′ | C | D |
| HFO-1132a | mass % | 1.5 | 1.5 | 1.5 | 1.5 | 1.5 | 1.5 | 1.5 | 3.0 | 3.0 | 3.0 | 3.0 | 3.0 | 3.0 |
| R32 | mass % | 74.0 | [symbol] | [symbol] | [symbol] | [symbol] | [symbol] | 0.0 | 74.0 | 73.9 | 59.2 | [symbol] | [symbol] | 0.0 |
| HFO-1132 (E) | mass % | 24.5 | 0.0 | [symbol] | 0.0 | 0.0 | [symbol] | 71.2 | 23.0 | 0.0 | 37.8 | 0.0 | 0.0 | [symbol] |
| R1234ze | mass % | 0.0 | [symbol] | 0.0 | [symbol] | [symbol] | 40.1 | 27.3 | 0.0 | [symbol] | 0.0 | [symbol] | [symbol] | [symbol] |
| GWP | — | 500 | 500 | 400 | 400 | [symbol] | [symbol] | 2 | 500 | 500 | 400 | 400 | [symbol] | [symbol] |
| COP ratio | % (relative | 100.2 | 102.0 | [symbol] | [symbol] | [symbol] | [symbol] | 100.0 | 93.7 | [symbol] | 98.6 | 102.8 | 103.2 | [symbol] |
| | to R410A) | | | | | | | | | | | | | |
| Refrigerating | % (relative | [symbol] | [symbol] | [symbol] | [symbol] | [symbol] | [symbol] | 85.0 | 115.3 | [symbol] | 115.5 | [symbol] | [symbol] | [symbol] |
| capacity ratio | to R410A) | | | | | | | | | | | | | |
| Condensation | ° C. | [symbol] | [symbol] | [symbol] | [symbol] | [symbol] | [symbol] | 5.4 | [symbol] | [symbol] | [symbol] | [symbol] | [symbol] | 7.5 |
| glide | | | | | | | | | | | | | | |

| | | Com | Com | Com | Com | Com | Com | Com | Com | Com | Com | [symbol] om | [symbol] om |
|---|---|---|---|---|---|---|---|---|---|---|---|---|---|
| | | Ex. 19 | Ex. 20 | Ex. 21 | Ex. 22 | Ex. 23 | Ex. 24 | Ex. 25 | Ex. 26 | Ex. 27 | Ex. 28 | Ex. [symbol] | Ex. [symbol] |
| Item | Unit | A | B | A′ | B′ | C | D | A | B | A′ | B′ | C | D |
| HFO-1132a | mass % | [symbol] | [symbol] | [symbol] | [symbol] | [symbol] | [symbol] | 7.0 | 7.0 | 7.0 | 7.0 | 7.0 | 7.0 |
| R32 | mass % | 74.0 | 73.9 | 59.2 | 59.2 | 49.3 | 0.0 | 74.0 | 73.9 | 59.2 | 59.0 | 44.1 | 0.0 |
| HFO-1132 (E) | mass % | 21.4 | 0.0 | [symbol] | 0.0 | 0.0 | [symbol] | [symbol] | 0.0 | [symbol] | 0.0 | 0.0 | [symbol] |
| R1234ze | mass % | 0.0 | 21.5 | 0.0 | [symbol] | [symbol] | 34.2 | 0.0 | [symbol] | 0.0 | 34.0 | [symbol] | [symbol] |
| GWP | — | 500 | 500 | 400 | 400 | [symbol] | [symbol] | 500 | 500 | 400 | 400 | 301 | [symbol] |
| COP ratio | % (relative | [symbol] | [symbol] | 98.1 | 102.2 | 102.7 | [symbol] | [symbol] | 101.0 | [symbol] | [symbol] | 102.1 | 28.0 |
| | to R410A) | | | | | | | | | | | | |
| Refrigerating | % (relative | 116.6 | [symbol] | [symbol] | [symbol] | [symbol] | [symbol] | [symbol] | 105.4 | [symbol] | [symbol] | [symbol] | [symbol] |
| capacity ratio | to R410A) | | | | | | | | | | | | |
| Condensation | ° C. | [symbol] | 4.5 | 1.5 | 7.4 | [symbol] | [symbol] | 2.2 | 4.9 | [symbol] | [symbol] | 11.5 | [symbol] |
| glide | | | | | | | | | | | | | |

| | | Com | Com | Com | Com | Com | Com |
|---|---|---|---|---|---|---|---|
| | | Ex. 36 | Ex. 37 | Ex. 38 | Ex. 39 | Ex. 40 | Ex. 41 |
| Item | Unit | A | B | A′ | B′ | C | D |
| HFO-1132a | mass % | [symbol] | [symbol] | [symbol] | [symbol] | [symbol] | [symbol] |
| R32 | mass % | 74.0 | 73.9 | [symbol] | [symbol] | 37.7 | 0.0 |
| HFO-1132 (E) | mass % | 15.0 | 0.0 | 30.0 | 0.0 | 0.0 | 45.2 |
| R1234ze | mass % | 0.0 | [symbol] | 0.0 | [symbol] | [symbol] | 44.8 |
| GWP | — | 500 | 500 | 400 | 400 | [symbol] | [symbol] |
| COP ratio | % (relative | [symbol] | [symbol] | [symbol] | 100.4 | 102.5 | [symbol] |
| | to R410A) | | | | | | |
| Refrigerating | % (relative | [symbol] | [symbol] | [symbol] | 100.1 | [symbol] | [symbol] |
| capacity ratio | to R410A) | | | | | | |
| Condensation | ° C. | [symbol] | [symbol] | 2.7 | [symbol] | [symbol] | [symbol] |
| glide | | | | | | | |

[symbol]

indicates data missing or illegible when filed

Approximate expressions indicating the coordinates of each point were obtained by determining approximate expressions for the curves connecting five points, as shown in Table 2.

TABLE 2

| Item | Unit | Approximate expression calculation of point A | | | | |
|---|---|---|---|---|---|---|
| a = HFO-1132a | mass % | 1.5 | 3.0 | 4.6 | 7.0 | 10.0 |
| x = R32 | mass % | 74.0 | 74.0 | 74.0 | 74.0 | 74.0 |
| y = HFO-1132 (E) | mass % | 24.5 | 23.0 | 21.4 | 19.0 | 16.0 |
| z = R1234ze | mass % | 0.0 | 0.0 | 0.0 | 0.0 | 0.0 |
| Approximate expression of x | | 74.0 | | | | |
| Approximate expression of y | | −a + 26.0 | | | | |
| Approximate expression of z | | 0.0 | | | | |
| Item | Unit | Approximate expression calculation of point B | | | | |
| a = HFO-1132a | mass % | 1.5 | 3.0 | 4.6 | 7.0 | 10.0 |
| x = R32 | mass % | 73.9 | 73.9 | 73.9 | 73.9 | 73.9 |
| y = HFO-1132 (E) | mass % | 0.0 | 0.0 | 0.0 | 0.0 | 0.0 |
| z = R1234ze | mass % | 24.6 | 23.1 | 21.5 | 19.1 | 16.1 |
| Approximate expression of x | | 73.9 | | | | |
| Approximate expression of y | | 0.0 | | | | |
| Approximate expression of z | | −a + 26.1 | | | | |
| Item | Unit | Approximate expression calculation of point A′ | | | | |
| a = HFO-1132a | mass % | 1.5 | 3.0 | 4.6 | 7.0 | 10.0 |
| x = R32 | mass % | 59.2 | 59.2 | 59.2 | 59.2 | 59.2 |
| y = HFO-1132 (E) | mass % | 39.3 | 37.8 | 36.2 | 33.8 | 30.8 |
| z = R1234ze | mass % | 0.0 | 0.0 | 0.0 | 0.0 | 0.0 |
| Approximate expression of x | | 59.2 | | | | |
| Approximate expression of y | | −a + 40.8 | | | | |
| Approximate expression of z | | 0.0 | | | | |
| Item | Unit | Approximate expression calculation of point B′ | | | | |
| a = HFO-1132a | mass % | 1.5 | 3.0 | 4.6 | 7.0 | 10.0 |
| x = R32 | mass % | 58.9 | 58.9 | 59.0 | 59.0 | 59.0 |
| y = HFO-1132 (E) | mass % | 0.0 | 0.0 | 0.0 | 0.0 | 0.0 |
| z = R1234ze | mass % | 39.6 | 38.1 | 36.4 | 34.0 | 31.0 |
| Approximate expression of x | | 0.0132a + 58.891 | | | | |
| Approximate expression of y | | 0.0 | | | | |
| Approximate expression of z | | −1.0132a + 41.109 | | | | |
| Item | Unit | Approximate expression calculation of point C | | | | |
| a = HFO-1132a | mass % | 1.5 | 3.0 | 4.6 | 7.0 | 10.0 |
| x = R32 | mass % | 56.2 | 52.8 | 49.3 | 44.1 | 37.7 |
| y = HFO-1132 (E) | mass % | 0.0 | 0.0 | 0.0 | 0.0 | 0.0 |
| z = R1234ze | mass % | 42.3 | 44.2 | 46.1 | 48.9 | 52.3 |
| Approximate expression of x | | 0.0087a² − 2.2743a + 59.574 | | | | |
| Approximate expression of y | | 0.0 | | | | |
| Approximate expression of z | | −0.0087a² + 1.2743a + 40.426 | | | | |
| Item | Unit | Approximate expression calculation of point D | | | | |
| a = HFO-1132a | mass % | 1.5 | 3.0 | 4.6 | 7.0 | 10.0 |
| x = R32 | mass % | 0.0 | 0.0 | 0.0 | 0.0 | 0.0 |
| y = HFO-1132 (E) | mass % | 71.2 | 66.3 | 61.2 | 53.9 | 45.2 |
| z = R1234ze | mass % | 27.3 | 30.7 | 34.2 | 39.1 | 44.8 |

| | |
|---|---|
| Approximate expression of x | 0.0 |
| Approximate expression of y | 0.0299a² − 3.4018a + 76.233 |
| Approximate expression of 2 | =D41 |

These results demonstrate that the mixed refrigerants of R32, HFO-1132(E), R1234ze, and HFO-1132a have a GWP of 500 or less and a refrigerating capacity ratio of 85% or more relative to that of R410A when they satisfy the following requirements.

### Requirements

When the mass % of R32, HFO-1132(E), R1234ze, and HFO-1132a based on their sum is respectively represented by x, y, z, and a, provided that 1.55a 10.0, coordinates (x,y,z) in a ternary composition diagram in which the sum of R32, HFO-1132(E), and R1234ze is (100−a) mass % are within the range of a figure surrounded by straight lines AB, BC, CD, DO, and OA that connect the following 5 points:

point A (74.0, −a+26.0, 0.0),
point B (73.9, 0.0, −a+26.1),
point C (0.0087a²−2.2743a+59.574, 0.0, −0.0087a²+1.2743a+40.426),
point D (0.0, 0.0299a²−3.4018a+76.233, −0.0299a²+2.4018a+23.767), and
point O (0.0, 100.0−a, 0.0),
or on the straight lines AB and CD (excluding the points A, B, C, and D).

Further, these results demonstrate that the mixed refrigerants of R32, HFO-1132(E), R1234ze, and HFO-1132a have a GWP of 400 or less and a refrigerating capacity ratio of 85% or more relative to that of R410A when they satisfy the following requirements.

### Requirements

When the mass % of R32, HFO-1132(E), R1234ze, and HFO-1132a based on their sum is respectively represented by x, y, z, and a, provided that 1.5≤a≤10.0, coordinates (x,y,z) in a ternary composition diagram in which the sum of R32, HFO-1132(E), and R1234ze is (100−a) mass % are within the range of a figure surrounded by straight lines A′B′, B′C, CD, DO, and OA′ that connect the following 5 points:

point A′ (59.2, −a+40.8, 0.0),
point B′ (0.0132a+58.891, 0.0, −1.0132a+41.109),
point C (0.0087a²−2.2743a+59.574, 0.0, −0.0087a²+1.2743a+40.426),
point D (0.0, 0.0299a°-3.4018a+76.233, −0.0299a²+2.4018a+23.767), and
point O (0.0, 100.0−a, 0.0),
or on the straight lines A′B′ and CD (excluding the points A′, B′, C, and D).

Mixed refrigerants further comprising R1234yf in addition to R32, HFO-1132(E), R1234ze, and HFO-1132a were evaluated in the same manner as described above. Table 3 shows the results.

TABLE 3

| | | Com | Com | Com | Com | Com | Com | Com | Com |
|---|---|---|---|---|---|---|---|---|---|
| | | Ex. 42 | Ex. 43 | Ex. 44 | Ex. 45 | Ex. 46 | Ex. 47 | Ex. 48 | Ex. 49 |
| Item | Unit | B [symbol] | B′ [symbol] | C [symbol] | D [symbol] | B [symbol] | B′ [symbol] | C [symbol] | D [symbol] |
| HFO-1132a | mass % | 1.5 | 1.5 | 1.5 | 1.5 | 1.5 | 1.5 | 1.5 | 1.5 |
| R32 | mass % | 73.9 | 59.0 | 50.7 | 0.0 | 73.9 | 59.0 | 44.7 | 0.0 |
| HFO-1132 (E) | mass % | 0.0 | 0.0 | 0.0 | 87.5 | 0.0 | 0.0 | 0.0 | 63.2 |
| R1234(yf + ze) | mass % | 12.3 | [symbol] | [symbol] | 15.5 | 24.6 | 39.5 | [symbol] | 35.3 |
| GWP | — | 500 | 400 | 345 | 2 | 500 | 400 | 304 | 2 |
| COP ratio | % (relative | 102.4 | 102.6 | 102.8 | 99.7 | 101.9 | 101.8 | 101.7 | 99.3 |
| | to R410A) | | | | | | | | |
| Refrigerating | % (relative | 99.2 | 90.5 | 85.0 | 85.0 | 101.3 | 93.7 | 85.0 | 85.0 |
| capacity ratio | to R410A) | | | | | | | | |
| Condensation | ° C. | 2.5 | 4.3 | [symbol] | 4.0 | 1.5 | 2.5 | 4.0 | 3.6 |
| glide | | | | | | | | | |
| | | Com | Com | Com | Com | Com | Com | Com | Com |
| | | Ex. 50 | Ex. 51 | Ex. 52 | Ex. 53 | Ex. 54 | Ex. 55 | Ex. 56 | Ex. 57 |
| Item | Unit | B [symbol] | B′ [symbol] | C [symbol] | D [symbol] | B [symbol] | B′ [symbol] | C [symbol] | D [symbol] |
| HFO-1132a | mass % | 3.0 | 3.0 | 3.0 | 3.0 | 3.0 | 3.0 | 3.0 | 3.0 |
| R32 | mass % | 73.9 | 59.0 | 47.4 | 0.0 | 73.9 | 59.1 | 41.7 | 0.0 |
| HFO-1132 (E) | mass % | 0.0 | 0.0 | 0.0 | 82.4 | 0.0 | 0.0 | 0.0 | 58.2 |
| R1234(yf + ze) | mass % | 11.6 | 19.0 | 24.8 | 17.3 | 23.9 | 0.0 | [symbol] | 38.8 |
| GWP | — | 500 | 400 | 322 | 2 | 500 | 400 | 284 | 2 |
| COP ratio | % (relative | 101.9 | 102.1 | 102.3 | 99.1 | 101.3 | 101.1 | 101.3 | 95.7 |
| | to R410A) | | | | | | | | |
| Refrigerating | % (relative | 101.4 | 92.6 | 85.0 | 85.0 | 109.5 | 114.2 | 85.0 | 85.0 |
| capacity ratio | to R410A) | | | | | | | | |
| Condensation | ° C. | 3.0 | [symbol] | [symbol] | [symbol] | 0.4 | 1.6 | 5.0 | 5.1 |
| glide | | | | | | | | | |
| | | Com | Com | Com | Com | Com | Com | Com | Com |
| | | Ex. 58 | Ex. 59 | Ex. 60 | Ex. 61 | Ex. 62 | Ex. 63 | Ex. 64 | Ex. 65 |
| Item | Unit | B [symbol] | B′ [symbol] | C [symbol] | D [symbol] | B [symbol] | B′ [symbol] | C [symbol] | D [symbol] |
| HFO-1132a | mass % | [symbol] | [symbol] | [symbol] | [symbol] | [symbol] | [symbol] | [symbol] | [symbol] |
| R32 | mass % | 73.9 | 59.0 | 44.0 | 0.0 | 73.9 | 59.0 | 38.7 | 0.0 |
| HFO-1132 (E) | mass % | 0.0 | 0.0 | 0.0 | 57.4 | 0.0 | 0.0 | 0.0 | 53.1 |
| R1234(yf + ze) | mass % | 10.8 | 18.2 | 25.7 | 10.0 | 21.5 | 0.0 | 56.7 | 42.3 |
| GWP | — | 500 | 400 | 300 | 3 | 500 | 400 | 254 | 2 |
| COP ratio | % (relative | 101.4 | 101.5 | 101.9 | 98.5 | 101.0 | 102.2 | 100.8 | 98.1 |
| | to R410A) | | | | | | | | |
| Refrigerating | % (relative | 103.6 | 94.9 | 85.0 | 85.0 | 105.3 | 91.8 | 85.0 | 85.0 |
| capacity ratio | to R410A) | | | | | | | | |
| Condensation | ° C. | 3.4 | 5.3 | 7.8 | 8.1 | 2.4 | 7.4 | 5.9 | [symbol] |
| glide | | | | | | | | | |
| | | Com | Com | Com | Com | Com | Com | Com | Com |
| | | Ex. 66 | Ex. 67 | Ex. 68 | Ex. 69 | Ex. 70 | Ex. 71 | Ex. 72 | Ex. 73 |
| Item | Unit | B [symbol] | B′ [symbol] | C [symbol] | D [symbol] | B [symbol] | B′ [symbol] | C [symbol] | D [symbol] |
| HFO-1132a | mass % | 7.0 | 7.0 | 7.0 | 7.0 | 7.0 | 7.0 | 7.0 | 7.0 |
| R32 | mass % | 73.9 | 59.0 | 39.2 | 0.0 | 73.9 | 59.1 | 34.3 | 0.0 |
| HFO-1132 (E) | mass % | 0.0 | 0.0 | 0.0 | 50.0 | 0.0 | 0.0 | 0.0 | 46.1 |
| R1234(yf + ze) | mass % | 9.6 | 17.0 | [symbol] | 21.5 | [symbol] | 0.0 | 58.7 | 46.9 |
| GWP | — | 500 | 400 | [symbol] | 3 | 500 | 400 | 234 | 2 |
| COP ratio | % (relative | 100.7 | 100.8 | 101.3 | 97.8 | 100.3 | [symbol] | 100.3 | [symbol] |
| | to R410A) | | | | | | | | |
| Refrigerating | % (relative | 106.9 | 98.4 | 85.0 | 85.0 | 108.4 | 119.3 | 85.0 | 85.0 |
| capacity ratio | to R410A) | | | | | | | | |
| Condensation | ° C. | 3.9 | 5.0 | [symbol] | [symbol] | 3.0 | 3.0 | 7.4 | [symbol] |
| glide | | | | | | | | | |
| | | Com | Com | Com | Com | Com | Com | Com | Com |
| | | Ex. 74 | Ex. 75 | Ex. 76 | Ex. 77 | Ex. 78 | Ex. 79 | Ex. 80 | Ex. 81 |
| Item | Unit | B [symbol] | B′ [symbol] | C [symbol] | D [symbol] | B [symbol] | B′ [symbol] | C [symbol] | D [symbol] |
| HFO-1132a | mass % | 10.0 | 10.0 | 10.0 | 10.0 | 10.0 | 10.0 | 10.0 | 10.0 |
| R32 | mass % | 73.9 | 59.0 | 33.2 | 0.0 | 73.9 | 59.1 | 29.1 | 0.0 |
| HFO-1132 (E) | mass % | 0.0 | 0.0 | 0.0 | [symbol] | 0.0 | 0.0 | 0.0 | 38.1 |
| R1234(yf + ze) | mass % | 8.1 | [symbol] | 28.4 | 24.2 | 16.1 | 0.0 | 50.9 | 51.9 |
| GWP | — | 500 | 400 | 227 | 3 | 500 | 400 | [symbol] | 3 |
| COP ratio | % (relative | 99.8 | 99.8 | 100.6 | 97.3 | 99.5 | 98.4 | 99.7 | 97.1 |
| | to R410A) | | | | | | | | |
| Refrigerating | % (relative | 111.0 | 102.5 | 85.0 | 85.0 | 112.2 | [symbol] | 85.0 | 85.0 |
| capacity ratio | to R410A) | | | | | | | | |
| Condensation | ° C. | 4.4 | 6.4 | 11.7 | [symbol] | [symbol] | 3.7 | 9.1 | 10.9 |
| glide | | | | | | | | | |

[symbol]

indicates data missing or illegible when filed

Approximate expressions indicating the coordinates of each point were obtained by determining approximate expressions for the curves connecting three points, as shown in Tables 4 and 5.

TABLE 4
Point B

[symbol]

B [symbol] (r = R1234ze/(R1234ze + R1234yf))

| Item | | Unit | 0.0 | 0.5 | 1.0 | 0.0 | 0.5 | 1.0 | 0.0 | 0.5 | 1.0 |
|---|---|---|---|---|---|---|---|---|---|---|---|
| Specific | HFO-1132a | mass % | 1.5 | 1.5 | 1.5 | 3.0 | 3.0 | 3.0 | 4.6 | 4.6 | 4.6 |
| coordinates | R32 | mass % | 73.9 | 73.9 | 73.9 | 73.9 | 73.9 | 73.9 | 73.9 | 73.9 | 73.9 |
| | HFO-1132E | mass % | 0.0 | 0.0 | 0.0 | 0.0 | 0.0 | 0.0 | 0.0 | 0.0 | 0.0 |
| | R1234(ze + yf) | mass % | 24.6 | 24.6 | 24.6 | 23.1 | 23.1 | 23.1 | 21.5 | 21.5 | 21.5 |

| r | x = R32 approximate expression | | 73.9 | 73.9 | 73.9 |
|---|---|---|---|---|---|
| approximate | y = HFO-1132E approximate expression | | 0.0 | 0.0 | 0.0 |
| expression | z = R1234(ze + yf) approximate expression | | 24.6 | 23.1 | 21.5 |
| x, y, z | x | a = HFO-1132a | 1.5 | 3.0 | 4.6 |
| approximate | | Quadratic coefficient | 0 | 0 | 0 |
| expressions | | Linear coefficient | 0 | 0 | 0 |
| represented | | Zero coefficient | 24.6 | 23.1 | 21.5 |

| | | |
|---|---|---|
| by a and r | x approximate expression | 73.9 |
| | y approximate expression | 0.0 |
| | z approximate expression | −x + 26.1 |

Point B′

[symbol]

B′ [symbol] (r = R1234ze/(R1234ze + R1234yf))

| Item | | Unit | 0.0 | 0.5 | 1.0 | 0.0 | 0.5 | 1.0 | 0.0 | 0.5 | 1.0 |
|---|---|---|---|---|---|---|---|---|---|---|---|
| Specific | HFO-1132a | mass % | 1.5 | 1.5 | 1.5 | 3.0 | 3.0 | 3.0 | 4.6 | 4.6 | 4.6 |
| coordinates | R32 | mass % | 58.9 | 59.0 | 59.0 | 58.9 | 59.0 | 59.1 | 59.0 | 59.0 | 59.0 |
| | HFO-1132E | mass % | 0.0 | 0.0 | 0.0 | 0.0 | 0.0 | 0.0 | 0.0 | 0.0 | 0.0 |
| | R1234(ze + yf) | mass % | 39.6 | 39.5 | 39.5 | 38.1 | 39.0 | 37.9 | 36.4 | 36.4 | 36.4 |

| r | x = R32 approximate expression | | −0.2r² + 0.3r + 58.9 | 0.2r + 58.9 | 59.0 |
|---|---|---|---|---|---|
| approximate | y = HFO-1132E approximate expression | | 0.0 | 0.0 | 0.0 |
| expression | z = R1234(ze + yf) approximate expression | | 100-a-x | 100-a-x | 36.4 |
| x, y, z | y | a = HFO-1132a | 1.5 | 3.0 | 4.6 |
| approximate | | Quadratic coefficient | −0.2 | 0 | 0 |
| expressions | | Linear coefficient | 0.3 | 0.2 | 0 |
| represented | | Zero coefficient | 58.9 | 58.9 | 59 |

| | | |
|---|---|---|
| by a and r | x approximate expression | (−0.043a² + 0.3269a − 0.5935)r² + (−0.0188a² + 0.018a + |
| | | 0.3153)r + (0.0202a² − 0.0907a + 58.991) |
| | y approximate expression | 0.0 |
| | z approximate expression | 100-a-x |

[symbol]

indicates data missing or illegible when filed

TABLE 5
Point C

[symbol]

C [symbol] (r = R1234ze/(R1234ze + R1234yf))

| Item | | Unit | 0.0 | 0.5 | 1.0 | 0.0 | 0.5 | 1.0 | 0.0 | 0.5 | 1.0 |
|---|---|---|---|---|---|---|---|---|---|---|---|
| Specific | HFO-1132a | mass % | 1.5 | 1.5 | 1.5 | 3.0 | 3.0 | 3.0 | 4.6 | 4.6 | 4.6 |
| coordinates | R32 | mass % | 56.2 | 50.7 | 44.7 | 52.8 | 47.4 | 41.7 | 49.3 | 44.0 | 38.7 |
| | HFO-1132E | mass % | 0.0 | 0.0 | 0.0 | 0.0 | 0.0 | 0.0 | 0.0 | 0.0 | 0.0 |
| | R1234(ze + yf) | mass % | 42.3 | 47.8 | 53.8 | 44.2 | 49.6 | 55.3 | 46.1 | 51.4 | 56.7 |

| r | x = R32 approximate expression | | −r² − 10.5r + 56.2 | −0.6r² − 10.5r + 52.8 | −10.6r + 49.3 |
|---|---|---|---|---|---|
| approximate | y = HFO-1132E approximate expression | | 0.0 | 0.0 | 0.0 |
| expression | z = R1234(ze + yf) approximate expression | | 100-a-x | 100-a-x | 100-a-x |
| x, y, z | x | a = HFO-1132a | 1.5 | 3.0 | 4.6 |
| approximate | | Quadratic coefficient | −1 | −0.6 | 0 |
| expressions | | Linear coefficient | −10.5 | −10.5 | −10.6 |
| represented | | Zero coefficient | 56.2 | 52.8 | 49.3 |

| by a and r | x approximate expression | (0.0349a² + 0.1094a − 1.2427)r² + (−0.0202a² + 0.0907a − |
|---|---|---|
| | | 10.591)r + (0.0255a² − 2.3816a + 59.715) |
| | y approximate expression | 0.0 |
| | z approximate expression | 100-a-x |
| Point D [symbol] | | |
| | | D [symbol] (r = R1234ze/(R1234ze + R1234yf)) |

| Item | | Unit | 0.0 | 0.5 | 1.0 | 0.0 | 0.5 | 1.0 | 0.0 | 0.5 | 1.0 |
|---|---|---|---|---|---|---|---|---|---|---|---|
| Specific | HFO-1132a | mass % | 1.5 | 1.5 | 1.5 | 3.0 | 3.0 | 3.0 | 4.6 | 4.6 | 4.6 |
| coordinates | R32 | mass % | 0.0 | 0.0 | 0.0 | 0.0 | 0.0 | 0.0 | 0.0 | 0.0 | 0.0 |
| | HFO-1132E | mass % | 71.2 | 67.5 | 63.2 | 66.3 | 62.4 | 58.2 | 61.2 | 57.4 | 53.1 |
| | R1234(ze + yf) | mass % | 27.3 | 31.0 | 35.3 | 30.7 | 34.6 | 38.8 | 34.2 | 38.0 | 42.3 |

| r | x = R32 approximate expression | | 0.0 | 0.0 | 0.0 |
|---|---|---|---|---|---|
| approximate | y = HFO-1132E approximate expression | | −1.2r² − 6.8r + 71.2 | −0.6r² − 7.5r + 66.3 | −r² − 7.1r + 61.2 |
| expression | z = R1234(ze + yf) approximate expression | | 100-a-y | 100-a-y | 100-a-y |
| x, y, z | y | a = HFO-1132a | 1.5 | 3.0 | 4.6 |
| approximate | | Quadratic coefficient | −1.2 | −0.6 | −1 |
| expressions | | Linear coefficient | −6.8 | −7.5 | −7.1 |
| represented | | Zero coefficient | 71.2 | 66.3 | 51.2 |

| | | |
|---|---|---|
| by a and r | x approximate expression | 0.0 |
| | y approximate expression | (−0.2097a² + 1.3435a − 2.7435)r² + (0.2312a² − 1.507a − |
| | | 5.0597)r + (0.0255a² − 3.3816a + 76.215) |
| | z approximate expression | 100-a-y |

[symbol]

indicates data missing or illegible when filed

TABLE 6
Point Br

B [symbol] (r = R1234ze/(R1234ze + R1234yf))

| Item | | Unit | 0.0 | 0.5 | 1.0 | 0.0 | 0.5 | 1.0 | 0.0 | 0.5 | 1.0 |
|---|---|---|---|---|---|---|---|---|---|---|---|
| Specific | HFO-1132a | mass % | 4.6 | 4.6 | 4.6 | 7.0 | 7.0 | 7.0 | 10.0 | 10.0 | 10.0 |
| coordinates | R32 | mass % | 73.9 | 73.9 | 73.9 | 73.9 | 73.9 | 73.9 | 73.9 | 73.9 | 73.9 |
| | HFO-1132E | mass % | 0.0 | 0.0 | 0.0 | 0.0 | 0.0 | 0.0 | 0.0 | 0.0 | 0.0 |
| | R1234(ze + yf) | mass % | 21.5 | 21.5 | 21.5 | 19.1 | 19.1 | 19.1 | 16.1 | 16.1 | 16.1 |

| r | x = R32 approximate expression | | 73.9 | 73.9 | 73.9 |
|---|---|---|---|---|---|
| approximate | y = HFO-1132E approximate expression | | 0.0 | 0.0 | 0.0 |
| expression | z = R1234(ze + yf) approximate expression | | 21.5 | 19.1 | 16.1 |
| x, y, z | x | a = HFO-1132a | 4.6 | 7.0 | 10.0 |
| approximate | | Quadratic coefficient | 0 | 0 | 0 |
| expressions | | Linear coefficient | 0 | 0 | 0 |
| represented | | Zero coefficient | 21.5 | 19.1 | 16.1 |

| | | |
|---|---|---|
| by a and r | x approximate expression | 73.9 |
| | y approximate expression | 0.0 |
| | z approximate expression | −x + 26.1 |

Point B′r

B′ [symbol] (r = R1234ze/(R1234ze + R1234yf))

| Item | | Unit | 0.0 | 0.5 | 1.0 | 0.0 | 0.5 | 1.0 | 0.0 | 0.5 | 1.0 |
|---|---|---|---|---|---|---|---|---|---|---|---|
| Specific | HFO-1132a | mass % | 4.6 | 4.6 | 4.6 | 7.0 | 7.0 | 7.0 | 10.0 | 10.0 | 10.0 |
| coordinates | R32 | mass % | 59.0 | 59.0 | 59.0 | 59.0 | 59.0 | 59.1 | 59.0 | 59.0 | 59.1 |
| | HFO-1132E | mass % | 0.0 | 0.0 | 0.0 | 0.0 | 0.0 | 0.0 | 0.0 | 0.0 | 0.0 |
| | R1234(ze + yf) | mass % | 36.4 | 36.4 | 36.4 | 34.0 | 34.0 | 33.9 | 31.0 | 31.0 | 30.9 |

| r | x = R32 approximate expression | | 59.0 | 0.1r + 58.983 | 0.1r + 58.983 |
|---|---|---|---|---|---|
| approximate | y = HFO-1132E approximate expression | | 0.0 | 0.0 | 0.0 |
| expression | z = R1234(ze + yf) approximate expression | | 36.4 | 100-a-x | 36.4 |
| x, y, z | x | a = HFO-1132a | 4.6 | 7.0 | 10.0 |
| approximate | | Quadratic coefficient | 0 | 0 | 0 |
| expressions | | Linear coefficient | 0 | 0.1 | 0.1 |
| represented | | Zero coefficient | 59 | 58.983 | 58.983 |

| | | |
|---|---|---|
| by a and r | x approximate expression | (−0.0077a² + 0.1312a − 0.4401)r + (0.0013a² − 0.0223a + 59.075) |
| | y approximate expression | 0.0 |
| | z approximate expression | 100-a-x |

[symbol]

indicates data missing or illegible when filed

TABLE 7
Point Cr

C [symbol] (r = R1234ze/(R1234ze + R1234yf))

| Item | | Unit | 0.0 | 0.5 | 1.0 | 0.0 | 0.5 | 1.0 | 0.0 | 0.5 | 1.0 |
|---|---|---|---|---|---|---|---|---|---|---|---|
| Specific | HFO-1132a | mass % | 4.6 | 4.6 | 4.6 | 7.0 | 7.0 | 7.0 | 10.0 | 10.0 | 10.0 |
| coordinates | R32 | mass % | 49.3 | 44.0 | 38.7 | 44.1 | 39.2 | 34.3 | 37.7 | 33.2 | 29.1 |
| | HFO-1132E | mass % | 0.0 | 0.0 | 0.0 | 0.0 | 0.0 | 0.0 | 0.0 | 0.0 | 0.0 |
| | R1234(ze + yf) | mass % | 46.1 | 51.4 | 56.7 | 48.9 | 53.8 | 58.7 | 52.3 | 56.8 | 60.9 |

| r | x = R32 approximate expression | | −10.6r + 49.3 | −9.8r + 44.1 | 0.8r² − 9.4r + 37.7 |
|---|---|---|---|---|---|
| approximate | y = HFO-1132E approximate expression | | 0.0 | 0.0 | 0.0 |
| expression | z = R1234(ze + yf) approximate expression | | 100-a-x | 100-a-x | 100-a-x |
| x, y, z | x | a = HFO-1132a | 4.6 | 7.0 | 10.0 |
| approximate | | Quadratic coefficient | 0 | 0 | 0.8 |
| expressions | | Linear coefficient | −10.6 | −9.8 | −9.4 |
| represented | | Zero coefficient | 49.3 | 44.1 | 37.7 |

| | | |
|---|---|---|
| by a and r | x approximate expression | (0.0494a² − 0.5728a + 1.5901)r² + (−0.037a² + 0.763a − |
| | | 13.326)r + (0.0062a² − 2.2383a + 59.465) |
| | y approximate expression | 0.0 |
| | z approximate expression | 100-a-x |

Point Dr

D [symbol] (r = R1234ze/(R1234ze + R1234yf))

| Item | | Unit | 0.0 | 0.5 | 1.0 | 0.0 | 0.5 | 1.0 | 0.0 | 0.5 | 1.0 |
|---|---|---|---|---|---|---|---|---|---|---|---|
| Specific | HFO-1132a | mass % | 4.6 | 4.6 | 4.6 | 7.0 | 7.0 | 7.0 | 10.0 | 10.0 | 10.0 |
| coordinates | R32 | mass % | 0.0 | 0.0 | 0.0 | 0.0 | 0.0 | 0.0 | 0.0 | 0.0 | 0.0 |
| | HFO-1132E | mass % | 61.2 | 57.4 | 53.1 | 53.9 | 50.0 | 46.1 | 45.2 | 41.6 | 38.1 |
| | R1234(ze + yf) | mass % | 34.2 | 38.0 | 42.3 | 39.1 | 43.0 | 46.9 | 44.8 | 48.4 | 51.9 |

| r | x = R32 approximate expression | | 0.0 | 0.0 | 0.0 |
|---|---|---|---|---|---|
| approximate | y = HFO-1132E approximate expression | | −r² − 7.1r + 61.2 | −7.8r + 53.9 | 0.2r² − 7.3r + 45.2 |
| expression | z = R1234(ze + yf) approximate expression | | 100-a-y | 100-a-y | 100-a-y |
| x, y, z | x | a = HFO-1132a | 4.6 | 7.0 | 10.0 |
| approximate | | Quadratic coefficient | −1 | 0 | 0.2 |
| expressions | | Linear coefficient | −7.1 | −7.8 | −7.3 |
| represented | | Zero coefficient | 61.2 | 53.9 | 45.2 |

| | | |
|---|---|---|
| by a and r | x approximate expression | 0.0 |
| | y approximate expression | (−0.0548a² + 1.1685a − 5.0037)r² + (0.0849a² − 1.2762a − |
| | | 3.0253)r + (0.0262a² − 3.346a + 76.036) |
| | z approximate expression | 100-a-y |

[symbol]

indicates data missing or illegible when filed

The mixed refrigerants further comprising R1234yf in addition to R32, HFO-1132(E), R1234ze, and HFO-1132a have a GWP of 500 or less and a refrigerating capacity ratio of 85% or more relative to that of R410A, because they satisfy the following requirements.

### Requirements

When the mass % of R32 is represented by f, the mass % of HFO-1132(E) is represented by y, the total mass % of R1234ze and R1234yf is represented by z, and the mass % of HFO-1132a is represented by a, provided that 1.5≤a≤10.0, based on the sum of R32, HFO-1132(E), R1234ze, R1234yf, and HFO-1132a, and r=R1234yf/(R1234ze+R1234yf),

if 1.5≤a≤4.6, coordinates (x,y,z) in a ternary composition diagram having R32 as a first vertex, HFO-1132(E) as a second vertex, and the sum of R1234ze and R1234yf as a third vertex are within the range of a figure surrounded by straight lines ABᵣ, BᵣCᵣ, CᵣDᵣ, DᵣO, and OA that connect the following 5 points:

point A (74.0, −a+26.0, 0.0),
point Bᵣ (73.9, 0.0, −a+26.1),
point Cᵣ ((0.0349a²+0.1094a−1.2427)r²+(−0.0202a²+0.0907a−10.591)r+(0.0255a²−2.3816a+59.715), 0.0, −a−x+100.0), point D. (0.0, (−0.2097a²+1.3435a−2.7435)r²+(0.2312a²−1.507a−5.0597)r+(0.0255a²−3.3816a+76.215), −a−y+100.0), and
point O (0.0, 100.0−a, 0.0),
or on the straight lines ABᵣ and CᵣDᵣ (excluding the points A, Bᵣ, Cᵣ, and Dᵣ); or

if 4.6≤a≤10.0, coordinates (x,y,z) in the ternary composition diagram are within the range of a figure surrounded by straight lines ABᵣ, BᵣCᵣ, CᵣDᵣ, DᵣO, and OA that connect the following 5 points:

point A (74.0, −a+26.0, 0.0),
point Bᵣ (73.9, 0.0, −a+26.1),
point Cᵣ ((0.0494a²−0.5728a+1.5901)r²+(−0.037a²+0.763a−13.326)r+(0.0062a²−2.2383a+59.465), 0.0, −a−x+100.0),
point Dᵣ (0.0, (−0.0648a²+1.1685a−5.0037)r²+(0.0849a²−1.2762a−3.0253)r+(0.0262a²−3.346a+76.036), −a−y+100.0), and
point O (0.0, 100.0−a, 0.0),
or on the straight lines ABᵣ and CᵣDᵣ (excluding the points A, Bᵣ, Cᵣ, and Dᵣ).

The mixed refrigerants further comprising R1234yf in addition to R32, HFO-1132(E), R1234ze, and HFO-1132a have a GWP of 400 or less and a refrigerating capacity ratio of 85% or more relative to that of R410A, because they satisfy the following requirements.

### Requirements

When the mass % of R32 is represented by x, the mass % of HFO-1132(E) is represented by y, the total mass % of R1234ze and R1234yf is represented by z, and the mass % of HFO-1132a is represented by a, provided that 1.5≤a≤10.0, based on the sum of R32, HFO-1132(E), R1234ze, R1234yf, and HFO-1132a, and r=R1234yf/(R1234ze+R1234yf),

if 1.5≤a≤4.6, coordinates (x,y,z) in a ternary composition diagram having R32 as a first vertex, HFO-1132(E) as a second vertex, and the sum of R1234ze and R1234yf as a third vertex are within the range of a figure surrounded by straight lines ABᵣ′, Bᵣ′Cᵣ, CᵣDᵣ, DᵣO, and OA that connect the following 5 points:

point A′ (74.0, −a+26.0, 0.0),
point Bᵣ′ ((−0.043a²+0.3269a−0.5935) r²+(−0.0188a²+0.018a+0.3153)r+(0.0202a=−0.0907a+58.991), 0.0, −a−x+100.0),
point Cᵣ ((0.0349a²+0.1094a−1.2427)r²+(−0.0202a²=+0.0907a−10.591)r+(0.0255a²−2.3816a+59.715), 0.0, −a−x+100.0),
point Dᵣ (0.0, (−0.2097a²+1.3435a−2.7435)r²=+(0.2312a²−1.507a−5.0597)r+(0.0255a²−3.3816a+76.215), −a−y+100.0), and
point O (0.0, 100.0−a, 0.0),
or on the straight lines ABᵣ′ and CᵣDᵣ (excluding the points A, Bᵣ′, Cᵣ, and Dᵣ); or

if 4.6≤a≤10.0, coordinates (x,y,z) in the ternary composition diagram are within the range of a figure surrounded by straight lines ABᵣ′, Bᵣ′Cᵣ, CᵣDᵣ, DᵣO, and OA that connect the following 5 points:

point A (74.0, −a+26.0, 0.0),
point Bᵣ′ ((−0.0077a²+0.1312a−0.4401)r+(0.0013a=−0.0223a+59.075), 0.0, −a−x+100.0),
point Cᵣ ((0.0494a²−0.5728a+1.5901)r₂+(−0.037a²+0.763a−13.326)r+(0.0062a²−2.2383a+59.465), 0.0, −a−x+100.0),
point Dᵣ (0.0, (−0.0648a²+1.1685a−5.0037)r²+(0.0849a=−1.2762a−3.0253)r+(0.0262a²−3.346a+76.036), −a−y+100.0), and
point O (0.0, 100.0−a, 0.0),
or on the straight lines ABᵣ′ and CᵣDᵣ (excluding the points A, Bᵣ′, Cᵣ, and Dᵣ).

Further, the mixed refrigerants shown in the following tables were also evaluated, and the above effects were confirmed.

TABLE 8

| | | Com | | | Com | | | | Com | |
|---|---|---|---|---|---|---|---|---|---|---|
| Item | Unit | Ex. 83 | Ex. 6 | Ex. 7 | Ex. 84 | Ex. 8 | Ex. 9 | Ex. 10 | Ex. 85 | Ex. 11 |
| HFO-1132a | mass % | 1.5 | 1.5 | 1.5 | 1.5 | 1.5 | 1.5 | 1.5 | 1.5 | 1.5 |
| R32 | mass % | 10.0 | 10.0 | 10.0 | 20.0 | 20.0 | 20.0 | 20.0 | 30.0 | 30.0 |
| HFO-1132 (E) | mass % | 50.0 | 70.0 | 80.0 | 40.0 | 50.0 | 50.0 | 70.0 | 20.0 | 40.0 |
| R1234(yf + ze) (r = 0) | mass % | 38.5 | 18.5 | 8.5 | 38.5 | 28.5 | 18.5 | 8.5 | 48.5 | 28.5 |
| GWP | — | 70 | 69 | 69 | 138 | 137 | 137 | 136 | 206 | 205 |
| COP ratio | % (relative | 100.9 | 99.1 | 98.5 | 101.1 | [symbol] | 99.0 | 98.3 | 102.9 | 100.2 |
| | to R410A) | | | | | | | | | |
| Refrigerating | % (relative | 81.9 | 93.8 | 99.6 | 84.5 | 90.7 | 96.8 | 102.7 | 79.7 | 92.8 |
| capacity ratio | to R410A) | | | | | | | | | |
| Condensation | ° C. | 7.9 | 4.2 | 2.5 | 8.0 | 6.0 | 4.1 | 2.4 | 9.7 | 5.9 |
| glide | | | | | | | | | | |

| | | | | Com | | | | | |
|---|---|---|---|---|---|---|---|---|---|
| Item | Unit | Ex. 12 | Ex. 13 | Ex. 86 | Ex. 14 | Ex. 15 | Ex. 16 | Ex. 17 | Ex. 18 |
| HFO-1132a | mass % | 1.5 | 1.5 | 1.5 | 1.5 | 1.5 | 1.5 | 1.5 | 1.5 |
| R32 | mass % | 30.0 | 30.0 | 40.0 | 40.0 | 40.0 | 40.0 | 50.0 | 50.0 |
| HFO-1132 (E) | mass % | 50.0 | 60.0 | 10.0 | 30.0 | 40.0 | 50.0 | 10.0 | 20.0 |
| R1234(yf + ze) (r = 0) | mass % | 18.5 | 8.5 | 48.5 | 28.5 | 18.5 | 8.5 | 38.5 | 28.5 |
| GWP | — | 204 | 204 | 273 | 272 | 272 | 271 | 340 | 339 |
| COP ratio | % (relative | [symbol] | 98.4 | 103.4 | 100.7 | 99.8 | [symbol] | 102.6 | 101.3 |
| | to R410A) | | | | | | | | |
| Refrigerating | % (relative | 99.0 | 105.1 | 80.5 | [symbol] | 100.7 | 107.0 | 87.9 | 94.9 |
| capacity ratio | to R410A) | | | | | | | | |
| Condensation | ° C. | 3.0 | 2.2 | [symbol] | [symbol] | 3.8 | 2.0 | [symbol] | 5.3 |
| glide | | | | | | | | | |
| | | | | | | | | | Com |
| Item | Unit | Ex. 19 | Ex. 20 | Ex. 21 | Ex. 22 | Ex. 23 | Ex. 24 | Ex. 25 | Ex. 87 |
| HFO-1132a | mass % | 1.5 | 1.5 | 1.5 | 1.5 | 1.5 | 1.5 | 1.5 | 1.5 |
| R32 | mass % | 50.0 | 50.0 | 60.0 | 60.0 | 60.0 | 70.0 | 70.0 | 80.0 |
| HFO-1132 (E) | mass % | 30.0 | 40.0 | 10.0 | 20.0 | 30.0 | 10.0 | 20.0 | 10.0 |
| R1234(yf + ze) (r = 0) | mass % | 18.5 | 8.5 | 28.5 | 18.5 | 8.5 | 18.5 | 8.5 | 8.5 |
| GWP | — | 338 | 338 | 407 | 405 | 405 | 474 | 473 | 541 |
| COP ratio | % (relative | 100.2 | 99.3 | 102.1 | 101.0 | 99.9 | 101.8 | 100.7 | 101.5 |
| | to R410A) | | | | | | | | |
| Refrigerating | % (relative | 101.7 | 108.2 | 95.0 | 102.0 | 108.7 | 101.8 | [symbol] | 107.9 |
| capacity ratio | to R410A) | | | | | | | | |
| Condensation | ° C. | [symbol] | 1.9 | 4.9 | 3.4 | [symbol] | 3.1 | 1.8 | 1.7 |
| glide | | | | | | | | | |

| | | Com | | | Com | | | | Com | |
|---|---|---|---|---|---|---|---|---|---|---|
| Item | Unit | Ex. 88 | Ex. 26 | Ex. 27 | Ex. 89 | Ex. 28 | Ex. 29 | Ex. 30 | Ex. 90 | Ex. 31 |
| HFO-1132a | mass % | 1.5 | 1.5 | 1.5 | 1.5 | 1.5 | 1.5 | 1.5 | 1.5 | 1.5 |
| R32 | mass % | 10.0 | 10.0 | 10.0 | 20.0 | 20.0 | 20.0 | 20.0 | 30.0 | 30.0 |
| HFO-1132 (E) | mass % | 50.0 | 70.0 | 80.0 | 30.0 | 50.0 | 60.0 | 70.0 | 20.0 | 40.0 |
| R1234(yf + ze) (r = 0.25) | mass % | 38.5 | 18.5 | 8.5 | 48.5 | 28.5 | 18.5 | 8.5 | 48.5 | 28.5 |
| GWP | — | 70 | 69 | 69 | 138 | 137 | 137 | 136 | 205 | 204 |
| COP ratio | % (relative | 100.4 | 98.8 | 98.5 | 101.7 | 99.6 | 98.8 | [symbol] | 102.1 | 99.8 |
| | to R410A) | | | | | | | | | |
| Refrigerating | % (relative | [symbol] | 94.5 | 99.9 | 79.9 | 91.8 | 97.5 | 103.0 | 81.5 | 94.0 |
| capacity ratio | to R410A) | | | | | | | | | |
| Condensation | ° C. | 6.9 | 3.7 | 2.3 | [symbol] | 5.2 | 3.6 | 2.2 | 8.4 | 5.1 |
| glide | | | | | | | | | | |
| | | | | Com | | | | | | |
| Item | Unit | Ex. 32 | Ex. 33 | Ex. 91 | Ex. 34 | Ex. 35 | Ex. 36 | Ex. 37 | Ex. 38 | Ex. 39 |
| HFO-1132a | mass % | 1.5 | 1.5 | 1.5 | 1.5 | 1.5 | 1.5 | 1.5 | 1.5 | 1.5 |
| R32 | mass % | 30.0 | 30.0 | 40.0 | 40.0 | 40.0 | 40.0 | 40.0 | 50.0 | 50.0 |
| HFO-1132 (E) | mass % | 50.0 | 50.0 | 10.0 | 20.0 | 30.0 | 40.0 | 50.0 | 10.0 | 20.0 |
| R1234(yf + ze) (r = 0.25) | mass % | 18.5 | 8.5 | 48.5 | 38.5 | 28.5 | 18.5 | 8.5 | 38.5 | 28.5 |
| GWP | — | 204 | 204 | 273 | 272 | 272 | 271 | 271 | 340 | 339 |
| COP ratio | % (relative | 99.0 | 98.3 | 102.7 | 101.4 | 100.3 | 99.4 | 98.7 | 102.2 | 101.0 |
| | to R410A) | | | | | | | | | |
| Refrigerating | % (relative | 99.9 | 105.5 | 82.4 | 89.1 | 95.4 | 101.5 | 107.4 | 89.6 | 96.2 |
| capacity ratio | to R410A) | | | | | | | | | |
| Condensation | ° C. | 3.4 | 1.9 | 7.7 | 6.4 | 4.8 | 3.3 | [symbol] | [symbol] | 4.5 |
| glide | | | | | | | | | | |

| | | | | | | | | | Com |
|---|---|---|---|---|---|---|---|---|---|
| Item | Unit | Ex. 40 | Ex. 41 | Ex. 42 | Ex. 43 | Ex. 44 | Ex. 45 | Ex. 46 | Ex. 92 |
| HFO-1132a | mass % | 1.5 | 1.5 | 1.5 | 1.5 | 1.5 | 1.5 | 1.5 | 1.5 |
| R32 | mass % | 50.0 | 50.0 | 60.0 | 60.0 | 60.0 | 70.0 | 70.0 | 80.0 |
| HFO-1132 (E) | mass % | 30.0 | 40.0 | 10.0 | 20.0 | 30.0 | 10.0 | 20.0 | 10.0 |
| R1234(yf + ze) (r = 0.25) | mass % | 18.5 | 8.5 | 28.5 | 18.5 | 8.5 | 18.5 | 8.5 | 8.5 |
| GWP | — | 339 | 338 | 407 | 406 | 406 | 474 | 473 | 541 |
| COP ratio | % (relative | 100.0 | 99.2 | 101.8 | 100.8 | 99.8 | 101.6 | 100.6 | 101.4 |
| | to R410A) | | | | | | | | |
| Refrigerating | % (relative | 102.5 | 108.5 | 96.3 | 102.9 | 109.1 | 102.6 | 109.0 | 108.3 |
| capacity ratio | to R410A) | | | | | | | | |
| Condensation | ° C. | 3.1 | 1.7 | 4.1 | 2.9 | [symbol] | 2.7 | 1.5 | 1.5 |
| glide | | | | | | | | | |

[symbol]

indicates data missing or illegible when filed

TABLE 9

| | | Com | | | | Com | | | | Com | |
|---|---|---|---|---|---|---|---|---|---|---|---|
| Item | Unit | Ex. 93 | Ex. 47 | Ex. 48 | Ex. 49 | Ex. 94 | Ex. 50 | Ex. 51 | Ex. 52 | Ex. 95 | Ex. 53 |
| HFO-1132a | mass % | 1.5 | 1.5 | 1.5 | 1.5 | 1.5 | 1.5 | 1.5 | 1.5 | 1.5 | 1.5 |
| R32 | mass % | 10.0 | 10.0 | 10.0 | 10.0 | 20.0 | 20.0 | 20.0 | 20.0 | 30.0 | 30.0 |
| HFO-1132 (E) | mass % | 40.0 | 50.0 | 70.0 | 80.0 | 30.0 | 60.0 | 60.0 | 70.0 | 20.0 | 30.0 |
| R1234(yf + ze) (r = 0.5) | mass % | 48.5 | 28.5 | 18.5 | 8.5 | 48.5 | 28.5 | 18.5 | 8.5 | 48.5 | 38.5 |
| GWP | — | 70 | 70 | 69 | 69 | 138 | 137 | 137 | 136 | 205 | 205 |
| COP ratio | % (relative | 100.9 | 99.3 | [symbol] | 98.4 | 101.0 | 99.2 | [symbol] | 98.2 | 101.4 | 100.4 |
| | to R410A) | | | | | | | | | | |
| Refrigerating | % (relative | 79.0 | [symbol] | 95.3 | 100.3 | [symbol] | 93.0 | 98.3 | 103.4 | 83.4 | [symbol] |
| capacity ratio | to R410A) | | | | | | | | | | |
| Condensation | ° C. | 7.4 | [symbol] | 3.3 | 2.1 | 7.4 | 4.5 | 3.1 | [symbol] | 7.0 | 5.7 |
| glide | | | | | | | | | | | |

| | | | | | Com | | | | | |
|---|---|---|---|---|---|---|---|---|---|---|
| Item | Unit | Ex. 54 | Ex. 55 | Ex. 56 | Ex. 96 | Ex. 57 | Ex. 58 | Ex. 59 | Ex. 60 | Ex. 61 |
| HFO-1132a | mass % | 1.5 | 1.5 | 1.5 | 1.5 | 1.5 | 1.5 | 1.5 | 1.5 | 1.5 |
| R32 | mass % | 30.0 | 30.0 | 30.0 | 40.0 | 40.0 | 40.0 | 40.0 | 40.0 | 50.0 |
| HFO-1132 (E) | mass % | 40.0 | 50.0 | 50.0 | 10.0 | 20.0 | 30.0 | 40.0 | 50.0 | 10.0 |
| R1234(yf + ze) (r = 0.5) | mass % | 28.5 | 18.5 | 8.5 | 48.5 | 38.5 | 28.5 | 18.5 | 8.5 | 38.5 |
| GWP | — | 204 | 204 | 204 | 273 | 272 | 272 | 271 | 271 | 340 |
| COP ratio | % (relative | 99.5 | 98.8 | 98.3 | 102.0 | 100.9 | 100.0 | 99.2 | 98.6 | 101.7 |
| | to R410A) | | | | | | | | | |
| Refrigerating | % (relative | [symbol] | 100.7 | [symbol] | 84.4 | 90.7 | 96.7 | 102.4 | 107.2 | 91.3 |
| capacity ratio | to R410A) | | | | | | | | | |
| Condensation | ° C. | 4.3 | 3.0 | 1.7 | 6.4 | 5.3 | 4.0 | [symbol] | 1.5 | [symbol] |
| glide | | | | | | | | | | |
| | | | | | | | | | | Com |
| Item | Unit | Ex. 62 | Ex. 63 | Ex. 64 | Ex. 65 | Ex. 66 | Ex. 67 | Ex. 68 | Ex. 69 | Ex. 97 |
| HFO-1132a | mass % | 1.5 | 1.5 | 1.5 | 1.5 | 1.5 | 1.5 | 1.5 | 1.5 | 1.5 |
| R32 | mass % | 50.0 | 50.0 | 50.0 | 60.0 | 60.0 | 60.0 | 70.0 | 70.0 | 80.0 |
| HFO-1132 (E) | mass % | 20.0 | 30.0 | 40.0 | 10.0 | 20.0 | 30.0 | 10.0 | 20.0 | 10.0 |
| R1234(yf + ze) (r = 0.5) | mass % | 28.5 | 18.5 | 8.5 | 28.5 | 18.5 | 8.5 | 18.5 | 8.5 | 8.5 |
| GWP | — | 339 | 339 | 338 | 407 | 406 | 406 | 474 | 473 | 541 |
| COP ratio | % (relative | 100.7 | 99.8 | 99.1 | 101.6 | 100.6 | 99.8 | 101.5 | 100.5 | 101.3 |
| | to R410A) | | | | | | | | | |
| Refrigerating | % (relative | 97.5 | 103.4 | 108.9 | 97.5 | 103.7 | 109.5 | 103.4 | 109.4 | 108.7 |
| capacity ratio | to R410A) | | | | | | | | | |
| Condensation | ° C. | 3.7 | 2.6 | 1.5 | 3.4 | 2.5 | 1.4 | 2.3 | 1.4 | 1.3 |
| glide | | | | | | | | | | |

| | | Com | | | | Com | | | | Com | |
|---|---|---|---|---|---|---|---|---|---|---|---|
| Item | Unit | Ex. 98 | Ex. 70 | Ex. 71 | Ex. 72 | Ex. 99 | Ex. 73 | Ex. 74 | Ex. 75 | Ex. 10 [symbol] | Ex. 76 |
| HFO-1132a | mass % | 1.5 | 1.5 | 1.5 | 1.5 | 1.5 | 1.5 | 1.5 | 1.5 | 1.5 | 1.5 |
| R32 | mass % | 10.0 | 10.0 | 10.0 | 10.0 | 20.0 | 20.0 | 20.0 | 20.0 | 30.0 | 30.0 |
| HFO-1132 (E) | mass % | 40.0 | 60.0 | 70.0 | 80.0 | 30.0 | 50.0 | 60.0 | 70.0 | 15.0 | 30.0 |
| R1234(yf + ze) (r = 0.75) | mass % | 48.5 | 28.5 | 18.5 | 8.5 | 48.5 | 28.5 | 18.5 | 8.5 | 53.5 | 38.5 |
| GWP | — | 70 | 69 | 69 | 69 | 137 | 137 | 136 | 136 | 205 | 205 |
| COP ratio | % (relative | 100.2 | 89.0 | 98.6 | 98.3 | 100.4 | 98.9 | 98.4 | 98.1 | 101.3 | 99.9 |
| | to R410A) | | | | | | | | | | |
| Refrigerating | % (relative | [symbol] | 91.1 | [symbol] | 100.5 | 83.3 | 94.1 | 99.1 | 103.8 | 82.2 | 91.0 |
| capacity ratio | to R410A) | | | | | | | | | | |
| Condensation | ° C. | 6.3 | 3.8 | 2.8 | 1.9 | 6.2 | 3.8 | 2.7 | 1.7 | 6.3 | 4.7 |
| glide | | | | | | | | | | | |

| | | | | | Com | | | | | |
|---|---|---|---|---|---|---|---|---|---|---|
| Item | Unit | Ex. 77 | Ex. 78 | Ex. 79 | Ex. 10 [symbol] | Ex. 80 | Ex. 81 | Ex. 82 | Ex. 83 | Ex. 84 |
| HFO-1132a | mass % | 1.5 | 1.5 | 1.5 | 1.5 | 1.5 | 1.5 | 1.5 | 1.5 | 1.5 |
| R32 | mass % | 30.0 | 30.0 | 30.0 | 40.0 | 40.0 | 40.0 | 40.0 | 40.0 | 50.0 |
| HFO-1132 (E) | mass % | 40.0 | 50.0 | 60.0 | 5.0 | 20.0 | 30.0 | 40.0 | 50.0 | 10.0 |
| R1234(yf + ze) (r = 0.75) | mass % | 28.5 | 18.5 | 8.5 | 53.5 | 38.5 | 28.5 | 18.5 | 8.5 | 38.5 |
| GWP | — | 204 | 204 | 203 | 272 | 272 | 272 | 271 | 271 | 339 |
| COP ratio | % (relative | 99.1 | 98.6 | 98.2 | 101.9 | 100.5 | 99.7 | 99.0 | 98.5 | 101.3 |
| | to R410A) | | | | | | | | | |
| Refrigerating | % (relative | [symbol] | 101.5 | 105.3 | 83.1 | 92.3 | 97.9 | 103.2 | 108.1 | 92.9 |
| capacity ratio | to R410A) | | | | | | | | | |
| Condensation | ° C. | 3.5 | 2.5 | 1.5 | 5.6 | 4.3 | 3.3 | 2.3 | 1.4 | 3.8 |
| glide | | | | | | | | | | |
| | | | | | | | | | | Com |
| Item | Unit | Ex. 85 | Ex. 86 | Ex. 87 | Ex. 88 | Ex. 89 | Ex. 90 | Ex. 91 | Ex. 92 | Ex. 102 |
| HFO-1132a | mass % | 1.5 | 1.5 | 1.5 | 1.5 | 1.5 | 1.5 | 1.5 | 1.5 | 1.5 |
| R32 | mass % | 50.0 | 50.0 | 50.0 | 60.0 | 60.0 | 60.0 | 70.0 | 70.0 | 80.0 |
| HFO-1132 (E) | mass % | 20.0 | 30.0 | 40.0 | 10.0 | 20.0 | 30.0 | 10.0 | 20.0 | 10.0 |
| R1234(yf + ze) (r = 0.75) | mass % | 28.5 | 18.5 | 8.5 | 28.5 | 18.5 | 8.5 | 18.5 | 8.5 | 8.5 |
| GWP | — | 339 | 339 | 335 | 406 | 406 | 406 | 473 | 473 | 549 |
| COP ratio | % (relative | 100.4 | 99.6 | 99.0 | 101.3 | 100.4 | 99.7 | 101.3 | 100.4 | 101.2 |
| | to R410A) | | | | | | | | | |
| Refrigerating | % (relative | 98.5 | 104.2 | 109.3 | 98.9 | 104.6 | 109.9 | 104.2 | 109.7 | 109.0 |
| capacity ratio | to R410A) | | | | | | | | | |
| Condensation | ° C. | 3.0 | 2.2 | 1.3 | 2.7 | 2.0 | 1.2 | 1.8 | 1.2 | 1.2 |
| glide | | | | | | | | | | |

[symbol]

indicates data missing or illegible when filed

TABLE 10

| | | Com | | | | Com | | | | Com |
|---|---|---|---|---|---|---|---|---|---|---|
| Item | Unit | Ex. 10 [symbol] | Ex. 93 | Ex. 94 | Ex. 95 | Ex. 10 [symbol] | Ex. 96 | Ex. 97 | Ex. 98 | Ex. 10 [symbol] |
| HFO-1132a | mass % | 3.0 | 3.0 | 3.0 | 3.0 | 3.0 | 3.0 | 3.0 | 3.0 | 3.0 |
| R32 | mass % | 10.0 | 10.0 | 10.0 | 10.0 | 20.0 | 20.0 | 20.0 | 20.0 | 30.0 |
| HFO-1132 (E) | mass % | 45.0 | 60.0 | 70.0 | 80.0 | 35.0 | 50.0 | 60.0 | 70.0 | 20.0 |
| R1234(yf + ze) (r = 0) | mass % | 42.0 | 27.0 | 17.0 | 7.0 | 42.0 | 27.0 | 17.0 | 7.0 | 47.0 |
| GWP | — | 71 | 70 | 69 | 69 | 138 | 137 | 137 | 136 | 206 |
| COP ratio | [symbol] relative | 100.5 | 99.0 | 98.2 | 97.7 | 100.8 | 99.0 | 98.2 | 97.5 | 102.0 |
| | to R41 [symbol] | | | | | | | | | |
| Refrigerating | [symbol] relative | 81.5 | 90.6 | 96.5 | 102.3 | 83.9 | 93.3 | 99.4 | 105.3 | 82.2 |
| capacity r [symbol] | to R41 [symbol] | | | | | | | | | |
| Condensation | ° C. | 10.0 | 6.9 | 4.9 | 3.2 | 9.8 | 6.7 | 4.7 | 2.9 | 10.5 |
| glide | | | | | | | | | | |
| | | | | | Com | | | | | |
| Item | Unit | Ex. 99 | Ex. 100 | Ex. 101 | Ex. 10 [symbol] | Ex. 102 | Ex. 103 | Ex. 104 | Ex. 105 | Ex. 106 |
| HFO-1132a | mass % | 3.0 | 3.0 | 3.0 | 3.0 | 3.0 | 3.0 | 3.0 | 3.0 | 3.0 |
| R32 | mass % | 30.0 | 30.0 | 30.0 | 40.0 | 40.0 | 40.0 | 40.0 | 40.0 | 50.0 |
| HFO-1132 (E) | mass % | 40.0 | 50.0 | 60.0 | 10.0 | 20.0 | 30.0 | 40.0 | 50.0 | 10.0 |
| R1234(yf + ze) (r = 0) | mass % | 27.0 | 17.0 | 7.0 | 47.0 | 37.0 | 27.0 | 17.0 | 7.0 | 37.0 |
| GWP | — | 205 | 204 | 204 | 273 | 272 | 272 | 271 | 271 | 340 |
| COP ratio | [symbol] relative | 99.4 | 98.4 | 97.6 | 102.7 | 101.2 | 99.9 | 98.9 | 98.0 | 102.0 |
| | to R41 [symbol] | | | | | | | | | |
| Refrigerating | [symbol] relative | 95.3 | 101.6 | 107.7 | 82.9 | 89.9 | 95.6 | 103.1 | 109.4 | 90.3 |
| capacity r [symbol] | to R41 [symbol] | | | | | | | | | |
| Condensation | ° C. | 5.4 | 4.4 | 2.5 | 9.8 | 8.1 | 6.1 | 4.1 | 2.3 | 7.5 |
| glide | | | | | | | | | | |
| | | | | | | | | | | Com |
| Item | Unit | Ex. 107 | Ex. 108 | Ex. 109 | Ex. 110 | Ex. 111 | Ex. 112 | Ex. 113 | Ex. 114 | Ex. 107 |
| HFO-1132a | mass % | 3.0 | 3.0 | 3.0 | 3.0 | 3.0 | 3.0 | 3.0 | 3.0 | 3.0 |
| R32 | mass % | 50.0 | 50.0 | 50.0 | 60.0 | 60.0 | 60.0 | 70.0 | 70.0 | 80.0 |
| HFO-1132 (E) | mass % | 20.0 | 30.0 | 40.0 | 10.0 | 20.0 | 30.0 | 10.0 | 20.0 | 10.0 |
| R1234(yf + ze) (r = 0) | mass % | 27.0 | 17.0 | 7.0 | 27.0 | 17.0 | 7.0 | 17.0 | 7.0 | 7.0 |
| GWP | — | 339 | 339 | 338 | 407 | 406 | 406 | 474 | 473 | 541 |
| COP ratio | [symbol] relative | 100.7 | 99.6 | 98.6 | 101.5 | 100.4 | 99.3 | 101.3 | 100.1 | 101.0 |
| | to R41 [symbol] | | | | | | | | | |
| Refrigerating | [symbol] relative | 97.3 | 104.1 | 110.6 | 97.4 | 104.4 | 111.1 | 104.1 | 110.9 | 110.2 |
| capacity r [symbol] | to R41 [symbol] | | | | | | | | | |
| Condensation | ° C. | 5.7 | 3.9 | 2.2 | 5.3 | 3.7 | 2.1 | 3.5 | 2.1 | 2.0 |
| glide | | | | | | | | | | |

| | | Com | | | | Com | | | | |
|---|---|---|---|---|---|---|---|---|---|---|
| Item | Unit | Ex. 10 [symbol] | Ex. 115 | Ex. 116 | Ex. 117 | Ex. 10 [symbol] | Ex. 118 | Ex. 119 | Ex. 120 | Ex. 121 |
| HFO-1132a | mass % | 3.0 | 3.0 | 3.0 | 3.0 | 3.0 | 3.0 | 3.0 | 3.0 | 3.0 |
| R32 | mass % | 10.0 | 10.0 | 10.0 | 10.0 | 20.0 | 20.0 | 20.0 | 20.0 | 20.0 |
| HFO-1132 (E) | mass % | 40.0 | 60.0 | 70.0 | 80.0 | 30.0 | 40.0 | 50.0 | 60.0 | 70.0 |
| R1234(yf + ze) (r = 0.25) | mass % | 47.0 | 27.0 | 17.0 | 7.0 | 47.0 | 37.0 | 27.0 | 17.0 | 7.0 |
| GWP | — | 71 | 70 | 69 | 69 | 138 | 137 | 137 | 137 | 136 |
| COP ratio | [symbol] relative | 100.6 | 98.7 | 98.1 | 97.6 | 100.9 | 99.7 | 98.7 | 98.0 | 97.5 |
| | to R41 [symbol] | | | | | | | | | |
| Refrigerating | [symbol] relative | 80.0 | 91.6 | 97.2 | 102.6 | 82.4 | 88.5 | 94.4 | 100.1 | 105.6 |
| capacity r [symbol] | to R41 [symbol] | | | | | | | | | |
| Condensation | ° C. | 9.7 | 6.1 | 4.5 | 3.0 | 9.5 | 7.7 | 5.9 | 4.2 | 2.7 |
| glide | | | | | | | | | | |
| | | Com | | | | | Com | | | |
| Item | Unit | Ex. 11 [symbol] | Ex. 122 | Ex. 123 | Ex. 124 | Ex. 125 | Ex. 11 [symbol] | Ex. 126 | Ex. 127 | Ex. 128 |
| HFO-1132a | mass % | 3.0 | 3.0 | 3.0 | 3.0 | 3.0 | 3.0 | 3.0 | 3.0 | 3.0 |
| R32 | mass % | 30.0 | 30.0 | 30.0 | 30.0 | 30.0 | 40.0 | 40.0 | 40.0 | 40.0 |
| HFO-1132 (E) | mass % | 15.0 | 30.0 | 40.0 | 50.0 | 60.0 | 5.0 | 20.0 | 30.0 | 40.0 |
| R1234(yf + ze) (r = 0.25) | mass % | 52.0 | 37.0 | 27.0 | 17.0 | 7.0 | 52.0 | 37.0 | 27.0 | 17.0 |
| GWP | — | 206 | 205 | 204 | 204 | 204 | 273 | 272 | 272 | 271 |
| COP ratio | [symbol] relative | 102.1 | 100.1 | 99.1 | 98.2 | 97.6 | 102.7 | 100.7 | 99.6 | 98.7 |
| | to R41 [symbol] | | | | | | | | | |
| Refrigerating | [symbol] relative | 80.7 | 90.3 | 96.4 | 102.3 | 108.0 | 81.3 | 91.5 | 97.8 | 103.9 |
| capacity r [symbol] | to R41 [symbol] | | | | | | | | | |
| Condensation | ° C. | 9.9 | 7.3 | 5.6 | 3.9 | 2.4 | 9.0 | 6.9 | 5.3 | 3.6 |
| glide | | | | | | | | | | |
| Item | Unit | Ex. 129 | Ex. 130 | Ex. 131 | Ex. 132 | Ex. 133 | Ex. 134 | Ex. 135 | Ex. 136 | Ex. 137 |
| HFO-1132a | mass % | 3.0 | 3.0 | 3.0 | 3.0 | 3.0 | 3.0 | 3.0 | 3.0 | 3.0 |
| R32 | mass % | 40.0 | 50.0 | 50.0 | 50.0 | 50.0 | 60.0 | 60.0 | 60.0 | 70.0 |
| HFO-1132 (E) | mass % | 50.0 | 10.0 | 20.0 | 30.0 | 40.0 | 10.0 | 20.0 | 30.0 | 10.0 |
| R1234(yf + ze) (r = 0.25) | mass % | 7.0 | 37.0 | 27.0 | 17.0 | 7.0 | 27.0 | 17.0 | 7.0 | 17.0 |
| GWP | — | 271 | 340 | 339 | 339 | 338 | 407 | 406 | 406 | 474 |
| COP ratio | [symbol] relative | 98.0 | 101.5 | 100.4 | 99.4 | 98.5 | 101.3 | 100.2 | 99.3 | 101.1 |
| | to R41 [symbol] | | | | | | | | | |
| Refrigerating | [symbol] relative | 109.8 | 91.9 | 98.6 | 104.9 | 110.9 | 98.6 | 105.2 | 111.4 | 104.8 |
| capacity r [symbol] | to R41 [symbol] | | | | | | | | | |
| Condensation | ° C. | 2.1 | 6.4 | 4.9 | 3.5 | 2.0 | 4.6 | 3.3 | 2.0 | 3.1 |
| glide | | | | | | | | | | |

[symbol]

indicates data missing or illegible when filed

TABLE 11

| | | | Com |
|---|---|---|---|
| Item | Unit | Ex. 138 | Ex. 112 |
| HFO-1132a | mass % | 3.0 | 3.0 |
| R32 | mass % | 70.0 | 80.0 |
| HFO-1132 (E) | mass % | 20.0 | 10.0 |
| R1234(yf + ze) (r = 0.25) | mass % | 7.0 | 7.0 |
| GWP | — | 473 | 541 |
| COP ratio | [symbol] relative | 100.1 | 100.9 |
| | to R41 [symbol] | | |
| Refrigerating | [symbol] relative | 111.2 | 110.5 |
| capacity r [symbol] | to R41 [symbol] | | |
| Condensation | ° C. | 1.9 | 1.8 |
| glide | | | |

| | | Com | | | | | Com | | | |
|---|---|---|---|---|---|---|---|---|---|---|
| Item | Unit | Ex. 11 [symbol] | Ex. 139 | Ex. 140 | Ex. 141 | Ex. 142 | Ex. 11 [symbol] | Ex. 143 | Ex. 144 | Ex. 145 |
| HFO-1132a | mass % | 3.0 | 3.0 | 3.0 | 3.0 | 3.0 | 3.0 | 3.0 | 3.0 | 3.0 |
| R32 | mass % | 10.0 | 10.0 | 10.0 | 10.0 | 10.0 | 20.0 | 20.0 | 20.0 | 20.0 |
| HFO-1132 (E) | mass % | 40.0 | 50.0 | 60.0 | 70.0 | 80.0 | 30.0 | 50.0 | 50.0 | 70.0 |
| R1234(yf + ze) (r = 0.5) | mass % | 47.0 | 37.0 | 27.0 | 17.0 | 7.0 | 47.0 | 27.0 | 17.0 | 7.0 |
| GWP | — | 70 | 70 | 69 | 69 | 69 | 138 | 137 | 136 | 136 |
| COP ratio | [symbol] relative | 100.0 | 99.1 | 98.4 | 97.9 | 97.6 | 100.3 | 98.4 | 97.8 | 97.4 |
| | to R41 [symbol] | | | | | | | | | |
| Refrigerating | [symbol] relative | 81.5 | 87.2 | 92.6 | 97.8 | 102.8 | 84.0 | 95.4 | 100.8 | 105.9 |
| capacity r [symbol] | to R41 [symbol] | | | | | | | | | |
| Condensation | ° C. | 8.4 | 6.8 | 5.3 | 4.0 | 2.8 | 8.2 | 5.1 | 3.7 | 2.5 |
| glide | | | | | | | | | | |
| | | Com | | | | | Com | | | |
| Item | Unit | Ex. 11 [symbol] | Ex. 146 | Ex. 147 | Ex. 148 | Ex. 149 | Ex. 11 [symbol] | Ex. 150 | Ex. 151 | Ex. 152 |
| HFO-1132a | mass % | 3.0 | 3.0 | 3.0 | 3.0 | 3.0 | 3.0 | 3.0 | 3.0 | 3.0 |
| R32 | mass % | 30.0 | 30.0 | 30.0 | 30.0 | 30.0 | 40.0 | 40.0 | 40.0 | 40.0 |
| HFO-1132 (E) | mass % | 15.0 | 30.0 | 40.0 | 50.0 | 60.0 | 5.0 | 20.0 | 30.0 | 40.0 |
| R1234(yf + ze) (r = 0.5) | mass % | 52.0 | 37.0 | 27.0 | 17.0 | 7.0 | 52.0 | 37.0 | 27.0 | 17.0 |
| GWP | — | 205 | 205 | 204 | 204 | 203 | 273 | 272 | 272 | 271 |
| COP ratio | [symbol] relative | 101.4 | 99.7 | 98.8 | 98.1 | 97.5 | 102.0 | 100.3 | 99.3 | 98.6 |
| | to R41 [symbol] | | | | | | | | | |
| Refrigerating | [symbol] relative | 82.6 | 91.8 | 97.5 | 103.0 | 108.3 | 83.3 | 93.0 | 99.0 | 104.7 |
| capacity r [symbol] | to R41 [symbol] | | | | | | | | | |
| Condensation | ° C. | 8.4 | 6.2 | 4.8 | 3.4 | 2.2 | 7.6 | 5.8 | 4.5 | 3.2 |
| glide | | | | | | | | | | |
| Item | Unit | Ex. 153 | Ex. 154 | Ex. 155 | Ex. 156 | Ex. 157 | Ex. 158 | Ex. 159 | Ex. 160 | Ex. 161 |
| HFO-1132a | mass % | 3.0 | 3.0 | 3.0 | 3.0 | 3.0 | 3.0 | 3.0 | 3.0 | 3.0 |
| R32 | mass % | 40.0 | 50.0 | 50.0 | 50.0 | 50.0 | 60.0 | 60.0 | 60.0 | 70.0 |
| HFO-1132 (E) | mass % | 50.0 | 10.0 | 20.0 | 30.0 | 40.0 | 10.0 | 20.0 | 30.0 | 10.0 |
| R1234(yf + ze) (r = 0.5) | mass % | 7.0 | 37.0 | 27.0 | 17.0 | 7.0 | 27.0 | 17.0 | 7.0 | 17.0 |
| GWP | — | 271 | 339 | 339 | 339 | 338 | 406 | 406 | 406 | 473 |
| COP ratio | [symbol] relative | 97.9 | 101.1 | 100.1 | 99.2 | 98.5 | 101.0 | 100.1 | 99.2 | 100.9 |
| | to R41 [symbol] | | | | | | | | | |
| Refrigerating | [symbol] relative | 110.1 | 93.5 | 99.7 | 105.6 | 111.2 | 99.8 | 105.9 | 111.7 | 105.6 |
| capacity r [symbol] | to R41 [symbol] | | | | | | | | | |
| Condensation | ° C. | 2.0 | 5.3 | 4.2 | 3.0 | 1.8 | 3.9 | 2.9 | 1.8 | 2.7 |
| glide | | | | | | | | | | |

| | | | Com |
|---|---|---|---|
| Item | Unit | Ex. 162 | Ex. 117 |
| HFO-1132a | mass % | 3.0 | 3.0 |
| R32 | mass % | 70.0 | 80.0 |
| HFO-1132 (E) | mass % | 20.0 | 10.0 |
| R1234(yf + ze) (r = 0.5) | mass % | 7.0 | 7.0 |
| GWP | — | 473 | 540 |
| COP ratio | [symbol] relative | 100.0 | 100.8 |
| | to R41 [symbol] | | |
| Refrigerating | [symbol] relative | 111.5 | 110.8 |
| capacity r [symbol] | to R41 [symbol] | | |
| Condensation | ° C. | 1.8 | 1.7 |
| glide | | | |

[symbol]

indicates data missing or illegible when filed

TABLE 12

| | | Com | | | | Com | | | | |
|---|---|---|---|---|---|---|---|---|---|---|
| Item | Unit | Ex. 11 [symbol] | Ex. 163 | Ex. 164 | Ex. 165 | Ex. 11 [symbol] | Ex. 166 | Ex. 167 | Ex. 168 | Ex. 169 |
| HFO-1132a | mass % | 3.0 | 3.0 | 3.0 | 3.0 | 3.0 | 3.0 | 3.0 | 3.0 | 3.0 |
| R32 | mass % | 10.0 | 10.0 | 10.0 | 10.0 | 20.0 | 20.0 | 20.0 | 20.0 | 20.0 |
| HFO-1132 (E) | mass % | 40.0 | 60.0 | 70.0 | 80.0 | 25.0 | 40.0 | 50.0 | 60.0 | 70.0 |
| R1234(yf + ze) (r = 0.75) | mass % | 47.0 | 27.0 | 17.0 | 7.0 | 52.0 | 37.0 | 27.0 | 17.0 | 7.0 |
| GWP | — | 70 | 59 | 59 | 69 | 138 | 137 | 137 | 136 | 136 |
| COP ratio | [symbol] relative | 99.5 | 98.2 | 97.8 | 97.5 | 100.2 | 98.8 | 98.2 | 97.7 | 97.3 |
| | to R41 [symbol] | | | | | | | | | |
| Refrigerating | [symbol] relative | 83.0 | 93.6 | 98.5 | 103.1 | 82.7 | 91.2 | 96.5 | 101.5 | 106.2 |
| capacity r [symbol] | to R41 [symbol] | | | | | | | | | |
| Condensation | ° C. | 7.2 | 4.6 | 3.6 | 2.6 | 7.5 | 5.6 | 4.4 | 3.3 | 2.3 |
| glide | | | | | | | | | | |
| | | Com | | | | | | | | |
| Item | Unit | Ex. 12 [symbol] | Ex. 170 | Ex. 171 | Ex. 172 | Ex. 173 | Ex. 174 | Ex. 175 | Ex. 176 | Ex. 177 |
| HFO-1132a | mass % | 3.0 | 3.0 | 3.0 | 3.0 | 3.0 | 3.0 | 3.0 | 3.0 | 3.0 |
| R32 | mass % | 30.0 | 30.0 | 30.0 | 30.0 | 30.0 | 30.0 | 40.0 | 40.0 | 40.0 |
| HFO-1132 (E) | mass % | 10.0 | 20.0 | 30.0 | 40.0 | 50.0 | 60.0 | 10.0 | 20.0 | 30.0 |
| R1234(yf + ze) (r = 0.75) | mass % | 57.0 | 47.0 | 37.0 | 27.0 | 17.0 | 7.0 | 47.0 | 37.0 | 27.0 |
| GWP | — | 205 | 205 | 204 | 204 | 204 | 203 | 272 | 272 | 272 |
| COP ratio | [symbol] relative | 101.3 | 100.1 | 99.2 | 98.5 | 97.9 | 97.5 | 100.9 | 99.9 | 99.1 |
| | to R41 [symbol] | | | | | | | | | |
| Refrigerating | [symbol] relative | 81.2 | 87.4 | 93.2 | 98.7 | 103.8 | 108.6 | 88.4 | 94.5 | 100.1 |
| capacity r [symbol] | to R41 [symbol] | | | | | | | | | |
| Condensation | ° C. | 7.5 | 6.4 | 5.2 | 4.0 | 3.0 | 2.0 | 5.8 | 4.8 | 3.7 |
| glide | | | | | | | | | | |
| Item | Unit | Ex. 178 | Ex. 179 | Ex. 180 | Ex. 181 | Ex. 182 | Ex. 183 | Ex. 184 | Ex. 185 | Ex. 186 |
| HFO-1132a | mass % | 3.0 | 3.0 | 3.0 | 3.0 | 3.0 | 3.0 | 3.0 | 3.0 | 3.0 |
| R32 | mass % | 40.0 | 40.0 | 50.0 | 50.0 | 50.0 | 50.0 | 60.0 | 60.0 | 60.0 |
| HFO-1132 (E) | mass % | 40.0 | 50.0 | 10.0 | 20.0 | 30.0 | 40.0 | 10.0 | 20.0 | 30.0 |
| R1234(yf + ze) (r = 0.75) | mass % | 17.0 | 7.0 | 37.0 | 27.0 | 17.0 | 7.0 | 27.0 | 17.0 | 7.0 |
| GWP | — | 271 | 271 | 339 | 339 | 339 | 338 | 406 | 406 | 406 |
| COP ratio | [symbol] relative | 98.4 | 97.8 | 100.7 | 99.8 | 99.1 | 98.4 | 100.7 | 99.9 | 99.1 |
| | to R41 [symbol] | | | | | | | | | |
| Refrigerating | [symbol] relative | 105.4 | 110.4 | 95.0 | 100.9 | 106.4 | 111.5 | 101.0 | 106.7 | 112.0 |
| capacity r [symbol] | to R41 [symbol] | | | | | | | | | |
| Condensation | ° C. | 2.7 | 1.8 | 4.3 | 3.5 | 2.6 | 1.7 | 3.2 | 2.4 | 1.6 |
| glide | | | | | | | | | | |

| | | | | Com |
|---|---|---|---|---|
| Item | Unit | Ex. 187 | Ex. 188 | Ex. 12 [symbol] |
| HFO-1132a | mass % | 3.0 | 3.0 | 3.0 |
| R32 | mass % | 70.0 | 70.0 | 80.0 |
| HFO-1132 (E) | mass % | 10.0 | 20.0 | 10.0 |
| R1234(yf + ze) (r = 0.75) | mass % | 17.0 | 7.0 | 7.0 |
| GWP | — | 473 | 473 | 540 |
| COP ratio | [symbol] relative | 100.8 | 99.9 | 100.8 |
| | to R41 [symbol] | | | |
| Refrigerating | [symbol] relative | 106.3 | 111.8 | 111.0 |
| capacity r [symbol] | to R41 [symbol] | | | |
| Condensation | ° C. | 2.3 | 1.6 | 1.6 |
| glide | | | | |

[symbol]

indicates data missing or illegible when filed

TABLE 13

| | | Com | | | | | Com | | | |
|---|---|---|---|---|---|---|---|---|---|---|
| Item | Unit | Ex. 12 [symbol] | Ex. 189 | Ex. 190 | Ex. 191 | Ex. 192 | Ex. 12 [symbol] | Ex. 193 | Ex. 194 | Ex. 195 |
| HFO-1132a | mass % | 4.6 | 4.6 | 4.6 | 4.6 | 4.6 | 4.6 | 4.6 | 4.6 | 4.6 |
| R32 | mass % | 10.0 | 10.0 | 10.0 | 10.0 | 10.0 | 20.0 | 20.0 | 20.0 | 20.0 |
| HFO-1132 (E) | mass % | 40.0 | 50.0 | 60.0 | 70.0 | 80.0 | 25.0 | 40.0 | 50.0 | 60.0 |
| R1234(yf + ze) (r = 0) | mass % | 45.4 | 35.4 | 25.4 | 15.4 | 5.4 | 50.4 | 35.4 | 25.4 | 15.4 |
| GWP | — | 71 | 70 | 70 | 69 | 69 | 138 | 138 | 137 | 137 |
| COP ratio | [symbol] relative | 100.2 | 99.0 | 98.0 | 97.3 | 96.8 | 101.4 | 99.3 | 98.2 | 97.3 |
| | to R41 [symbol] | | | | | | | | | |
| Refrigerating | [symbol] relative | 81.3 | 87.4 | 93.5 | 99.4 | 105.1 | 80.2 | 89.8 | 96.0 | 102.1 |
| capacity r [symbol] | to R41 [symbol] | | | | | | | | | |
| Condensation | ° C. | 12.1 | 9.8 | 7.6 | 5.5 | 3.7 | 12.9 | 9.5 | 7.2 | 5.1 |
| glide | | | | | | | | | | |
| | | | Com | | | | | Com | | |
| Item | Unit | Ex. 195 | Ex. 12 [symbol] | Ex. 197 | Ex. 198 | Ex. 199 | Ex. 200 | Ex. 12 [symbol] | Ex. 201 | Ex. 202 |
| HFO-1132a | mass % | 4.6 | 4.6 | 4.6 | 4.6 | 4.6 | 4.6 | 4.6 | 4.6 | 4.6 |
| R32 | mass % | 20.0 | 30.0 | 30.0 | 30.0 | 30.0 | 30.0 | 40.0 | 40.0 | 40.0 |
| HFO-1132 (E) | mass % | 70.0 | 15.0 | 30.0 | 40.0 | 50.0 | 60.0 | 5.0 | 20.0 | 30.0 |
| R1234(yf + ze) (r = 0) | mass % | 5.4 | 50.4 | 35.4 | 25.4 | 15.4 | 5.4 | 50.4 | 35.4 | 25.4 |
| GWP | — | 136 | 206 | 205 | 204 | 204 | 203 | 273 | 272 | 272 |
| COP ratio | [symbol] relative | 96.7 | 102.0 | 99.8 | 98.6 | 97.6 | 96.9 | 102.7 | 100.5 | 99.2 |
| | to R41 [symbol] | | | | | | | | | |
| Refrigerating | [symbol] relative | 108.0 | 81.5 | 91.5 | 98.0 | 104.2 | 110.3 | 81.9 | 92.5 | 99.2 |
| capacity r [symbol] | to R41 [symbol] | | | | | | | | | |
| Condensation | ° C. | 3.3 | 12.3 | 9.0 | 6.8 | 4.7 | 2.9 | 11.3 | 8.5 | 6.5 |
| glide | | | | | | | | | | |
| Item | Unit | Ex. 203 | Ex. 204 | Ex. 205 | Ex. 206 | Ex. 207 | Ex. 208 | Ex. 209 | Ex. 210 | Ex. 211 |
| HFO-1132a | mass % | 4.6 | 4.6 | 4.6 | 4.6 | 4.6 | 4.6 | 4.6 | 4.6 | 4.6 |
| R32 | mass % | 40.0 | 40.0 | 50.0 | 50.0 | 50.0 | 50.0 | 60.0 | 60.0 | 60.0 |
| HFO-1132 (E) | mass % | 40.0 | 50.0 | 10.0 | 20.0 | 30.0 | 40.0 | 10.0 | 20.0 | 30.0 |
| R1234(yf + ze) (r = 0) | mass % | 15.4 | 5.4 | 35.4 | 25.4 | 15.4 | 5.4 | 25.4 | 15.4 | 5.4 |
| GWP | — | 271 | 271 | 340 | 339 | 339 | 338 | 407 | 406 | 406 |
| COP ratio | [symbol] relative | 98.2 | 97.3 | 101.3 | 100.0 | 98.9 | 97.9 | 100.9 | 99.8 | 98.7 |
| | to R41 [symbol] | | | | | | | | | |
| Refrigerating | [symbol] relative | 105.8 | 112.0 | 92.9 | 99.9 | 106.6 | 113.1 | 99.9 | 106.9 | 113.5 |
| capacity r [symbol] | to R41 [symbol] | | | | | | | | | |
| Condensation | ° C. | 4.4 | 2.6 | 7.9 | 6.1 | 4.2 | 2.4 | 5.7 | 4.0 | 2.4 |
| glide | | | | | | | | | | |

| | | | | Com |
|---|---|---|---|---|
| Item | Unit | Ex. 212 | Ex. 213 | Ex. 126 |
| HFO-1132a | mass % | 4.6 | 4.6 | 4.6 |
| R32 | mass % | 70.0 | 70.0 | 80.0 |
| HFO-1132 (E) | mass % | 10.0 | 20.0 | 10.0 |
| R1234(yf + ze) (r = 0) | mass % | 15.4 | 5.4 | 5.4 |
| GWP | — | 474 | 473 | 540 |
| COP ratio | [symbol] relative | 100.7 | 99.5 | 100.4 |
| | to R41 [symbol] | | | |
| Refrigerating | [symbol] relative | 106.5 | 113.3 | 112.6 |
| capacity r [symbol] | to R41 [symbol] | | | |
| Condensation | ° C. | 3.8 | 2.4 | 2.3 |
| glide | | | | |

| | | Com | | | | | Com | | | |
|---|---|---|---|---|---|---|---|---|---|---|
| Item | Unit | Ex. 12 [symbol] | Ex. 214 | Ex. 215 | Ex. 216 | Ex. 217 | Ex. 12 [symbol] | Ex. 218 | Ex. 219 | Ex. 220 |
| HFO-1132a | mass % | 4.6 | 4.6 | 4.6 | 4.6 | 4.6 | 4.6 | 4.6 | 4.6 | 4.6 |
| R32 | mass % | 10.0 | 10.0 | 10.0 | 10.0 | 10.0 | 20.0 | 20.0 | 20.0 | 20.0 |
| HFO-1132 (E) | mass % | 40.0 | 50.0 | 60.0 | 70.0 | 80.0 | 25.0 | 40.0 | 50.0 | 60.0 |
| R1234(yf + ze) (r = 0.25) | mass % | 45.4 | 35.4 | 25.4 | 15.4 | 5.4 | 50.4 | 35.4 | 25.4 | 15.4 |
| GWP | — | 70 | 70 | 70 | 69 | 69 | 138 | 137 | 137 | 136 |
| COP ratio | [symbol] relative | 99.7 | 98.6 | 97.8 | 97.2 | 96.7 | 100.8 | 98.9 | 97.9 | 97.2 |
| | to R41 [symbol] | | | | | | | | | |
| Refrigerating | [symbol] relative | 82.7 | 88.7 | 94.4 | 100.0 | 105.3 | 81.9 | 91.1 | 97.0 | 102.7 |
| capacity r [symbol] | to R41 [symbol] | | | | | | | | | |
| Condensation | ° C. | 10.6 | 8.6 | 6.8 | 5.1 | 3.6 | 11.2 | 8.3 | 6.4 | 4.7 |
| glide | | | | | | | | | | |

[symbol]

indicates data missing or illegible when filed

TABLE 14

| | | | Com | | | | | Com | | |
|---|---|---|---|---|---|---|---|---|---|---|
| Item | Unit | Ex. | Ex. 12 [symbol] | Ex. 222 | Ex. 223 | Ex. 224 | Ex. 225 | Ex. 13 [symbol] | Ex. 226 | Ex. 227 |
| HFO-1132a | mass % | 4.6 | 4.6 | 4.6 | 4.6 | 4.6 | 4.6 | 4.6 | 4.6 | 4.6 |
| R32 | mass % | 20.0 | 30.0 | 30.0 | 30.0 | 30.0 | 30.0 | 40.0 | 40.0 | 40.0 |
| HFO-1132 (E) | mass % | 70.0 | 15.0 | 30.0 | 40.0 | 50.0 | 60.0 | 5.0 | 20.0 | 30.0 |
| R1234(yf + ze) (r = 0.25) | mass % | 5.4 | 50.4 | 35.4 | 25.4 | 15.4 | 5.4 | 50.4 | 35.4 | 25.4 |
| GWP | — | 136 | 205 | 205 | 204 | 204 | 203 | 273 | 272 | 272 |
| COP ratio | [symbol] relative | 96.6 | 101.4 | 99.4 | 98.3 | 97.5 | 96.8 | 102.0 | 100.1 | 98.9 |
| | to R41 [symbol] | | | | | | | | | |
| Refrigerating | [symbol] relative | 108.2 | 83.2 | 92.9 | 99.0 | 104.9 | 110.6 | 83.8 | 94.0 | 100.3 |
| capacity r [symbol] | to R41 [symbol] | | | | | | | | | |
| Condensation | ° C. | 3.1 | 10.6 | 7.9 | 6.0 | 4.3 | 2.7 | 9.7 | 7.4 | 5.7 |
| glide | | | | | | | | | | |

| Item | Unit | Ex. 228 | Ex. 229 | Ex. 230 | Ex. 231 | Ex. 232 | Ex. 233 | Ex. 234 | Ex. 235 | Ex. 236 |
|---|---|---|---|---|---|---|---|---|---|---|
| HFO-1132a | mass % | 4.6 | 4.6 | 4.6 | 4.6 | 4.6 | 4.6 | 4.6 | 4.6 | 4.6 |
| R32 | mass % | 40.0 | 40.0 | 50.0 | 50.0 | 50.0 | 50.0 | 60.0 | 60.0 | 60.0 |
| HFO-1132 (E) | mass % | 40.0 | 50.0 | 10.0 | 20.0 | 30.0 | 40.0 | 10.0 | 20.0 | 30.0 |
| R1234(yf + ze) (r = 0.25) | mass % | 15.4 | 5.4 | 35.4 | 25.4 | 15.4 | 5.4 | 25.4 | 15.4 | 5.4 |
| GWP | — | 271 | 271 | 340 | 339 | 339 | 338 | 407 | 406 | 406 |
| COP ratio | [symbol] relative | 98.0 | 97.3 | 100.9 | 99.8 | 98.8 | 97.9 | 100.7 | 99.6 | 98.6 |
| | to R41 [symbol] | | | | | | | | | |
| Refrigerating | [symbol] relative | 106.4 | 112.3 | 94.4 | 101.0 | 107.3 | 113.3 | 101.0 | 107.6 | 113.8 |
| capacity r [symbol] | to R41 [symbol] | | | | | | | | | |
| Condensation | ° C. | 4.0 | 2.4 | 6.8 | 5.3 | 3.8 | 2.3 | 5.0 | 3.6 | 2.2 |
| glide | | | | | | | | | | |

| | | | | Com |
|---|---|---|---|---|
| Item | Unit | Ex. 237 | Ex. 238 | Ex. 131 |
| HFO-1132a | mass % | 4.6 | 4.6 | 4.6 |
| R32 | mass % | 70.0 | 70.0 | 80.0 |
| HFO-1132 (E) | mass % | 10.0 | 20.0 | 10.0 |
| R1234(yf + ze) (r = 0.25) | mass % | 15.4 | 5.4 | 5.4 |
| GWP | — | 473 | 473 | 540 |
| COP ratio | [symbol] relative | 100.6 | 99.5 | 100.4 |
| | to R41 [symbol] | | | |
| Refrigerating | [symbol] relative | 107.2 | 113.6 | 112.8 |
| capacity r [symbol] | to R41 [symbol] | | | |
| Condensation | ° C. | 3.4 | 2.2 | 2.2 |
| glide | | | | |

| | | Com | | | | | Com | | | |
|---|---|---|---|---|---|---|---|---|---|---|
| Item | Unit | Ex. 13 [symbol] | Ex. 239 | Ex. 240 | Ex. 241 | Ex. 242 | Ex. 13 [symbol] | Ex. 243 | Ex. 244 | Ex. 245 |
| HFO-1132a | mass % | 4.6 | 4.6 | 4.6 | 4.6 | 4.6 | 4.6 | 4.6 | 4.6 | 4.6 |
| R32 | mass % | 10.0 | 10.0 | 10.0 | 10.0 | 10.0 | 20.0 | 20.0 | 20.0 | 20.0 |
| HFO-1132 (E) | mass % | 40.0 | 50.0 | 60.0 | 70.0 | 80.0 | 25.0 | 40.0 | 50.0 | 60.0 |
| R1234(yf + ze) (r = 0.5) | mass % | 45.4 | 35.4 | 25.4 | 15.4 | 5.4 | 50.4 | 35.4 | 25.4 | 15.4 |
| GWP | — | 70 | 70 | 69 | 69 | 69 | 138 | 137 | 137 | 136 |
| COP ratio | [symbol] relative | 99.2 | 98.3 | 97.6 | 97.0 | 96.7 | 100.1 | 98.5 | 97.6 | 97.0 |
| | to R41 [symbol] | | | | | | | | | |
| Refrigerating | [symbol] relative | 84.2 | 89.9 | 95.3 | 100.5 | 105.5 | 83.5 | 92.4 | 98.0 | 103.4 |
| capacity r [symbol] | to R41 [symbol] | | | | | | | | | |
| Condensation | ° C. | 9.2 | 7.6 | 6.0 | 4.7 | 3.4 | 9.7 | 7.2 | 5.6 | 4.2 |
| glide | | | | | | | | | | |
| | | | Com | | | | | | | |
| Item | Unit | Ex. 246 | Ex. 13 [symbol] | Ex. 247 | Ex. 248 | Ex. 249 | Ex. 250 | Ex. 251 | Ex. 252 | Ex. 253 |
| HFO-1132a | mass % | 4.6 | 4.6 | 4.6 | 4.6 | 4.6 | 4.6 | 4.6 | 4.6 | 4.6 |
| R32 | mass % | 20.0 | 30.0 | 30.0 | 30.0 | 30.0 | 30.0 | 30.0 | 40.0 | 40.0 |
| HFO-1132 (E) | mass % | 70.0 | 10.0 | 20.0 | 30.0 | 40.0 | 50.0 | 60.0 | 10.0 | 20.0 |
| R1234(yf + ze) (r = 0.5) | mass % | 5.4 | 64.4 | 45.4 | 35.4 | 25.4 | 15.4 | 5.4 | 45.4 | 35.4 |
| GWP | — | 136 | 206 | 205 | 205 | 204 | 204 | 203 | 272 | 272 |
| COP ratio | [symbol] relative | 96.6 | 101.8 | 100.1 | 98.9 | 98.0 | 97.3 | 96.8 | 100.8 | 99.7 |
| | to R41 [symbol] | | | | | | | | | |
| Refrigerating | [symbol] relative | 108.5 | 78.7 | 88.2 | 94.3 | 100.0 | 105.5 | 110.8 | 89.0 | 95.4 |
| capacity r [symbol] | to R41 [symbol] | | | | | | | | | |
| Condensation | ° C. | 3.0 | 10.1 | 8.3 | 6.7 | 5.2 | 3.8 | 2.6 | 7.6 | 6.3 |
| glide | | | | | | | | | | |

[symbol]

indicates data missing or illegible when filed

TABLE 15

| Item | Unit | Ex. 254 | Ex. 255 | Ex. 256 | Ex. 257 | Ex. 258 | Ex. 259 | Ex. 260 | Ex. 261 | Ex. 262 |
|---|---|---|---|---|---|---|---|---|---|---|
| HFO-1132a | mass % | 4.6 | 4.6 | 4.6 | 4.6 | 4.6 | 4.6 | 4.6 | 4.6 | 4.6 |
| R32 | mass % | 40.0 | 40.0 | 40.0 | 50.0 | 50.0 | 50.0 | 50.0 | 60.0 | 60.0 |
| HFO-1132 (E) | mass % | 30.0 | 40.0 | 50.0 | 10.0 | 20.0 | 30.0 | 40.0 | 10.0 | 20.0 |
| R1234(yf + ze) (r = 0.5) | mass % | 25.4 | 15.4 | 5.4 | 35.4 | 25.4 | 15.4 | 5.4 | 25.4 | 15.4 |
| GWP | — | 272 | 271 | 271 | 339 | 339 | 339 | 338 | 406 | 406 |
| COP ratio | [symbol] relative | 98.7 | 97.9 | 97.2 | 100.5 | 99.5 | 98.6 | 97.8 | 100.5 | 99.5 |
| | to R41 [symbol] | | | | | | | | | |
| Refrigerating | [symbol] relative | 101.4 | 107.1 | 112.5 | 95.8 | 102.1 | 108.0 | 113.6 | 102.1 | 108.3 |
| capacity r [symbol] | to R41 [symbol] | | | | | | | | | |
| Condensation | ° C. | 4.9 | 3.5 | 2.3 | 5.8 | 4.6 | 3.4 | 2.2 | 4.3 | 3.2 |
| glide | | | | | | | | | | |

| | | | | | Com |
|---|---|---|---|---|---|
| Item | Unit | Ex. 263 | Ex. 264 | Ex. 265 | Ex. 135 |
| HFO-1132a | mass % | 4.6 | 4.6 | 4.6 | 4.6 |
| R32 | mass % | 60.0 | 70.0 | 70.0 | 80.0 |
| HFO-1132 (E) | mass % | 30.0 | 10.0 | 20.0 | 10.0 |
| R1234(yf + ze) (r = 0.5) | mass % | 5.4 | 15.4 | 5.4 | 5.4 |
| GWP | — | 406 | 473 | 473 | 540 |
| COP ratio | [symbol] relative | 98.6 | 100.4 | 99.4 | 100.3 |
| | to R41 [symbol] | | | | |
| Refrigerating | [symbol] relative | 114.0 | 107.9 | 113.8 | 113.0 |
| capacity r [symbol] | to R41 [symbol] | | | | |
| Condensation | ° C. | 2.1 | 3.0 | 2.1 | 2.1 |
| glide | | | | | |

| | | Com | | | | | Com | | | |
|---|---|---|---|---|---|---|---|---|---|---|
| Item | Unit | Ex. 13 [symbol] | Ex. 266 | Ex. 267 | Ex. 268 | Ex. 269 | Ex. 13 [symbol] | Ex. 270 | Ex. 271 | Ex. 272 |
| HFO-1132a | mass % | 4.6 | 4.6 | 4.6 | 4.6 | 4.6 | 4.6 | 4.6 | 4.6 | 4.6 |
| R32 | mass % | 10.0 | 10.0 | 10.0 | 10.0 | 10.0 | 20.0 | 20.0 | 20.0 | 20.0 |
| HFO-1132 (E) | mass % | 35.0 | 50.0 | 60.0 | 70.0 | 80.0 | 20.0 | 30.0 | 40.0 | 50.0 |
| R1234(yf + ze) (r = 0.75) | mass % | 50.4 | 35.4 | 25.4 | 15.4 | 5.4 | 55.4 | 45.4 | 35.4 | 25.4 |
| GWP | — | 70 | 70 | 69 | 69 | 69 | 138 | 137 | 137 | 137 |
| COP ratio | [symbol] relative | 99.2 | 97.9 | 97.3 | 96.9 | 96.6 | 100.1 | 99.0 | 98.1 | 97.4 |
| | to R41 [symbol] | | | | | | | | | |
| Refrigerating | [symbol] relative | 82.7 | 91.0 | 96.2 | 101.1 | 106.7 | 82.1 | 88.1 | 93.7 | 99.0 |
| capacity r [symbol] | to R41 [symbol] | | | | | | | | | |
| Condensation | ° C. | 8.7 | 6.6 | 5.3 | 4.2 | 3.3 | 8.9 | 7.5 | 6.1 | 4.9 |
| glide | | | | | | | | | | |
| | | | | Com | | | | | | |
| Item | Unit | Ex. 273 | Ex. 274 | Ex. 13 [symbol] | Ex. 275 | Ex. 276 | Ex. 277 | Ex. 278 | Ex. 279 | Ex. 280 |
| HFO-1132a | mass % | 4.6 | 4.6 | 4.6 | 4.6 | 4.6 | 4.6 | 4.6 | 4.6 | 4.6 |
| R32 | mass % | 20.0 | 20.0 | 30.0 | 30.0 | 30.0 | 30.0 | 30.0 | 30.0 | 40.0 |
| HFO-1132 (E) | mass % | 60.0 | 70.0 | 10.0 | 20.0 | 30.0 | 40.0 | 50.0 | 60.0 | 10.0 |
| R1234(yf + ze) (r = 0.75) | mass % | 15.4 | 5.4 | 55.4 | 45.4 | 35.4 | 25.4 | 15.4 | 5.4 | 45.4 |
| GWP | — | 136 | 136 | 205 | 205 | 204 | 204 | 204 | 203 | 272 |
| COP ratio | [symbol] relative | 96.9 | 96.5 | 100.7 | 99.5 | 98.5 | 97.8 | 97.2 | 96.7 | 100.3 |
| | to R41 [symbol] | | | | | | | | | |
| Refrigerating | [symbol] relative | 104.0 | 108.7 | 83.5 | 89.8 | 95.6 | 101.1 | 106.2 | 111.0 | 90.7 |
| capacity r [symbol] | to R41 [symbol] | | | | | | | | | |
| Condensation | ° C. | 3.8 | 2.8 | 8.1 | 6.9 | 5.7 | 4.5 | 3.4 | 2.4 | 6.3 |
| glide | | | | | | | | | | |
| Item | Unit | Ex. 281 | Ex. 282 | Ex. 283 | Ex. 284 | Ex. 285 | Ex. 286 | Ex. 287 | Ex. 288 | Ex. 289 |
| HFO-1132a | mass % | 4.6 | 4.6 | 4.6 | 4.6 | 4.6 | 4.6 | 4.6 | 4.6 | 4.6 |
| R32 | mass % | 40.0 | 40.0 | 40.0 | 40.0 | 50.0 | 50.0 | 50.0 | 50.0 | 60.0 |
| HFO-1132 (E) | mass % | 20.0 | 30.0 | 40.0 | 50.0 | 10.0 | 20.0 | 30.0 | 40.0 | 10.0 |
| R1234(yf + ze) (r = 0.75) | mass % | 35.4 | 25.4 | 15.4 | 5.4 | 35.4 | 25.4 | 15.4 | 5.4 | 25.4 |
| GWP | — | 272 | 271 | 271 | 271 | 339 | 339 | 339 | 338 | 406 |
| COP ratio | [symbol] relative | 99.3 | 98.4 | 97.7 | 97.2 | 100.2 | 99.3 | 98.5 | 97.8 | 100.2 |
| | to R41 [symbol] | | | | | | | | | |
| Refrigerating | [symbol] relative | 96.8 | 102.5 | 107.8 | 112.7 | 97.3 | 103.2 | 108.7 | 113.8 | 103.2 |
| capacity r [symbol] | to R41 [symbol] | | | | | | | | | |
| Condensation | ° C. | 5.2 | 4.2 | 3.1 | 2.2 | 4.8 | 3.9 | 2.9 | 2.0 | 3.6 |
| glide | | | | | | | | | | |

| | | | | | | Com |
|---|---|---|---|---|---|---|
| Item | Unit | Ex. 290 | Ex. 291 | Ex. 292 | Ex. 293 | Ex. 139 |
| HFO-1132a | mass % | 4.6 | 4.6 | 4.6 | 4.6 | 4.6 |
| R32 | mass % | 60.0 | 50.0 | 70.0 | 70.0 | 80.0 |
| HFO-1132 (E) | mass % | 20.0 | 30.0 | 10.0 | 20.0 | 10.0 |
| R1234(yf + ze) (r = 0.75) | mass % | 15.4 | 5.4 | 15.4 | 5.4 | 5.4 |
| GWP | — | 406 | 406 | 473 | 473 | 540 |
| COP ratio | [symbol] relative | 99.3 | 98.5 | 100.3 | 99.4 | 100.3 |
| | to R41 [symbol] | | | | | |
| Refrigerating | [symbol] relative | 108.9 | 114.2 | 108.5 | 114.0 | 113.2 |
| capacity r [symbol] | to R41 [symbol] | | | | | |
| Condensation | ° C. | 2.8 | 2.0 | 2.7 | 2.0 | 1.9 |
| glide | | | | | | |

[symbol]

indicates data missing or illegible when filed

TABLE 16

| | | Com | | | | | Com | | | |
|---|---|---|---|---|---|---|---|---|---|---|
| Item | Unit | Ex. 14 [symbol] | Ex. 294 | Ex. 295 | Ex. 296 | Ex. 297 | Ex. 14 [symbol] | Ex. 298 | Ex. 299 | Ex. 300 |
| HFO-1132a | mass % | 7.0 | 7.0 | 7.0 | 7.0 | 7.0 | 7.0 | 7.0 | 7.0 | 7.0 |
| R32 | mass % | 10.0 | 10.0 | 10.0 | 10.0 | 10.0 | 20.0 | 20.0 | 20.0 | 20.0 |
| HFO-1132 (E) | mass % | 30.0 | 50.0 | 60.0 | 70.0 | 80.0 | 20.0 | 30.0 | 40.0 | 50.0 |
| R1234(yf + ze) (r = 0) | mass % | 53.0 | 33.0 | 23.0 | 13.0 | 3.0 | 53.0 | 43.0 | 33.0 | 23.0 |
| GWP | — | 71 | 70 | 70 | 69 | 69 | 138 | 138 | 137 | 137 |
| COP ratio | [symbol] relative | 100.4 | 97.6 | 96.7 | 96.0 | 95.4 | 101.1 | 99.4 | 98.0 | 96.9 |
| | to R41 [symbol] | | | | | | | | | |
| Refrigerating | [symbol] relative | 79.2 | 91.6 | 97.6 | 103.5 | 109.2 | 80.9 | 87.5 | 93.8 | 100.0 |
| capacity r [symbol] | to R41 [symbol] | | | | | | | | | |
| Condensation | ° C. | 15.9 | 10.7 | 8.3 | 6.2 | 4.3 | 15.2 | 12.7 | 10.1 | 7.7 |
| glide | | | | | | | | | | |
| | | | | Com | | | | | | |
| Item | Unit | Ex. 301 | Ex. 302 | Ex. 14 [symbol] | Ex. 303 | Ex. 304 | Ex. 305 | Ex. 306 | Ex. 307 | Ex. 308 |
| HFO-1132a | mass % | 7.0 | 7.0 | 7.0 | 7.0 | 7.0 | 7.0 | 7.0 | 7.0 | 7.0 |
| R32 | mass % | 20.0 | 20.0 | 30.0 | 30.0 | 30.0 | 30.0 | 30.0 | 30.0 | 40.0 |
| HFO-1132 (E) | mass % | 60.0 | 70.0 | 10.0 | 20.0 | 30.0 | 40.0 | 50.0 | 60.0 | 10.0 |
| R1234(yf + ze) (r = 0) | mass % | 13.0 | 3.0 | 53.0 | 43.0 | 33.0 | 23.0 | 13.0 | 3.0 | 43.0 |
| GWP | — | 136 | 136 | 206 | 205 | 205 | 204 | 204 | 203 | 273 |
| COP ratio | [symbol] relative | 96.1 | 95.4 | 101.7 | 100.1 | 98.6 | 97.4 | 96.4 | 95.7 | 100.9 |
| | to R41 [symbol] | | | | | | | | | |
| Refrigerating | [symbol] relative | 106.1 | 112.0 | 81.9 | 88.8 | 95.4 | 101.9 | 108.1 | 114.2 | 89.3 |
| capacity r [symbol] | to R41 [symbol] | | | | | | | | | |
| Condensation | ° C. | 5.6 | 3.7 | 14.2 | 12.0 | 9.6 | 7.2 | 5.1 | 3.2 | 11.2 |
| glide | | | | | | | | | | |
| Item | Unit | Ex. 309 | Ex. 310 | Ex. 311 | Ex. 312 | Ex. 313 | Ex. 314 | Ex. 315 | Ex. 316 | Ex. 317 |
| HFO-1132a | mass % | 7.0 | 7.0 | 7.0 | 7.0 | 7.0 | 7.0 | 7.0 | 7.0 | 7.0 |
| R32 | mass % | 40.0 | 40.0 | 40.0 | 40.0 | 50.0 | 50.0 | 50.0 | 50.0 | 60.0 |
| HFO-1132 (E) | mass % | 20.0 | 30.0 | 40.0 | 50.0 | 10.0 | 20.0 | 30.0 | 40.0 | 10.0 |
| R1234(yf + ze) (r = 0) | mass % | 33.0 | 23.0 | 13.0 | 3.0 | 33.0 | 23.0 | 13.0 | 3.0 | 23.0 |
| GWP | — | 272 | 272 | 271 | 271 | 340 | 339 | 339 | 338 | 407 |
| COP ratio | [symbol] relative | 99.4 | 98.1 | 97.1 | 96.2 | 100.3 | 99.1 | 97.9 | 96.9 | 100.1 |
| | to R41 [symbol] | | | | | | | | | |
| Refrigerating | [symbol] relative | 96.3 | 103.1 | 109.6 | 115.8 | 96.6 | 103.6 | 110.4 | 116.8 | 103.6 |
| capacity r [symbol] | to R41 [symbol] | | | | | | | | | |
| Condensation | ° C. | 9.0 | 6.8 | 4.7 | 2.8 | 8.5 | 6.5 | 4.5 | 2.7 | 6.1 |
| glide | | | | | | | | | | |

| | | | | | | Com |
|---|---|---|---|---|---|---|
| Item | Unit | Ex. 318 | Ex. 319 | Ex. 320 | Ex. 321 | Ex. 143 |
| HFO-1132a | mass % | 7.0 | 7.0 | 7.0 | 7.0 | 7.0 |
| R32 | mass % | 60.0 | 60.0 | 70.0 | 70.0 | 80.0 |
| HFO-1132 (E) | mass % | 20.0 | 30.0 | 10.0 | 20.0 | 10.0 |
| R1234(yf + ze) (r = 0) | mass % | 13.0 | 3.0 | 13.0 | 3.0 | 3.0 |
| GWP | — | 406 | 406 | 473 | 473 | 540 |
| COP ratio | [symbol] relative | 98.9 | 97.8 | 99.9 | 98.7 | 99.6 |
| | to R41 [symbol] | | | | | |
| Refrigerating | [symbol] relative | 110.6 | 117.2 | 110.1 | 116.9 | 116.0 |
| capacity r [symbol] | to R41 [symbol] | | | | | |
| Condensation | ° C. | 4.3 | 2.6 | 4.2 | 2.6 | 2.6 |
| glide | | | | | | |

| | | Com | | | | | Com | | | |
|---|---|---|---|---|---|---|---|---|---|---|
| Item | Unit | Ex. 14 [symbol] | Ex. 322 | Ex. 323 | Ex. 324 | Ex. 325 | Ex. 14 [symbol] | Ex. 326 | Ex. 327 | Ex. 328 |
| HFO-1132a | mass % | 7.0 | 7.0 | 7.0 | 7.0 | 7.0 | 7.0 | 7.0 | 7.0 | 7.0 |
| R32 | mass % | 10.0 | 10.0 | 10.0 | 10.0 | 10.0 | 20.0 | 20.0 | 20.0 | 20.0 |
| HFO-1132 (E) | mass % | 30.0 | 50.0 | 60.0 | 70.0 | 80.0 | 20.0 | 30.0 | 40.0 | 50.0 |
| R1234(yf + ze) (r = 0.25) | mass % | 53.0 | 33.0 | 23.0 | 13.0 | 3.0 | 53.0 | 43.0 | 33.0 | 23.0 |
| GWP | — | 71 | 70 | 69 | 69 | 69 | 138 | 138 | 137 | 137 |
| COP ratio | [symbol] relative | 99.8 | 97.3 | 96.5 | 95.9 | 95.4 | 100.4 | 98.9 | 97.7 | 96.7 |
| | to R41 [symbol] | | | | | | | | | |
| Refrigerating | [symbol] relative | 80.6 | 92.7 | 98.4 | 104.0 | 109.3 | 82.5 | 88.9 | 95.0 | 100.9 |
| capacity r [symbol] | to R41 [symbol] | | | | | | | | | |
| Condensation | ° C. | 13.8 | 9.5 | 7.5 | 5.8 | 4.2 | 13.2 | 11.1 | 8.9 | 7.0 |
| glide | | | | | | | | | | |

[symbol]

indicates data missing or illegible when filed

TABLE 17

| | | | | Com | | | | Com | | |
|---|---|---|---|---|---|---|---|---|---|---|
| Item | Unit | Ex. 329 | Ex. 330 | Ex. 14 [symbol] | Ex. 331 | Ex. 332 | Ex. 333 | Ex. 13 [symbol] | Ex. 334 | Ex. 335 |
| HFO-1132a | mass % | 7.0 | 7.0 | 7.0 | 7.0 | 7.0 | 7.0 | 7.0 | 7.0 | 7.0 |
| R32 | mass % | 20.0 | 20.0 | 30.0 | 30.0 | 30.0 | 30.0 | 30.0 | 30.0 | 40.0 |
| HFO-1132 (E) | mass % | 60.0 | 70.0 | 10.0 | 20.0 | 30.0 | 40.0 | 50.0 | 60.0 | 10.0 |
| R1234(yf + ze) (r = 0.25) | mass % | 13.0 | 3.0 | 53.0 | 43.0 | 33.0 | 23.0 | 13.0 | 3.0 | 43.0 |
| GWP | — | 95.9 | 99.4 | 101.1 | 99.6 | 98.3 | 97.2 | 96.3 | 95.7 | 100.4 |
| COP ratio | [symbol] relative | 136 | 136 | 206 | 205 | 205 | 204 | 204 | 203 | 273 |
| | to R41 [symbol] | | | | | | | | | |
| Refrigerating | [symbol] relative | 106.6 | 112.1 | 83.6 | 90.3 | 96.7 | 102.8 | 108.7 | 114.3 | 90.9 |
| capacity r [symbol] | to R41 [symbol] | | | | | | | | | |
| Condensation | ° C. | 5.2 | 3.6 | 12.3 | 10.4 | 8.4 | 6.5 | 4.7 | 3.1 | 9.7 |
| glide | | | | | | | | | | |
| Item | Unit | Ex. 336 | Ex. 337 | Ex. 338 | Ex. 339 | Ex. 340 | Ex. 341 | Ex. 342 | Ex. 343 | Ex. 344 |
| HFO-1132a | mass % | 7.0 | 7.0 | 7.0 | 7.0 | 7.0 | 7.0 | 7.0 | 7.0 | 7.0 |
| R32 | mass % | 40.0 | 40.0 | 40.0 | 40.0 | 50.0 | 50.0 | 50.0 | 50.0 | 50.0 |
| HFO-1132 (E) | mass % | 20.0 | 30.0 | 40.0 | 50.0 | 10.0 | 20.0 | 30.0 | 40.0 | 10.0 |
| R1234(yf + ze) (r = 0.25) | mass % | 33.0 | 23.0 | 13.0 | 3.0 | 33.0 | 23.0 | 13.0 | 3.0 | 23.0 |
| GWP | — | 272 | 272 | 271 | 271 | 339 | 339 | 339 | 338 | 406 |
| COP ratio | [symbol] relative | 99.1 | 97.9 | 97.0 | 96.2 | 100.0 | 98.8 | 97.8 | 96.9 | 99.9 |
| | to R41 [symbol] | | | | | | | | | |
| Refrigerating | [symbol] relative | 97.5 | 104.0 | 110.1 | 115.9 | 98.0 | 104.6 | 111.0 | 116.9 | 104.6 |
| capacity r [symbol] | to R41 [symbol] | | | | | | | | | |
| Condensation | ° C. | 7.9 | 6.1 | 4.3 | 2.7 | 7.3 | 5.7 | 4.1 | 2.6 | 5.4 |
| glide | | | | | | | | | | |

| | | | | | | Com |
|---|---|---|---|---|---|---|
| Item | Unit | Ex. 345 | Ex. 346 | Ex. 347 | Ex. 348 | Ex. 147 |
| HFO-1132a | mass % | 7.0 | 7.0 | 7.0 | 7.0 | 7.0 |
| R32 | mass % | 50.0 | 50.0 | 70.0 | 70.0 | 80.0 |
| HFO-1132 (E) | mass % | 20.0 | 30.0 | 10.0 | 20.0 | 10.0 |
| R1234(yf + ze) (r = 0.25) | mass % | 13.0 | 3.0 | 13.0 | 3.0 | 3.0 |
| GWP | — | 406 | 406 | 473 | 473 | 540 |
| COP ratio | [symbol] relative | 98.7 | 97.7 | 99.7 | 98.6 | 99.6 |
| | to R41 [symbol] | | | | | |
| Refrigerating | [symbol] relative | 111.1 | 117.3 | 110.7 | 117.0 | 116.1 |
| capacity r [symbol] | to R41 [symbol] | | | | | |
| Condensation | ° C. | 4.0 | 2.5 | 3.8 | 2.6 | 2.6 |
| glide | | | | | | |

| | | Com | | | | | | Com | | |
|---|---|---|---|---|---|---|---|---|---|---|
| Item | Unit | Ex. 14 [symbol] | Ex. 349 | Ex. 350 | Ex. 351 | Ex. 352 | Ex. 353 | Ex. 14 [symbol] | Ex. 354 | Ex. 355 |
| HFO-1132a | mass % | 7.0 | 7.0 | 7.0 | 7.0 | 7.0 | 7.0 | 7.0 | 7.0 | 7.0 |
| R32 | mass % | 10.0 | 10.0 | 10.0 | 10.0 | 10.0 | 10.0 | 20.0 | 20.0 | 20.0 |
| HFO-1132 (E) | mass % | 30.0 | 40.0 | 50.0 | 60.0 | 70.0 | 80.0 | 20.0 | 30.0 | 40.0 |
| R1234(yf + ze) (r = 0.5) | mass % | 53.0 | 43.0 | 33.0 | 23.0 | 13.0 | 3.0 | 53.0 | 43.0 | 33.0 |
| GWP | — | 71 | 70 | 70 | 69 | 69 | 69 | 138 | 138 | 137 |
| COP ratio | [symbol] relative | 99.3 | 98.0 | 97.0 | 96.3 | 96.8 | 95.4 | 99.8 | 98.4 | 97.3 |
| | to R41 [symbol] | | | | | | | | | |
| Refrigerating | [symbol] relative | 82.1 | 88.1 | 93.8 | 99.2 | 104.4 | 109.4 | 84.1 | 90.3 | 96.2 |
| capacity r [symbol] | to R41 [symbol] | | | | | | | | | |
| Condensation | ° C. | 12.0 | 10.2 | 8.4 | 6.8 | 5.4 | 4.1 | 11.3 | 9.6 | 7.8 |
| glide | | | | | | | | | | |

[symbol]

indicates data missing or illegible when filed

TABLE 18

| | | | | | Com | | | | | |
|---|---|---|---|---|---|---|---|---|---|---|
| Item | Unit | Ex. 356 | Ex. 357 | Ex. 358 | Ex. 15 [symbol] | Ex. 359 | Ex. 360 | Ex. 361 | Ex. 362 | Ex. 363 |
| HFO-1132a | mass % | 7.0 | 7.0 | 7.0 | 7.0 | 7.0 | 7.0 | 7.0 | 7.0 | 7.0 |
| R32 | mass % | 20.0 | 20.0 | 20.0 | 30.0 | 30.0 | 30.0 | 30.0 | 30.0 | 30.0 |
| HFO-1132 (E) | mass % | 50.0 | 60.0 | 70.0 | 5.0 | 20.0 | 30.0 | 40.0 | 50.0 | 60.0 |
| R1234(yf + ze) (r = 0.5) | mass % | 23.0 | 13.0 | 3.0 | 58.0 | 43.0 | 33.0 | 23.0 | 13.0 | 3.0 |
| GWP | — | 137 | 136 | 136 | 206 | 205 | 205 | 204 | 204 | 203 |
| COP ratio | [symbol] relative | 96.5 | 95.8 | 95.4 | 101.2 | 99.1 | 97.9 | 97.0 | 96.2 | 95.7 |
| | to R41 [symbol] | | | | | | | | | |
| Refrigerating | [symbol] relative | 101.8 | 107.1 | 112.2 | 82.8 | 91.8 | 97.9 | 103.7 | 109.2 | 114.4 |
| capacity r [symbol] | to R41 [symbol] | | | | | | | | | |
| Condensation | ° C. | 6.2 | 4.8 | 3.5 | 11.1 | 8.9 | 7.3 | 5.7 | 4.3 | 3.0 |
| glide | | | | | | | | | | |
| Item | Unit | Ex. 364 | Ex. 365 | Ex. 366 | Ex. 367 | Ex. 368 | Ex. 369 | Ex. 370 | Ex. 371 | Ex. 372 |
| HFO-1132a | mass % | 7.0 | 7.0 | 7.0 | 7.0 | 7.0 | 7.0 | 7.0 | 7.0 | 7.0 |
| R32 | mass % | 40.0 | 40.0 | 40.0 | 40.0 | 40.0 | 50.0 | 50.0 | 50.0 | 50.0 |
| HFO-1132 (E) | mass % | 10.0 | 20.0 | 30.0 | 40.0 | 50.0 | 10.0 | 20.0 | 30.0 | 40.0 |
| R1234(yf + ze) (r = 0.5) | mass % | 43.0 | 33.0 | 23.0 | 13.0 | 3.0 | 33.0 | 23.0 | 13.0 | 3.0 |
| GWP | — | 272 | 272 | 272 | 271 | 271 | 339 | 339 | 339 | 338 |
| COP ratio | [symbol] relative | 99.9 | 98.7 | 97.7 | 96.9 | 96.2 | 99.7 | 98.6 | 97.7 | 96.9 |
| | to R41 [symbol] | | | | | | | | | |
| Refrigerating | [symbol] relative | 92.5 | 98.9 | 105.0 | 110.7 | 116.1 | 99.3 | 105.6 | 111.5 | 117.1 |
| capacity r [symbol] | to R41 [symbol] | | | | | | | | | |
| Condensation | ° C. | 8.2 | 6.8 | 5.3 | 3.9 | 2.7 | 6.3 | 5.0 | 3.7 | 2.5 |
| glide | | | | | | | | | | |

| | | | | | | | Com |
|---|---|---|---|---|---|---|---|
| Item | Unit | Ex. 373 | Ex. 374 | Ex. 375 | Ex. 376 | Ex. 377 | Ex. 151 |
| HFO-1132a | mass % | 7.0 | 7.0 | 7.0 | 7.0 | 7.0 | 7.0 |
| R32 | mass % | 60.0 | 60.0 | 60.0 | 70.0 | 70.0 | 80.0 |
| HFO-1132 (E) | mass % | 10.0 | 20.0 | 30.0 | 10.0 | 20.0 | 10.0 |
| R1234(yf + ze) (r = 0.5) | mass % | 23.0 | 13.0 | 3.0 | 13.0 | 3.0 | 3.0 |
| GWP | — | 406 | 406 | 406 | 473 | 473 | 540 |
| COP ratio | [symbol] relative | 99.6 | 98.6 | 97.7 | 99.6 | 98.6 | 99.6 |
| | to R41 [symbol] | | | | | | |
| Refrigerating | [symbol] relative | 105.6 | 111.7 | 117.4 | 111.2 | 117.1 | 116.3 |
| capacity r [symbol] | to R41 [symbol] | | | | | | |
| Condensation | ° C. | 4.7 | 3.6 | 2.5 | 3.5 | 2.5 | 2.5 |
| glide | | | | | | | |

| | | Com | | | | | | Com | | |
|---|---|---|---|---|---|---|---|---|---|---|
| Item | Unit | Ex. 15 [symbol] | Ex. 378 | Ex. 379 | Ex. 380 | Ex. 381 | Ex. 382 | Ex. 15 [symbol] | Ex. 383 | Ex. 384 |
| HFO-1132a | mass % | 7.0 | 7.0 | 7.0 | 7.0 | 7.0 | 7.0 | 7.0 | 7.0 | 7.0 |
| R32 | mass % | 10.0 | 10.0 | 10.0 | 10.0 | 10.0 | 10.0 | 20.0 | 20.0 | 20.0 |
| HFO-1132 (E) | mass % | 25.0 | 40.0 | 50.0 | 60.0 | 70.0 | 80.0 | 10.0 | 20.0 | 30.0 |
| R1234(yf + ze) (r = 0.75) | mass % | 58.0 | 43.0 | 33.0 | 23.0 | 13.0 | 3.0 | 63.0 | 53.0 | 43.0 |
| GWP | — | 70 | 70 | 70 | 69 | 69 | 69 | 138 | 138 | 137 |
| COP ratio | [symbol] relative | 99.4 | 97.6 | 96.7 | 96.1 | 95.7 | 95.4 | 100.6 | 99.2 | 97.9 |
| | to R41 [symbol] | | | | | | | | | |
| Refrigerating | [symbol] relative | 80.4 | 89.3 | 94.8 | 100.0 | 104.9 | 109.5 | 79.2 | 85.7 | 91.7 |
| capacity r [symbol] | to R41 [symbol] | | | | | | | | | |
| Condensation | ° C. | 11.2 | 8.8 | 7.4 | 6.1 | 5.0 | 4.1 | 11.0 | 9.7 | 8.2 |
| glide | | | | | | | | | | |
| Item | Unit | Ex. 385 | Ex. 386 | Ex. 387 | Ex. 388 | Ex. 389 | Ex. 390 | Ex. 391 | Ex. 392 | Ex. 393 |
| HFO-1132a | mass % | 7.0 | 7.0 | 7.0 | 7.0 | 7.0 | 7.0 | 7.0 | 7.0 | 7.0 |
| R32 | mass % | 20.0 | 20.0 | 20.0 | 20.0 | 30.0 | 30.0 | 30.0 | 30.0 | 30.0 |
| HFO-1132 (E) | mass % | 40.0 | 50.0 | 60.0 | 70.0 | 10.0 | 20.0 | 30.0 | 40.0 | 50.0 |
| R1234(yf + ze) (r = 0.75) | mass % | 33.0 | 23.0 | 13.0 | 3.0 | 53.0 | 43.0 | 33.0 | 23.0 | 13.0 |
| GWP | — | 137 | 137 | 136 | 136 | 205 | 205 | 204 | 204 | 204 |
| COP ratio | [symbol] relative | 97.0 | 96.3 | 95.7 | 95.4 | 99.8 | 98.6 | 97.5 | 96.7 | 96.1 |
| | to R41 [symbol] | | | | | | | | | |
| Refrigerating | [symbol] relative | 97.3 | 102.6 | 107.6 | 112.3 | 87.0 | 93.3 | 99.1 | 104.6 | 109.7 |
| capacity r [symbol] | to R41 [symbol] | | | | | | | | | |
| Condensation | ° C. | 6.8 | 5.5 | 4.4 | 3.4 | 8.8 | 7.5 | 6.2 | 5.0 | 3.9 |
| glide | | | | | | | | | | |

[symbol]

indicates data missing or illegible when filed

TABLE 19

| Item | Unit | Ex. 394 | Ex. 395 | Ex. 396 | Ex. 397 | Ex. 398 | Ex. 399 | Ex. 400 | Ex. 401 | Ex. 402 |
|---|---|---|---|---|---|---|---|---|---|---|
| HFO-1132a | mass % | 7.0 | 7.0 | 7.0 | 7.0 | 7.0 | 7.0 | 7.0 | 7.0 | 7.0 |
| R32 | mass % | 30.0 | 40.0 | 40.0 | 40.0 | 40.0 | 40.0 | 50.0 | 50.0 | 50.0 |
| HFO-1132 (E) | mass % | 60.0 | 10.0 | 20.0 | 30.0 | 40.0 | 50.0 | 10.0 | 20.0 | 30.0 |
| R1234(yf + ze) (r = 0.75) | mass % | 3.0 | 43.0 | 33.0 | 23.0 | 13.0 | 3.0 | 33.0 | 23.0 | 13.0 |
| GWP | — | 203 | 272 | 272 | 271 | 271 | 271 | 339 | 339 | 338 |
| COP ratio | [symbol] relative | 95.6 | 99.4 | 98.4 | 97.5 | 96.7 | 96.2 | 99.4 | 98.4 | 97.6 |
| | to R41 [symbol] | | | | | | | | | |
| Refrigerating | [symbol] relative | 114.5 | 94.1 | 100.2 | 105.9 | 111.2 | 116.2 | 100.6 | 106.6 | 112.1 |
| capacity r [symbol] | to R41 [symbol] | | | | | | | | | |
| Condensation | ° C. | 2.9 | 6.9 | 5.8 | 4.6 | 3.6 | 2.6 | 5.3 | 4.4 | 3.4 |
| glide | | | | | | | | | | |

| | | | | | | | | Com |
|---|---|---|---|---|---|---|---|---|
| Item | Unit | Ex. 403 | Ex. 404 | Ex. 405 | Ex. 406 | Ex. 407 | Ex. 408 | Ex. 154 |
| HFO-1132a | mass % | 7.0 | 7.0 | 7.0 | 7.0 | 7.0 | 7.0 | 7.0 |
| R32 | mass % | 50.0 | 50.0 | 60.0 | 60.0 | 70.0 | 70.0 | 80.0 |
| HFO-1132 (E) | mass % | 40.0 | 10.0 | 20.0 | 30.0 | 10.0 | 20.0 | 10.0 |
| R1234(yf + ze) (r = 0.75) | mass % | 3.0 | 23.0 | 13.0 | 3.0 | 13.0 | 3.0 | 3.0 |
| GWP | — | 338 | 406 | 406 | 406 | 473 | 473 | 540 |
| COP ratio | [symbol] relative | 96.9 | 99.4 | 98.5 | 97.7 | 99.5 | 98.6 | 99.5 |
| | to R41 [symbol] | | | | | | | |
| Refrigerating | [symbol] relative | 117.2 | 106.5 | 112.2 | 117.5 | 111.7 | 117.3 | 116.4 |
| capacity r [symbol] | to R41 [symbol] | | | | | | | |
| Condensation | ° C. | 2.4 | 4.1 | 3.3 | 2.4 | 3.2 | 2.4 | 2.4 |
| glide | | | | | | | | |

[symbol]

indicates data missing or illegible when filed

TABLE 20

| | | Com | | | | | Com | | | |
|---|---|---|---|---|---|---|---|---|---|---|
| Item | Unit | Ex. 15 [symbol] | Ex. 409 | Ex. 410 | Ex. 411 | Ex. 412 | Ex. 15 [symbol] | Ex. 413 | Ex. 414 | Ex. 415 |
| HFO-1132a | mass % | 10.0 | 10.0 | 10.0 | 10.0 | 10.0 | 10.0 | 10.0 | 10.0 | 10.0 |
| R32 | mass % | 10.0 | 10.0 | 10.0 | 10.0 | 10.0 | 20.0 | 20.0 | 20.0 | 20.0 |
| HFO-1132 (E) | mass % | 25.0 | 40.0 | 50.0 | 60.0 | 70.0 | 15.0 | 30.0 | 40.0 | 50.0 |
| R1234(yf + ze) (r = 0) | mass % | 55.0 | 40.0 | 30.0 | 20.0 | 10.0 | 55.0 | 40.0 | 30.0 | 20.0 |
| GWP | — | 71 | 70 | 70 | 69 | 69 | 139 | 138 | 137 | 137 |
| COP ratio | [symbol] relative | 99.8 | 97.3 | 96.0 | 95.0 | 94.3 | 100.6 | 98.0 | 96.5 | 95.4 |
| | to R41 [symbol] | | | | | | | | | |
| Refrigerating | [symbol] relative | 81.1 | 90.5 | 96.6 | 102.6 | 108.4 | 82.5 | 92.3 | 98.7 | 104.9 |
| capacity r [symbol] | to R41 [symbol] | | | | | | | | | |
| Condensation | ° C. | 18.3 | 14.0 | 11.2 | 8.8 | 6.6 | 17.3 | 13.2 | 10.5 | 8.0 |
| glide | | | | | | | | | | |
| | | | Com | | | | | | | |
| Item | Unit | Ex. 416 | Ex. 15 [symbol] | Ex. 417 | Ex. 418 | Ex. 419 | Ex. 420 | Ex. 421 | Ex. 422 | Ex. 423 |
| HFO-1132a | mass % | 10.0 | 10.0 | 10.0 | 10.0 | 10.0 | 10.0 | 10.0 | 10.0 | 10.0 |
| R32 | mass % | 20.0 | 30.0 | 30.0 | 30.0 | 30.0 | 30.0 | 30.0 | 40.0 | 40.0 |
| HFO-1132 (E) | mass % | 60.0 | 5.0 | 10.0 | 20.0 | 30.0 | 40.0 | 50.0 | 10.0 | 20.0 |
| R1234(yf + ze) (r = 0) | mass % | 10.0 | 55.0 | 50.0 | 40.0 | 30.0 | 20.0 | 10.0 | 40.0 | 30.0 |
| GWP | — | 136 | 206 | 206 | 205 | 205 | 204 | 204 | 273 | 273 |
| 272 | [symbol] relative | 94.5 | 101.4 | 100.5 | 98.8 | 97.2 | 96.0 | 95.0 | 99.7 | 98.2 |
| | to R41 [symbol] | | | | | | | | | |
| Refrigerating | [symbol] relative | 110.9 | 83.0 | 86.6 | 93.5 | 100.1 | 106.6 | 112.8 | 94.0 | 101.0 |
| capacity r [symbol] | to R41 [symbol] | | | | | | | | | |
| Condensation | ° C. | 5.8 | 16.1 | 15.0 | 12.5 | 9.9 | 7.4 | 5.2 | 11.7 | 9.3 |
| glide | | | | | | | | | | |
| | | | | | | | | | | Com |
| Item | Unit | Ex. 424 | Ex. 425 | Ex. 426 | Ex. 427 | Ex. 428 | Ex. 429 | Ex. 430 | Ex. 431 | Ex. 15 [symbol] |
| HFO-1132a | mass % | 10.0 | 10.0 | 10.0 | 10.0 | 10.0 | 10.0 | 10.0 | 10.0 | 10.0 |
| R32 | mass % | 40.0 | 40.0 | 50.0 | 50.0 | 50.0 | 60.0 | 60.0 | 70.0 | 80.0 |
| HFO-1132 (E) | mass % | 30.0 | 40.0 | 10.0 | 20.0 | 30.0 | 10.0 | 20.0 | 10.0 | 5.0 |
| R1234(yf + ze) (r = 0) | mass % | 20.0 | 40.0 | 30.0 | 20.0 | 10.0 | 20.0 | 10.0 | 10.0 | 5.0 |
| GWP | — | 272 | 271 | 340 | 339 | 339 | 406 | 406 | 473 | 540 |
| COP ratio | [symbol] relative | 96.8 | 95.8 | 99.2 | 97.9 | 96.7 | 99.0 | 97.7 | 98.8 | 99.3 |
| | to R41 [symbol] | | | | | | | | | |
| Refrigerating | [symbol] relative | 107.2 | 114.2 | 101.2 | 108.2 | 114.9 | 108.1 | 115.0 | 114.5 | 116.9 |
| capacity r [symbol] | to R41 [symbol] | | | | | | | | | |
| Condensation | ° C. | 7.0 | 4.8 | 8.8 | 6.7 | 4.6 | 6.4 | 4.5 | 4.4 | 3.6 |
| glide | | | | | | | | | | |

| | | Com | | | | | Com | | | |
|---|---|---|---|---|---|---|---|---|---|---|
| Item | Unit | Ex. 15 [symbol] | Ex. 432 | Ex. 433 | Ex. 434 | Ex. 435 | Ex. 16 [symbol] | Ex. 436 | Ex. 437 | Ex. 438 |
| HFO-1132a | mass % | 10.0 | 10.0 | 10.0 | 10.0 | 10.0 | 10.0 | 10.0 | 10.0 | 10.0 |
| R32 | mass % | 10.0 | 10.0 | 10.0 | 10.0 | 10.0 | 20.0 | 20.0 | 20.0 | 20.0 |
| HFO-1132 (E) | mass % | 20.0 | 40.0 | 50.0 | 60.0 | 70.0 | 10.0 | 20.0 | 30.0 | 40.0 |
| R1234(yf + ze) (r = 0.25) | mass % | 60.0 | 40.0 | 30.0 | 20.0 | 10.0 | 60.0 | 50.0 | 40.0 | 30.0 |
| GWP | — | 71 | 70 | 70 | 69 | 69 | 139 | 138 | 138 | 137 |
| COP ratio | [symbol] relative | 100.1 | 96.9 | 95.8 | 94.9 | 94.3 | 100.8 | 99.1 | 97.5 | 96.2 |
| | to R41 [symbol] | | | | | | | | | |
| Refrigerating | [symbol] relative | 79.1 | 91.6 | 97.5 | 103.3 | 108.8 | 80.4 | 87.2 | 93.6 | 99.7 |
| capacity r [symbol] | to R41 [symbol] | | | | | | | | | |
| Condensation | ° C. | 17.2 | 12.4 | 10.1 | 8.1 | 5.3 | 15.1 | 13.9 | 11.5 | 9.4 |
| glide | | | | | | | | | | |
| | | | | Com | | | | | | |
| Item | Unit | Ex. 439 | Ex. 440 | Ex. 14 [symbol] | Ex. 441 | Ex. 442 | Ex. 443 | Ex. 444 | Ex. 445 | Ex. 446 |
| HFO-1132a | mass % | 10.0 | 10.0 | 10.0 | 10.0 | 10.0 | 10.0 | 10.0 | 10.0 | 10.0 |
| R32 | mass % | 20.0 | 20.0 | 30.0 | 30.0 | 30.0 | 30.0 | 30.0 | 40.0 | 40.0 |
| HFO-1132 (E) | mass % | 50.0 | 50.0 | 10.0 | 20.0 | 30.0 | 40.0 | 50.0 | 10.0 | 20.0 |
| R1234(yf + ze) (r = 0.25) | mass % | 20.0 | 10.0 | 50.0 | 40.0 | 30.0 | 20.0 | 10.0 | 40.0 | 30.0 |
| GWP | — | 137 | 136 | 205 | 205 | 205 | 204 | 204 | 272 | 272 |
| COP ratio | [symbol] relative | 95.2 | 94.4 | 99.9 | 98.3 | 96.9 | 95.8 | 94.9 | 99.2 | 97.8 |
| | to R41 [symbol] | | | | | | | | | |
| Refrigerating | [symbol] relative | 105.6 | 111.3 | 88.1 | 94.8 | 101.2 | 107.4 | 113.2 | 95.4 | 102.1 |
| capacity r [symbol] | to R41 [symbol] | | | | | | | | | |
| Condensation | ° C. | 7.3 | 5.5 | 13.0 | 10.9 | 8.8 | 6.7 | 4.9 | 10.1 | 8.2 |
| glide | | | | | | | | | | |

[symbol]

indicates data missing or illegible when filed

TABLE 21

| | | | | | | | | | | Com |
|---|---|---|---|---|---|---|---|---|---|---|
| Item | Unit | Ex. 447 | Ex. 448 | Ex. 449 | Ex. 450 | Ex. 451 | Ex. 452 | Ex. 453 | Ex. 454 | Ex. 161 |
| HFO-1132a | mass % | 10.0 | 10.0 | 10.0 | 10.0 | 10.0 | 10.0 | 10.0 | 10.0 | 10.0 |
| R32 | mass % | 40.0 | 40.0 | 50.0 | 50.0 | 50.0 | 50.0 | 60.0 | 70.0 | 80.0 |
| HFO-1132 (E) | mass % | 30.0 | 40.0 | 10.0 | 20.0 | 30.0 | 10.0 | 20.0 | 10.0 | 5.0 |
| R1234(yf + ze) (r = 0.25) | mass % | 20.0 | 10.0 | 30.0 | 20.0 | 10.0 | 20.0 | 10.0 | 10.0 | 5.0 |
| GWP | — | 272 | 271 | 339 | 339 | 338 | 406 | 405 | 473 | 540 |
| COP ratio | [symbol] relative | 96.7 | 96.7 | 98.9 | 97.7 | 96.6 | 98.8 | 97.7 | 98.8 | 99.2 |
| | to R41 [symbol] | | | | | | | | | |
| Refrigerating | [symbol] relative | 108.5 | 114.6 | 102.4 | 109.1 | 115.3 | 108.9 | 115.5 | 114.9 | 117.1 |
| capacity r [symbol] | to R41 [symbol] | | | | | | | | | |
| Condensation | ° C. | 6.3 | 4.5 | 7.7 | 6.0 | 4.3 | 5.7 | 4.2 | 4.1 | 3.4 |
| glide | | | | | | | | | | |

| | | Com | | | | | | Com | | |
|---|---|---|---|---|---|---|---|---|---|---|
| Item | Unit | Ex. 16 [symbol] | Ex. 455 | Ex. 456 | Ex. 457 | Ex. 458 | Ex. 459 | Ex. 16 [symbol] | Ex. 460 | Ex. 461 |
| HFO-1132a | mass % | 10.0 | 10.0 | 10.0 | 10.0 | 10.0 | 10.0 | 10.0 | 10.0 | 10.0 |
| R32 | mass % | 10.0 | 10.0 | 10.0 | 10.0 | 10.0 | 10.0 | 20.0 | 20.0 | 20.0 |
| HFO-1132 (E) | mass % | 20.0 | 30.0 | 10.0 | 50.0 | 60.0 | 40.0 | 10.0 | 30.0 | 40.0 |
| R1234(yf + ze) (r = 0.5) | mass % | 60.0 | 50.0 | 40.0 | 30.0 | 20.0 | 10.0 | 60.0 | 40.0 | 30.0 |
| GWP | — | 71 | 70 | 70 | 70 | 69 | 69 | 138 | 137 | 137 |
| COP ratio | [symbol] relative | 99.5 | 97.9 | 96.6 | 95.5 | 94.8 | 94.2 | 100.1 | 97.1 | 95.9 |
| | to R41 [symbol] | | | | | | | | | |
| Refrigerating | [symbol] relative | 80.4 | 85.8 | 92.8 | 98.5 | 103.9 | 109.1 | 82.0 | 94.8 | 100.7 |
| capacity r [symbol] | to R41 [symbol] | | | | | | | | | |
| Condensation | ° C. | 14.9 | 12.9 | 10.9 | 9.1 | 7.4 | 5.9 | 13.8 | 10.1 | 8.3 |
| glide | | | | | | | | | | |
| Item | Unit | Ex. 462 | Ex. 463 | Ex. 464 | Ex. 465 | Ex. 466 | Ex. 467 | Ex. 468 | Ex. 469 | Ex. 470 |
| HFO-1132a | mass % | 10.0 | 10.0 | 10.0 | 10.0 | 10.0 | 10.0 | 10.0 | 10.0 | 10.0 |
| R32 | mass % | 20.0 | 20.0 | 30.0 | 30.0 | 30.0 | 30.0 | 30.0 | 40.0 | 40.0 |
| HFO-1132 (E) | mass % | 50.0 | 60.0 | 5.0 | 20.0 | 30.0 | 40.0 | 50.0 | 10.0 | 20.0 |
| R1234(yf + ze) (r = 0.5) | mass % | 20.0 | 10.0 | 55.0 | 40.0 | 30.0 | 20.0 | 10.0 | 40.0 | 30.0 |
| GWP | — | 137 | 136 | 205 | 205 | 204 | 204 | 204 | 272 | 272 |
| COP ratio | [symbol] relative | 95.0 | 94.4 | 100.1 | 97.8 | 96.6 | 95.6 | 94.9 | 98.8 | 97.6 |
| | to R41 [symbol] | | | | | | | | | |
| Refrigerating | [symbol] relative | 106.3 | 111.6 | 86.2 | 96.2 | 102.3 | 108.1 | 113.6 | 96.8 | 103.3 |
| capacity r [symbol] | to R41 [symbol] | | | | | | | | | |
| Condensation | ° C. | 6.6 | 5.2 | 11.9 | 9.4 | 7.7 | 6.1 | 4.6 | 8.7 | 7.2 |
| glide | | | | | | | | | | |
| | | | | | | | | | | Com |
| Item | Unit | Ex. 471 | Ex. 472 | Ex. 473 | Ex. 474 | Ex. 475 | Ex. 476 | Ex. 477 | Ex. 478 | Ex. 16 [symbol] |
| HFO-1132a | mass % | 10.0 | 10.0 | 10.0 | 10.0 | 10.0 | 10.0 | 10.0 | 10.0 | 10.0 |
| R32 | mass % | 40.0 | 40.0 | 50.0 | 50.0 | 50.0 | 60.0 | 60.0 | 70.0 | 80.0 |
| HFO-1132 (E) | mass % | 30.0 | 40.0 | 10.0 | 20.0 | 30.0 | 10.0 | 20.0 | 10.0 | 5.0 |
| R1234(yf + ze) (r = 0.5) | mass % | 20.0 | 10.0 | 30.0 | 20.0 | 10.0 | 20.0 | 10.0 | 10.0 | 5.0 |
| GWP | — | 271 | 271 | 339 | 339 | 338 | 406 | 406 | 473 | 540 |
| COP ratio | [symbol] relative | 96.5 | 95.6 | 98.7 | 97.5 | 96.5 | 98.7 | 97.6 | 98.7 | 99.2 |
| | to R41 [symbol] | | | | | | | | | |
| Refrigerating | [symbol] relative | 109.3 | 115.0 | 103.6 | 109.9 | 115.8 | 109.7 | 115.9 | 115.3 | 117.2 |
| capacity r [symbol] | to R41 [symbol] | | | | | | | | | |
| Condensation | ° C. | 5.7 | 4.2 | 6.7 | 5.4 | 4.0 | 5.1 | 3.9 | 3.9 | 3.3 |
| glide | | | | | | | | | | |

| | | Com | | | | | Com | | | |
|---|---|---|---|---|---|---|---|---|---|---|
| Item | Unit | Ex. 16 [symbol] | Ex. 479 | Ex. 480 | Ex. 481 | Ex. 482 | Ex. 16 [symbol] | Ex. 483 | Ex. 484 | Ex. 485 |
| HFO-1132a | mass % | 10.0 | 10.0 | 10.0 | 10.0 | 10.0 | 10.0 | 10.0 | 10.0 | 10.0 |
| R32 | mass % | 10.0 | 10.0 | 10.0 | 10.0 | 10.0 | 20.0 | 20.0 | 20.0 | 20.0 |
| HFO-1132 (E) | mass % | 20.0 | 40.0 | 50.0 | 60.0 | 70.0 | 5.0 | 20.0 | 30.0 | 40.0 |
| R1234(yf + ze) (r = 0.75) | mass % | 60.0 | 40.0 | 30.0 | 20.0 | 10.0 | 65.0 | 50.0 | 40.0 | 30.0 |
| GWP | — | 71 | 70 | 69 | 69 | 69 | 138 | 138 | 137 | 137 |
| COP ratio | [symbol] relative | 99.0 | 96.2 | 95.3 | 94.6 | 94.1 | 100.4 | 98.0 | 96.7 | 95.6 |
| | to R41 [symbol] | | | | | | | | | |
| Refrigerating | [symbol] relative | 81.7 | 93.9 | 99.4 | 104.6 | 109.4 | 79.9 | 90.0 | 96.0 | 101.7 |
| capacity r [symbol] | to R41 [symbol] | | | | | | | | | |
| Condensation | ° C. | 12.9 | 9.6 | 8.1 | 6.8 | 5.6 | 12.4 | 10.4 | 8.8 | 7.3 |
| glide | | | | | | | | | | |

[symbol]

indicates data missing or illegible when filed

TABLE 22

| Item | Unit | Ex. 486 | Ex. 487 | Ex. 488 | Ex. 489 | Ex. 490 | Ex. 491 | Ex. 492 | Ex. 493 | Ex. 494 |
|---|---|---|---|---|---|---|---|---|---|---|
| HFO-1132a | mass % | 10.0 | 10.0 | 10.0 | 10.0 | 10.0 | 10.0 | 10.0 | 10.0 | 10.0 |
| R32 | mass % | 20.0 | 20.0 | 30.0 | 30.0 | 30.0 | 30.0 | 30.0 | 40.0 | 40.0 |
| HFO-1132 (E) | mass % | 50.0 | 60.0 | 10.0 | 20.0 | 30.0 | 40.0 | 50.0 | 10.0 | 20.0 |
| R1234(yf + ze) (r = 0.75) | mass % | 20.0 | 10.0 | 50.0 | 40.0 | 30.0 | 20.0 | 10.0 | 40.0 | 30.0 |
| GWP | — | 137 | 136 | 205 | 205 | 204 | 204 | 204 | 272 | 272 |
| COP ratio | [symbol] relative | 94.9 | 94.3 | 98.7 | 97.4 | 96.3 | 95.5 | 94.8 | 98.4 | 97.3 |
| | to R41 [symbol] | | | | | | | | | |
| Refrigerating | [symbol] relative | 107.0 | 112.0 | 91.1 | 97.5 | 103.4 | 108.9 | 114.0 | 98.2 | 104.4 |
| capacity r [symbol] | to R41 [symbol] | | | | | | | | | |
| Condensation | ° C. | 6.0 | 4.9 | 9.4 | 8.1 | 6.7 | 5.4 | 4.3 | 7.4 | 6.2 |
| glide | | | | | | | | | | |
| | | | | | | | | | | Com |
| Item | Unit | Ex. 495 | Ex. 496 | Ex. 497 | Ex. 498 | Ex. 499 | Ex. 500 | Ex. 501 | Ex. 502 | Ex. 167 |
| HFO-1132a | mass % | 10.0 | 10.0 | 10.0 | 10.0 | 10.0 | 10.0 | 10.0 | 10.0 | 10.0 |
| R32 | mass % | 40.0 | 40.0 | 50.0 | 50.0 | 50.0 | 60.0 | 60.0 | 70.0 | 80.0 |
| HFO-1132 (E) | mass % | 30.0 | 40.0 | 10.0 | 20.0 | 30.0 | 10.0 | 20.0 | 10.0 | 5.0 |
| R1234(yf + ze) (r = 0.75) | mass % | 20.0 | 10.0 | 30.0 | 20.0 | 10.0 | 20.0 | 10.0 | 10.0 | 5.0 |
| GWP | — | 271 | 271 | 339 | 339 | 338 | 406 | 406 | 473 | 540 |
| COP ratio | [symbol] relative | 96.3 | 95.5 | 98.4 | 97.3 | 96.4 | 98.5 | 97.5 | 98.6 | 99.1 |
| | to R41 [symbol] | | | | | | | | | |
| Refrigerating | [symbol] relative | 110.1 | 115.4 | 104.7 | 110.7 | 116.1 | 110.5 | 116.2 | 115.7 | 117.4 |
| capacity r [symbol] | to R41 [symbol] | | | | | | | | | |
| Condensation | ° C. | 5.0 | 3.9 | 5.8 | 4.8 | 3.7 | 4.6 | 3.7 | 3.6 | 3.2 |
| glide | | | | | | | | | | |

[symbol]

indicates data missing or illegible when filed

1. A composition comprising a refrigerant, the refrigerant comprising difluoromethane (R32), trans-1,2-difluoroethylene (HFO-1132(E)), 1,3,3,3-tetrafluoropropene (R1234ze), and 1,1-difluoroethylene (HFO-1132a).

2. The composition according to claim 1,
wherein
when the mass % of R32, HFO-1132(E), R1234ze, and HFO-1132a based on their sum in the refrigerant is respectively represented by x, y, z, and a, provided that 1.5≤a≤10.0, coordinates (x,y,z) in a ternary composition diagram in which the sum of R32, HFO-1132(E), and R1234ze is (100−a) mass % are within the range of a figure surrounded by straight lines AB, BC, CD, DO, and OA that connect the following 5 points:
point A (74.0, −a+26.0, 0.0),
point B (73.9, 0.0, −a+26.1),
point C (0.0087a²−2.2743a+59.574, 0.0, −0.0087a²+1.2743a+40.426),
point D (0.0, 0.0299a²−3.4018a+76.233, −0.0299a²+2.4018a+23.767), and
point O (0.0, 100.0−a, 0.0),
or on the straight lines AB and CD (excluding the points A, B, C, and D).

3. The composition according to claim 1,
wherein
when the mass % of R32, HFO-1132(E), R1234ze, and HFO-1132a based on their sum in the refrigerant is respectively represented by x, y, z, and a, provided that 1.5≤a≤10.0, coordinates (x,y,z) in a ternary composition diagram in which the sum of R32, HFO-1132(E), and R1234ze is (100−a) mass % are within the range of a figure surrounded by straight lines A′B′, B′C, CD, DO, and OA′ that connect the following 5 points:
point A′ (59.2, −a+40.8, 0.0),
point B′ (0.0132a+58.891, 0.0, −1.0132a+41.109),
point C (0.0087a²−2.2743a+59.574, 0.0, −0.0087a²+1.2743a+40.426),
point D (0.0, 0.0299a²−3.4018a+76.233, −0.0299a²+2.4018a+23.767), and
point O (0.0, 100.0−a, 0.0),
or on the straight lines A′B′ and CD (excluding the points A′, B′, C, and D).

4. The composition according to claim 1, wherein the refrigerant further comprises 2,3,3,3-tetrafluoro-1-propene (R1234yf).

5. The composition according to claim 4,
wherein
when the mass % of R32 is represented by x, the mass % of HFO-1132(E) is represented by y, the total mass % of R1234ze and R1234yf is represented by z, and the mass % of HFO-1132a is represented by a, provided that 1.5≤a≤10.0, based on the sum of R32, HFO-1132(E), R1234ze, R1234yf, and HFO-1132a in the refrigerant, and r=R1234yf/(R1234ze+R1234yf),
if 1.5≤a≤4.6, coordinates (x,y,z) in a ternary composition diagram having R32 as a first vertex, HFO-1132(E) as a second vertex, and the sum of R1234ze and R1234yf as a third vertex are within the range of a figure surrounded by straight lines ABᵣ, BᵣCᵣ, CᵣDᵣ, DᵣO, and OA that connect the following 5 points:
point A (74.0, −a+26.0, 0.0),
point Bᵣ (73.9, 0.0, −a+26.1),
point Cᵣ ((0.0349a²+0.1094a−1.2427)r²+(−0.0202a²+0.0907a−10.591)r+(0.0255a²−2.3816a+59.715), 0.0, −a−x+100.0),
point Dᵣ (0.0, (−0.2097a²+1.3435a−2.7435)r²+(0.2312a²−1.507a−5.0597)r+(0.0255a²−3.3816a+76.215), −a−y+100.0), and
point O (0.0, 100.0−a, 0.0),
or on the straight lines ABᵣ and CᵣDᵣ (excluding the points A, Bᵣ, Cᵣ, and Dᵣ); or
if 4.6≤a≤10.0, coordinates (x,y,z) in the ternary composition diagram are within the range of a figure surrounded by straight lines ABᵣ, BᵣCᵣ, CᵣDᵣ, DᵣO, and OA that connect the following points:
point A (74.0, −a+26.0, 0.0),
point Bᵣ (73.9, 0.0, −a+26.1),
point Cᵣ ((0.0494a²−0.5728a+1.5901)r²+(−0.037a²+0.763a−13.326)r+(0.0062a²−2.2383a+59.465), 0.0, −a−x+100.0),
point Dᵣ (0.0, (−0.0648a²+1.1685a−5.0037)r²+(0.0849a²−1.2762a−3.0253)r+(0.0262a²−3.346a+76.036), −a−y+100.0), and
point O (0.0, 100.0−a, 0.0),
or on the straight lines ABᵣ and CᵣDᵣ (excluding the points A, Bᵣ, Cᵣ, and Dᵣ).

6. The composition according to claim 4,
wherein
when the mass % of R32 is represented by x, the mass % of HFO-1132(E) is represented by y, the total mass % of R1234ze and R1234yf is represented by z, and the mass % of HFO-1132a is represented by a, provided that 1.5≤a≤10.0, based on the sum of R32, HFO-1132(E), R1234ze, R1234yf, and HFO-1132a in the refrigerant, and r=R1234yf/(R1234ze+R1234yf),
if 1.5≤a≤4.6, coordinates (x,y,z) in a ternary composition diagram having R32 as a first vertex, HFO-1132(E) as a second vertex, and the sum of R1234ze and R1234yf as a third vertex are within the range of a figure surrounded by straight lines ABᵣ′, Bᵣ′Cᵣ, CᵣDᵣ, DᵣO, and OA that connect the following 5 points:
point A′ (74.0, −a+26.0, 0.0),
point Bᵣ′ ((−0.043a²+0.3269a−0.5935)r²+(−0.0188a²+0.018a+0.3153)r+(0.0202a²−0.0907a+58.991), 0.0, −a−x+100.0),
point Cᵣ ((0.0349a²+0.1094a−1.2427)r²+(−0.0202a²+0.0907a−10.591)r+(0.0255a²−2.3816a+59.715), 0.0, −a−x+100.0),
point Dᵣ (0.0, (−0.2097a²+1.3435a−2.7435)r²+(0.2312a²−1.507a−5.0597)r+(0.0255a²−3.3816a+76.215), −a−y+100.0), and
point O (0.0, 100.0−a, 0.0),
or on the straight lines ABᵣ′ and CᵣDᵣ (excluding the points A, Bᵣ′, Cᵣ, and Dᵣ); or
if 4.6≤a≤10.0, coordinates (x,y,z) in the ternary composition diagram are within the range of a figure surrounded by straight lines ABᵣ′, Bᵣ′Cᵣ, CᵣDᵣ, DᵣO, and OA that connect the following 5 points:
point A (74.0, −a+26.0, 0.0),
point Bᵣ′ ((−0.0077a²+0.1312a−0.4401)r+(0.0013a²−0.0223a+59.075), 0.0, −a−x+100.0),
point Cᵣ ((0.0494a²−0.5728a+1.5901)r²+(−0.037a²+0.763a−13.326)r+(0.0062a²−2.2383a+59.465), 0.0, −a−x+100.0),
point Dᵣ (0.0, (−0.0648a²+1.1685a−5.0037)r²+(0.0849a²−1.2762a−3.0253)r+(0.0262a²−3.346a+76.036), −a−y+100.0), and
point O (0.0, 100.0−a, 0.0),
or on the straight lines ABᵣ′ and CᵣDᵣ (excluding the points A, Bᵣ′, Cᵣ, and Dᵣ).

7. The composition according to claim 1, for use as a working fluid for a refrigerating machine, wherein the composition further comprises a refrigeration oil.

8. The composition according to claim 1, for use as an alternative refrigerant for R410A.

9. Use of the composition according to claim 1 as an alternative refrigerant for R410A.

10. A refrigerating machine comprising the composition according to claim 1 as a working fluid.

11. A method for operating a refrigerating machine, comprising circulating the composition according to claim 1 as a working fluid in a refrigerating machine.
